(19) United States
(12) Patent Application Publication
(10) Pub. No.: US 2002/0104379 A1
(43) Pub. Date: Aug. 8, 2002

(54) Accelerometer with re-entrant grooves

(75) Inventors: Robert Ried, Stafford, TX (US); Arjun Selvakumar, Bellaire, TX (US); Howard Goldberg, Sugar Land, TX (US); Martin Schmidt, Reading, MA (US); Lianzhong Yu, Redmond, WA (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Input/Output, Inc., Stafford, TX (US)

(21) Appl. No.: 09/867,286

(22) Filed: May 29, 2001

Related U.S. Application Data
(60) Provisional application No. 60/212,997, filed on Jun. 21, 2000.
(60) Provisional application No. 60/217,609, filed on Jul. 11, 2000.
(60) Provisional application No. 60/207,934, filed on May 30, 2000.

(51) Int. Cl. G01P 15/125

(52) U.S. Cl. 73/514.32

(57) ABSTRACT

An accelerometer for measuring seismic data. The accelerometer includes a measurement mass assembly having top and bottom electrodes, a top capacitor electrode, and bottom capacitor electrode. One or more of the electrodes include re-entrant openings formed in the surface of the electrodes.

### CROSS REFERENCE TO RELATED APPLICATIONS

This application is related to U.S. provisional patent application serial No. 60/212,997, filed on Jun. 21, 2000, and U.S. provisional patent application serial No. 60/217,609, filed on Jul. 11, 2000 the disclosures of which are incorporated herein by reference and claims priority from U.S. provisional patent application serial No. 60/207,934, filed May 30, 2000.

### BACKGROUND OF THE INVENTION

This invention relates generally to accelerometers and more particularly to accelerometers including a mass that is resiliently coupled to a housing.

Accelerometers are used to detect and record environmental data. In particular, accelerometers are often used in seismic applications to gather seismic data. Conventional seismic accelerometers typically include a measurement mass resiliently coupled to a support structure by one or more resilient members. The measurement mass includes top and bottom capacitor electrodes positioned on the top and bottom surfaces of the measurement mass. Positioned above the top measurement mass capacitor electrode is a top capacitor electrode, and positioned below the bottom measurement mass capacitor electrode is a bottom capacitor electrode. Variations in the spacing between the capacitor electrodes caused by displacement of the measurement mass due to acceleration are then sensed by a controller and processed to determine the acceleration level. Such conventional seismic accelerometers suffer from a number of drawbacks. In particular, gas molecules that impact the surfaces of the capacitor electrodes during operation of the accelerometer introduce thermal-mechanical noise into the output signals generated by the accelerometer.

The present invention is directed to overcoming one or more of the limitations of the existing accelerometers.

### SUMMARY

According to one embodiment of the present invention, an accelerometer is provided that includes a measurement mass for detecting acceleration, including a housing having a cavity, a spring mass assembly positioned within the cavity, and one or more mass electrodes coupled to the spring mass assembly; a top cap wafer coupled to the measurement mass, including a top capacitor electrode; and a bottom cap wafer coupled to the measurement mass, including a bottom capacitor electrode. The surfaces of one or more of the mass electrodes, top cap electrode, or bottom cap electrode include one or more re-entrant openings.

According to another embodiment of the present invention, a method of operating an accelerometer including a measurement mass for detecting acceleration, including a housing having a cavity, a spring mass assembly positioned within the cavity, and one or more mass electrodes coupled to the spring mass assembly, a top cap wafer coupled to the measurement mass, including a top capacitor electrode, a bottom cap wafer coupled to the measurement mass, including a bottom capacitor electrode, is provided that includes reducing fluid damping between the electrodes by providing one or more re-entrant openings in the surfaces of one or more of the electrodes.

According to another aspect of the present invention, a method of forming a re-entrant opening is provided that includes providing a substrate, patterning a portion of the substrate to form a cavity having an upper cross sectional area, bonding a wafer having an internal etch-stop layer onto the surface of the substrate, etching the wafer down to the etch-stop layer, and patterning the wafer to form an opening that exposes the cavity. The cross sectional area of the opening is less than the upper cross sectional area of the cavity.

According to another aspect of the present invention, a method of forming a re-entrant opening is provided that includes providing a silicon substrate, growing a layer of silicon dioxide onto the silicon substrate, patterning the layer of silicon dioxide, depositing a layer of silicon onto the layer of silicon dioxide and the exposed portions of the silicon substrate, patterning the layer of silicon to form an opening that exposes the layer of silicon dioxide, and removing the layer of silicon dioxide.

According to another aspect of the present invention, a method of forming a re-entrant opening is provided that includes providing a substrate. A layer of masking material is then deposited onto the substrate. The layer of masking material is then patterned to form an opening. The exposed portions of the substrate are then etched to form a re-entrant opening.

According to another aspect of the present invention, a method of forming a re-entrant opening is provided that includes providing a substrate. A first layer of a masking material is then deposited onto the substrate. The first layer of masking material is then patterned to form an opening. The exposed portions of the substrate are then etched to form a channel. A second layer of masking material is then deposited onto the exposed portions of the substrate. The second layer of masking material is then patterned to form an opening. The exposed portions of the substrate are then etched to form a re-entrant opening.

According to another aspect of the present invention, an accelerometer is provided that includes a measurement mass for detecting acceleration, including a housing having a cavity, a spring mass assembly positioned within the cavity, and one or more mass electrodes coupled to the spring mass assembly, a top cap wafer coupled to the measurement mass, including a top capacitor electrode, and a bottom cap wafer coupled to the measurement mass, including a bottom capacitor electrode. The surfaces of one or more of the mass electrodes, the top capacitor electrode, or the bottom capacitor electrode include one or more grooves.

According to another aspect of the present invention, a method of operating an accelerometer including a measurement mass for detecting acceleration, including a housing having a cavity, a spring mass assembly positioned within the cavity, and one or more mass electrodes coupled to the spring mass assembly, a top cap wafer coupled to the measurement mass, including a top capacitor electrode, and a bottom cap wafer coupled to the measurement mass, including a bottom capacitor electrode, is provided that includes reducing fluid damping between the electrodes by providing one or more grooves in the surfaces of one or more of the electrodes.

The present embodiments of the invention provide an accelerometer for providing reliable data measurements. The use of re-entrant openings in the electrodes of the accelerometer reduces fluid damping during operation of the accelerometer. In this manner, thermo-mechanical noise is reduced and the signal to noise ratio of the accelerometer is increased. Furthermore, the use of re-entrant openings maximizes the available electrode surface area thereby maximizing the working capacitance of the electrodes.

### BRIEF DESCRIPTION OF THE DRAWINGS

FIG. 1 illustrates an embodiment of a system used to acquire environmental data measurements.

FIG. 2 illustrates an embodiment of sensors and cabling used within the system of FIG. 1.

FIG. 3a is a cross-sectional side view of the positioning of an accelerometer within the sensor of FIG. 1.

FIG. 3b is a cross-sectional top view of the positioning of an accelerometer within the sensor of FIG. 1.

FIG. 4 illustrates a top perspective view of an embodiment of the accelerometer of FIG. 3a.

FIG. 5 illustrates a bottom perspective view of the accelerometer of FIG. 4.

FIG. 6 illustrates a cross-sectional view of the accelerometer of FIG. 4.

FIG. 7a illustrates a cross-sectional view of a top cap wafer of the accelerometer of FIG. 4.

FIG. 7b illustrates a top view of the top cap wafer of FIG. 7a.

FIG. 7c illustrates a bottom view of the top cap wafer of FIG. 7a.

FIG. 7d illustrates an embodiment of an arrangement of overshock bumpers on the top cap wafer of FIG. 7a.

FIG. 7e illustrates an embodiment of an alternative arrangement of the overshock bumpers of FIG. 7d.

FIG. 7f illustrates an embodiment of an alternative arrangement of the overshock bumpers of FIG. 7d.

FIG. 7g illustrates an embodiment of an alternative arrangement of the overshock bumpers of FIG. 7d.

FIG. 7h illustrates an embodiment of an alternative arrangement of the overshock bumpers of FIG. 7d.

FIG. 7i illustrates an embodiment of an alternative arrangement of the overshock bumpers of FIG. 7d.

FIG. 7j illustrates an embodiment of an alternative arrangement of the overshock bumpers of FIG. 7d.

FIG. 7k illustrates an embodiment of an alternative arrangement of the overshock bumpers of FIG. 7d.

FIG. 7l illustrates an embodiment of an alternative arrangement of the overshock bumpers of FIG. 7d.

FIG. 8a illustrates a cross-sectional view of a bottom cap wafer of the accelerometer of FIG. 4.

FIG. 8b illustrates a bottom view of the bottom cap wafer of FIG. 8a.

FIG. 8c illustrates a top view of the bottom cap wafer of FIG. 8a.

FIG. 9a illustrates a cross-sectional view of a mass wafer pair of the accelerometer of FIG. 4.

FIG. 9aa illustrates a cross-sectional view of a top cap overshock bumper and a patterned mass electrode within the accelerometer of FIG. 6.

FIG. 9ab illustrates a cross-sectional view of a bottom cap overshock bumper and a patterned mass electrode within the accelerometer of FIG. 6.

FIG. 9ac illustrates an embodiment of mass electrodes including reduced-thickness recesses within the accelerometer of FIG. 6.

FIG. 9ad illustrates an embodiment of mass electrodes including cavities within the accelerometer of FIG. 6.

FIG. 9b is a top view of a top mass half of the mass wafer pair of FIG. 9a.

FIG. 9c is a bottom view of the top mass half of FIG. 9b.

FIG. 9d is a bottom perspective view of the top mass half of FIG. 9c.

FIG. 9e is a bottom view of a bottom mass half of the mass wafer pair of FIG. 9a.

FIG. 9f is a top view of the bottom mass half of FIG. 9e.

FIG. 9g is a top perspective view of the bottom mass half of FIG. 9e.

FIG. 10 is a flowchart of a fabrication process for the accelerometer of FIG. 4.

FIG. 11a illustrates an embodiment of the two starting cap wafers of FIG. 10.

FIG. 11b illustrates a cross-sectional view of a top cap wafer and a bottom cap wafer resulting from the cap wafer process of FIG. 10.

FIG. 11c illustrates an embodiment of the starting mass wafers of FIG. 10.

FIG. 11d illustrates a top view of an embodiment of a photomask outline including corner compensation structures applied to the starting mass wafers during the mass wafer process of FIG. 10.

FIG. 11e illustrates a bottom view of the top starting mass wafer after an etching phase of the mass wafer process of FIG. 10.

FIG. 11f illustrates a cross-sectional view of the top starting mass wafer and the bottom starting mass wafer after an etching phase of the mass wafer process of FIG. 10.

FIG. 11g illustrates a cross-sectional view of a bonded mass wafer pair during the mass wafer process of FIG. 10.

FIG. 11h illustrates a cross-sectional view of the bonded mass wafer pair of FIG. 11g including electrodes and bond rings.

FIG. 11ha illustrates an embodiment of a mass electrode including a patterned surface on an upper surface of the mass wafer pair of FIG. 9a.

FIG. 11hb illustrates an embodiment of a mass electrode including a patterned surface on a lower surface of the mass wafer pair of FIG. 9a.

FIG. 11hc illustrates an embodiment of a patterned surface on the mass wafer pair of FIG. 9a.

FIG. 11hd illustrates an alternative embodiment of the patterned surface of FIG. 11hc.

FIG. 11he illustrates an alternative embodiment of the patterned surface of FIG. 11hc.

FIG. 11hf illustrates an alternative embodiment of the patterned surface of FIG. 11hc.

FIG. 11hg illustrates an alternative embodiment of the patterned surface of FIG. 11hc.

FIG. 11hh illustrates an alternative embodiment of the patterned surface of FIG. 11hc.

FIG. 11hi illustrates an alternative embodiment of the patterned surface of FIG. 11hc.

FIG. 11hj illustrates an alternative embodiment of the patterned surface of FIG. 11hc.

FIG. 11i illustrates a cross-sectional view of the bonded mass wafer pair of FIG. 11h including springs.

FIG. 11j illustrates a cross-sectional view of an accelerometer after the bonding process of FIG. 10.

FIG. 12a is a side view illustrating the relative positioning of dicing cuts on the accelerometer die of FIG. 6.

FIG. 12b is an illustration of the accelerometer die after the dicing cuts of FIG. 12a have been completed.

FIG. 12c is an illustration of an embodiment of the accelerometer of FIG. 12b after an integrated passage has been exposed.

FIG. 13 is an illustration of an embodiment of the accelerometer of FIG. 12c packaged within a housing.

FIG. 14 illustrates a cross-sectional view of the accelerometer of FIG. 6 including re-entrant grooves formed in the surfaces of the top and bottom capacitor electrodes and the mass electrode patterns formed on the top and bottom measurement masses.

FIG. 15 is a fragmentary cross sectional illustration of one of the re-entrant grooves of the accelerometer of FIG. 14.

FIG. 16 is a top view of an embodiment of an electrode including re-entrant grooves.

FIG. 17 is a top view of an embodiment of an electrode including a plurality of re-entrant openings.

FIG. 17a is a partial cross sectional view of the electrode of FIG. 17.

FIG. 17b is a partial cross sectional view of the electrode of FIG. 17.

FIG. 18 is a top view of an embodiment of an electrode including a criss-crossing pattern of re-entrant grooves.

FIG. 19 is a top view of an embodiment of an electrode including a star burst pattern of re-entrant grooves.

FIG. 20 is a top view of an embodiment of an electrode including a star burst pattern of re-entrant grooves whose opening width increases toward the edges of the electrode.

FIG. 21a is a cross sectional illustration of a first substrate including a plurality of grooves.

FIG. 21b is a cross sectional illustration of the first substrate of FIG. 21a after bonding a second substrate having an internal etch stop layer onto the top surface of the first substrate.

FIG. 21c is a cross sectional illustration of the substrates of FIG. 21b after etching the second substrate down to the etch stop layer.

FIG. 21d is a cross sectional illustration of the substrates of FIG. 21c after deep reactive ion etching the second substrate to provide openings into the plurality of grooves.

FIG. 22a is a cross sectional illustration of a silicon substrate having a patterned layer of silicon dioxide.

FIG. 22b is a cross section illustration of the growth of a layer of silicon onto the layer of silicon dioxide of FIG. 22a.

FIG. 22c is a cross sectional illustration of the deep reactive ion etching of the layer of silicon of FIG. 22b to provide openings into the layer of silicon dioxide.

FIG. 22d is a cross sectional illustration of the removal of the layer of silicon dioxide.

FIG. 23a is a cross sectional illustration of the patterning of a layer of masking material onto a silicon substrate.

FIG. 23b is a cross sectional illustration of the formation of a re-entrant opening or groove in the silicon substrate of FIG. 23a.

FIG. 24a is a cross sectional illustration of the patterning of a layer of masking material onto a silicon substrate.

FIG. 24b is a cross sectional illustration of the etching of a recess in the exposed portions of the silicon substrate of FIG. 24a.

FIG. 24c is a cross sectional illustration of the patterning of another layer of a masking material onto the exposed portions of the silicon substrate of FIG. 24b.

FIG. 24d is a cross sectional illustration of the etching of a re-entrant opening or groove in the exposed portions of the silicon substrate of FIG. 24c.

### DETAILED DESCRIPTION OF THE ILLUSTRATIVE EMBODIMENTS

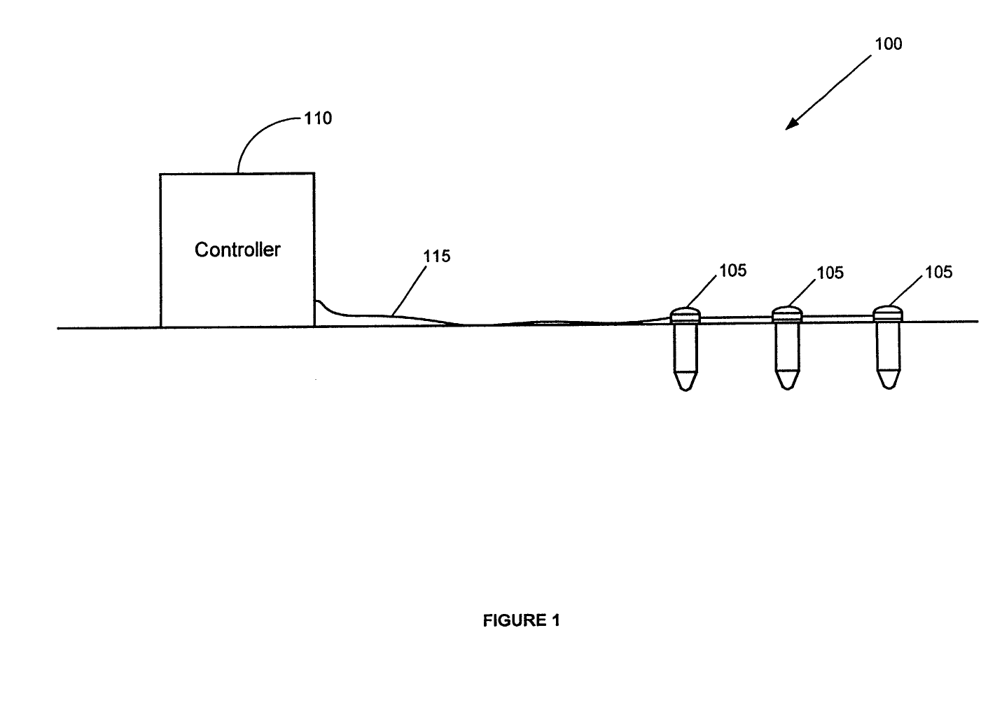

Referring initially to FIG. 1, a preferred embodiment of a system 100 designed to record data measurements is illustrated. The system 100 preferably includes one or more sensors 105, a controller 110, and cabling 115.

Within the system 100, the sensors 105 are used to detect data measurements. In a preferred embodiment, the system 100 is used in seismic applications to record seismic data measurements. The sensors 105 may be any number of conventional commercially available sensors, such as, for example, a geophone, a hydrophone, or an accelerometer. In a preferred embodiment, each of the sensors 105 is an accelerometer.

The controller 110 is used to monitor and control the sensors 105. The controller 110 is preferably coupled to the sensors 105 by the cabling 115. The controller 110 may be any number of conventional commercially available controllers suitable for controlling the sensors 105, such as, for example, a seismic data acquisition device, a PID controller, or a microcontroller. In a preferred embodiment, the controller 110 is a seismic data acquisition device.

The cabling 115 couples the sensors 105 and the controller 110. The cabling 115 may be any cabling suitable for transmitting information between the sensors 105 and controller 110, such as, for example, wire or fiber optics. In a preferred embodiment, the cabling 115 is a wire.

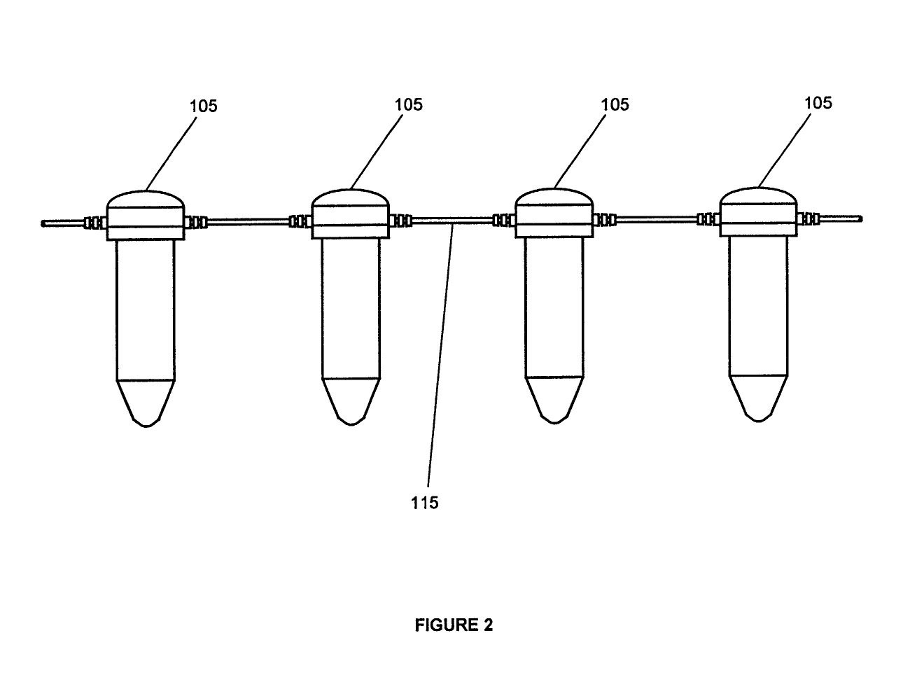

Referring to FIG. 2, a preferred embodiment of the alignment of the sensors 105 and the cabling 115 within the system 100 is illustrated. The sensors 105 and the cabling 115 may be aligned linearly or non-linearly. In a preferred embodiment, the sensors 105 and cabling 115 are aligned linearly.

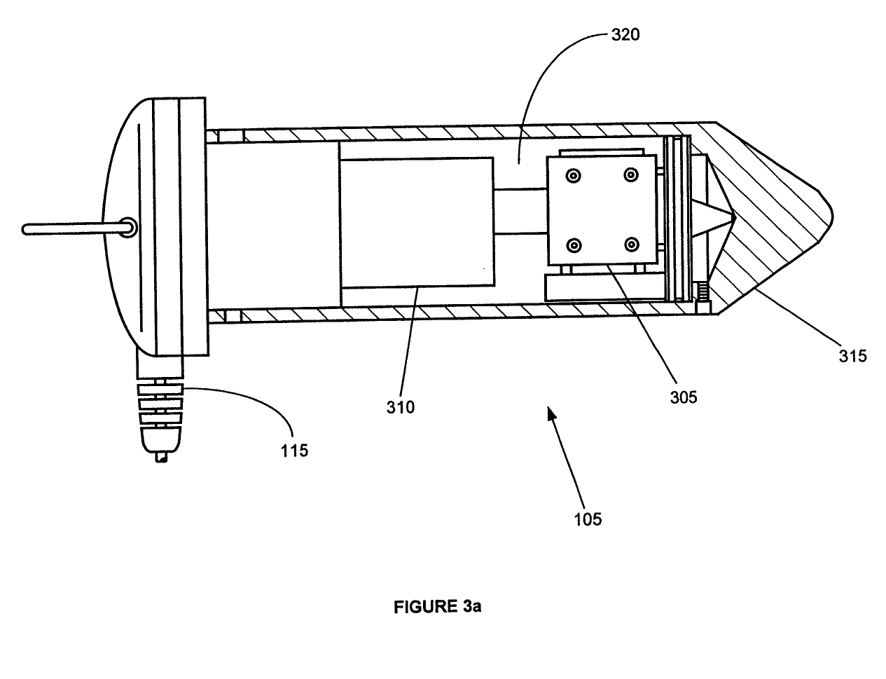

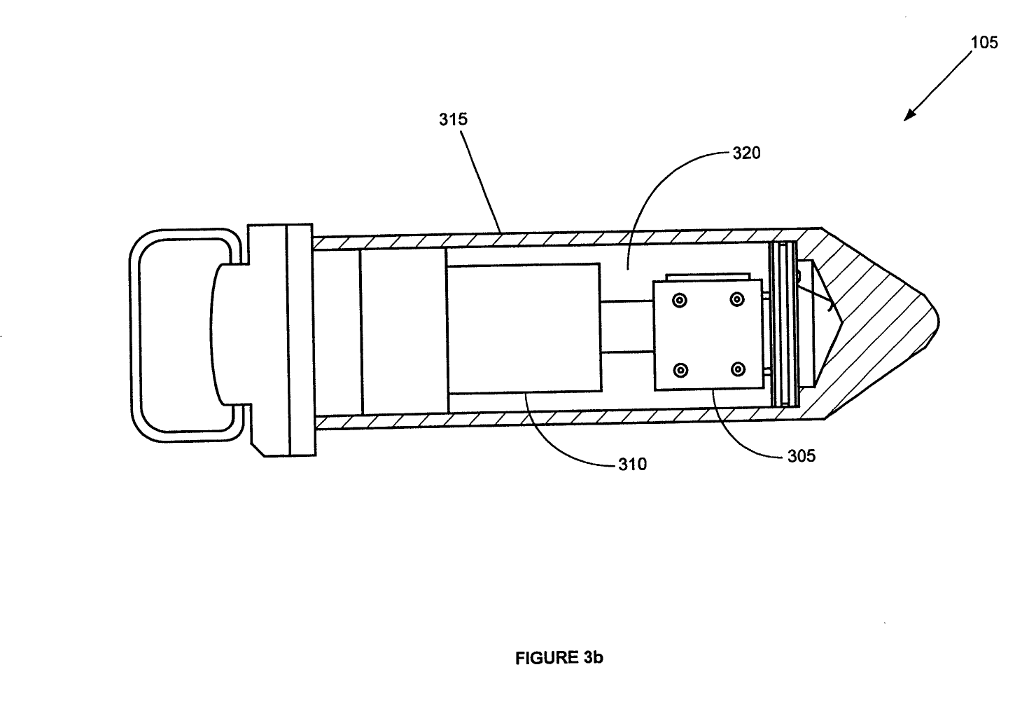

The sensors 105 may include any number of conventional commercially available components suitable for creating a sensor. Referring to FIGS. 3a and 3b, in a preferred embodiment, the sensors 105 include one or more accelerometers 305, and a housing 315 having a cavity 320. In another preferred embodiment, the sensors 105 further include a measurement device 310. In a preferred embodiment, the sensors 105 each include three accelerometers 305. The accelerometers 305 are preferably placed in the cavity 320 within the housing 315 of the sensor 105. The accelerometers 305 may be coupled to the measurement device 310, or may operate independently within the sensor 105. In a preferred embodiment, the accelerometers 305 operate independently within the sensor 105. The measurement device 310 may be any number of conventional commercially available devices suitable for coupling with the accelerometer 305 to create a sensor 105, such as, for example, a geophone or a hydrophone. In a preferred embodiment, the measurement device 310 is a hydrophone.

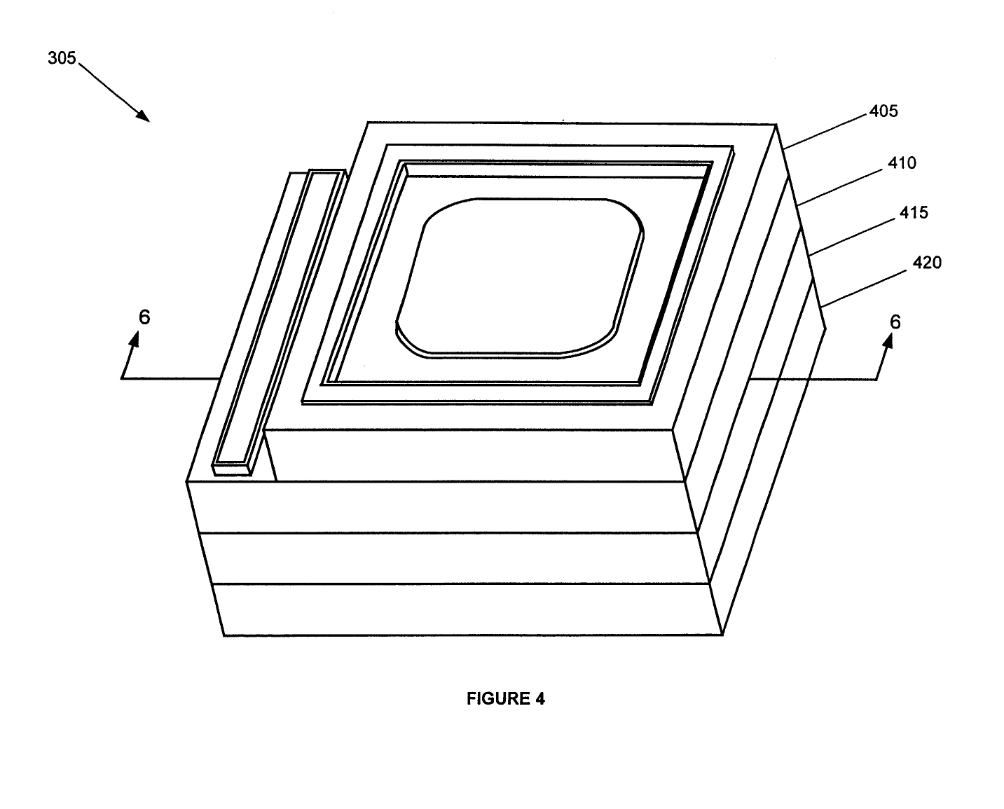

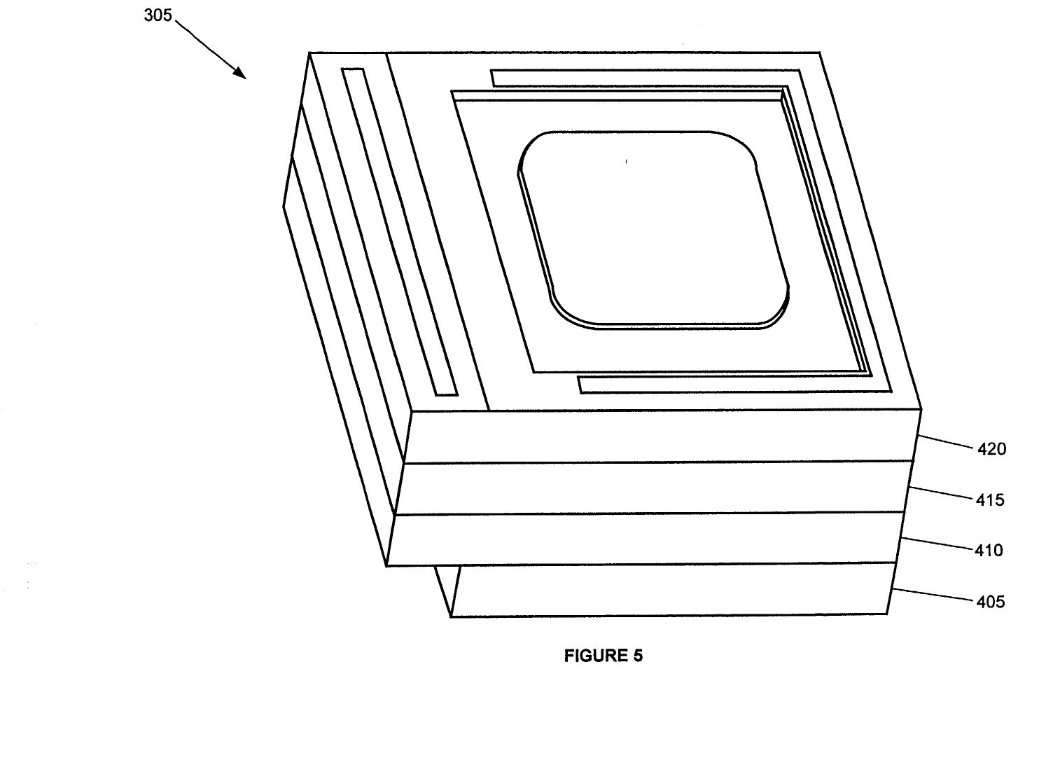

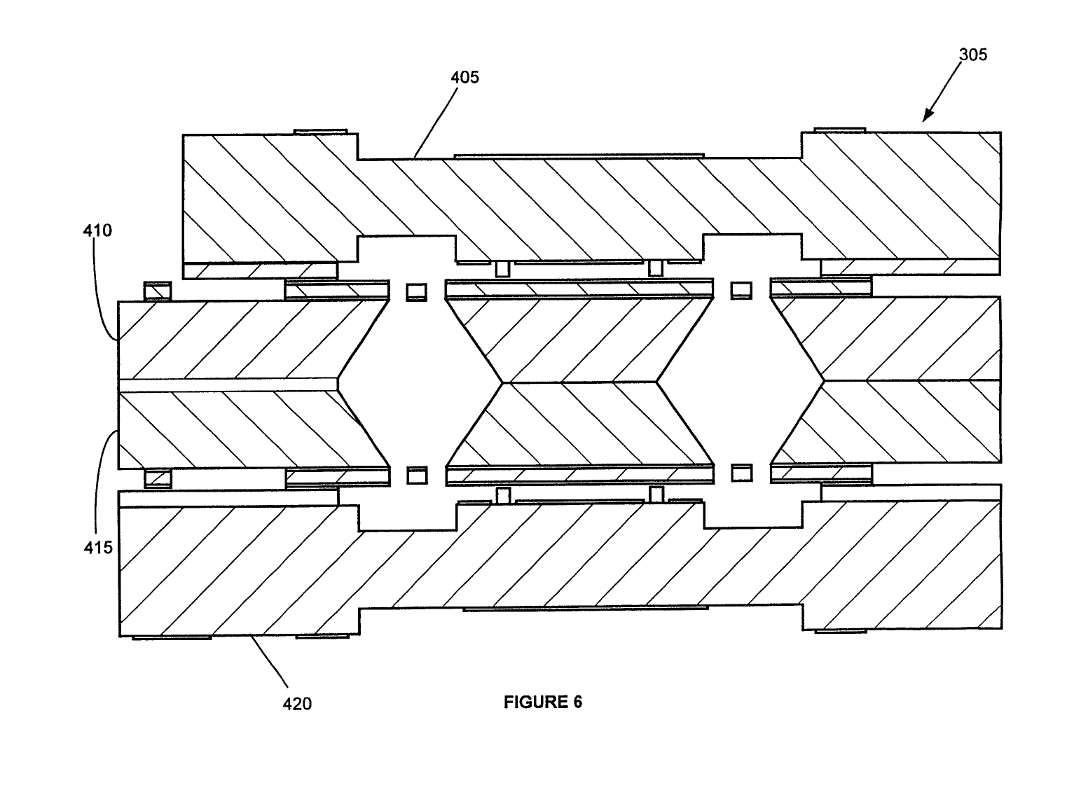

The accelerometer 305 may include any number of components suitable for forming an accelerometer. Referring to FIGS. 4, 5, and 6, in a preferred embodiment, the accelerometer 305 includes a top cap wafer 405, a top measurement mass half 410, a bottom measurement mass half 415, and a bottom cap wafer 420. The operation of the accelerometer 305 is preferably provided substantially as described in U.S. Pat. Nos. 5,852,242, 6,035,694, and PCT patent application serial number PCT/US00/40038, filed on Mar. 16, 2000, the disclosures of which is incorporated herein by reference.

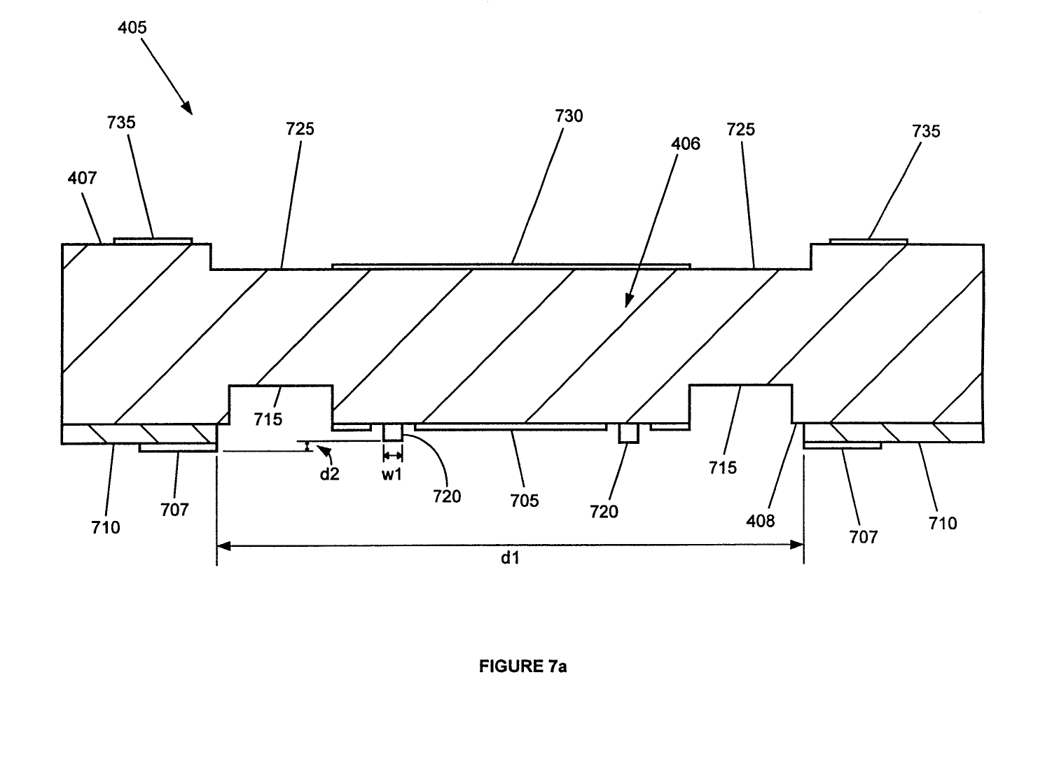

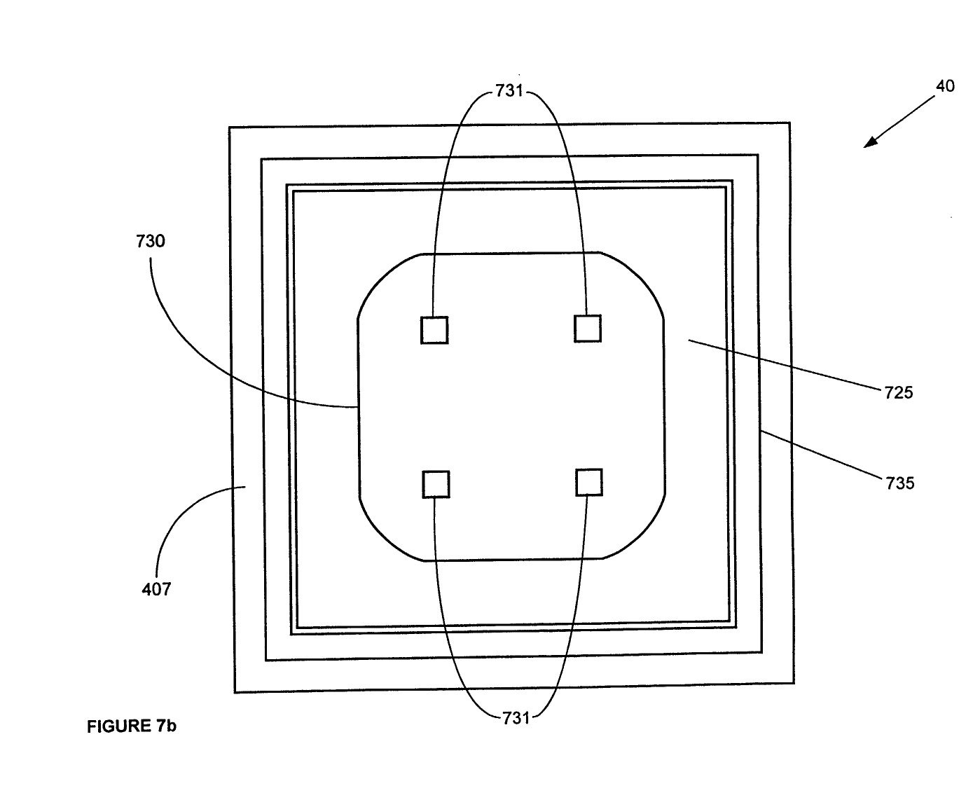

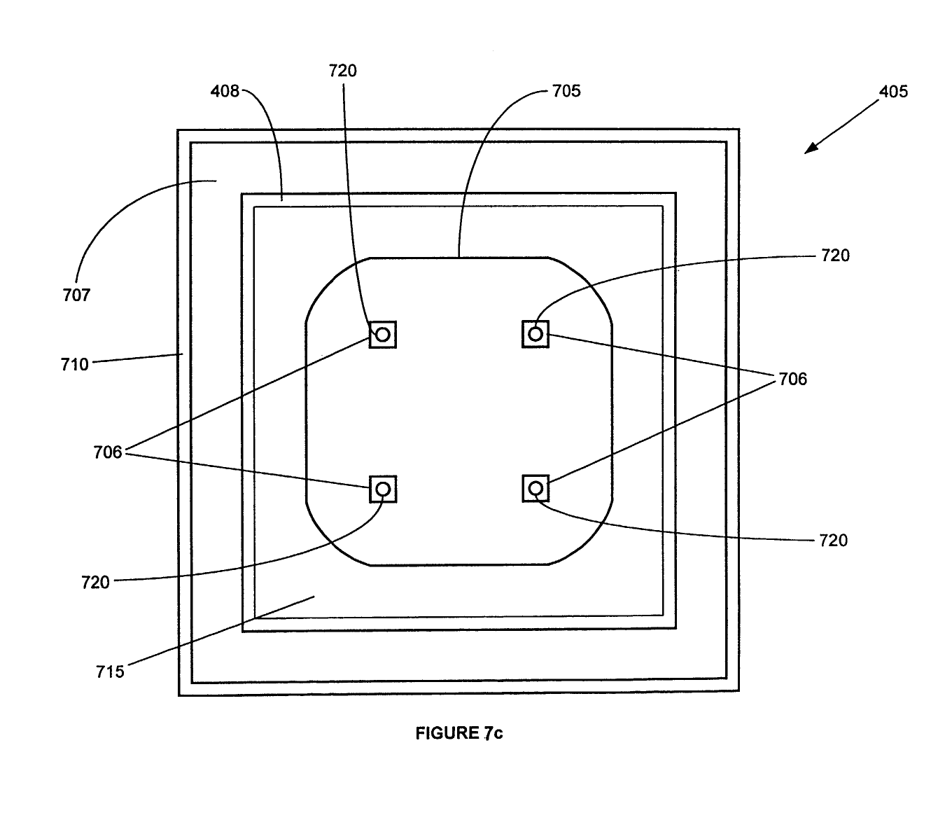

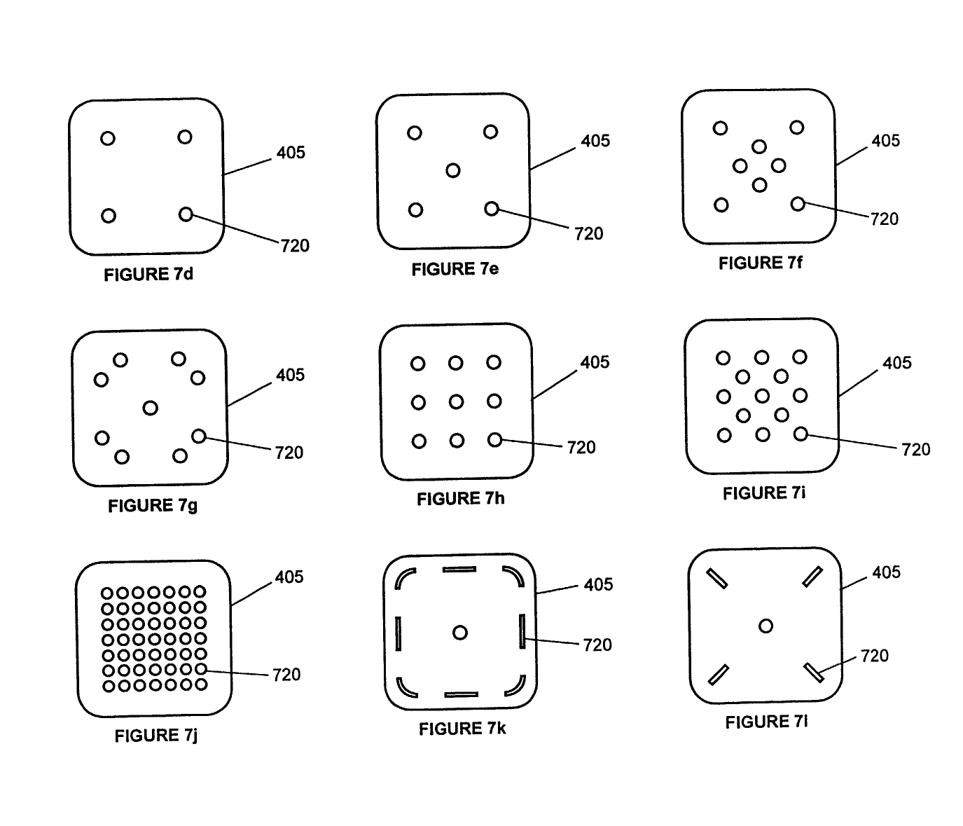

The top cap wafer 405 may include any number of conventional commercially available components suitable for forming a top cap wafer. In a preferred embodiment, as illustrated in FIGS. 7a, 7b, 7c, 7d, 7e, 7f, 7g, 7h, 7i, 7j, 7k, and 7l, the top cap wafer 405 includes a top cap wafer body 406, an upper surface 407, a bottom surface 408, a top capacitor electrode 705, a top bond ring 707, a top bond oxide ring 710, a top cap parasitic groove 715, top cap overshock bumpers 720, a top cap press frame recess 725, a top cap balanced metal pattern 730, and a top cap contact pad 735.

The top cap wafer body 406 may be fabricated from any number of conventional commercially available materials suitable for creating a cap wafer body, such as, for example, glass, quartz, ceramic, or silicon. In a preferred embodiment, the top cap wafer body 406 is made of silicon.

The top capacitor electrode 705 is preferably used for the time-based multiplexing of electrical signals from an external circuit, the operation of which is substantially as described in PCT patent application serial number PCT/US00/40038, filed on Mar. 16, 2000, the disclosure of which is incorporated herein by reference. The top capacitor electrode 705 is preferably located on the bottom surface 408 of the top cap wafer body 406, within an area circumscribed by the top cap parasitic groove 715. In a preferred embodiment, as illustrated in FIG. 7c, the top capacitor electrode 705 includes slots 706 into which the top cap overshock bumpers 720 are fabricated. The top capacitor electrode 705 may be fabricated from any number of conductive materials suitable for creating an electrode, such as, for example, metals, silicides, or doped semiconductors. In a preferred embodiment, the top capacitor electrode 705 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide.

The top bond ring 707 and the top bond oxide ring 710 preferably bond the top cap wafer 405 to the top measurement mass half 410 and help establish a narrow gap between the top capacitor electrode 705 and an electrode located on an upper surface of the top measurement mass half 410. The top bond oxide ring 710 preferably provides electrical isolation between the top cap wafer 405 and the top measurement mass half 410. The top bond ring 707 and the top bond oxide ring 710 are preferably located on the bottom surface 408 of the top cap wafer body 406. The top bond ring 707 may be fabricated from any number of materials suitable for making a bond ring, such as, for example, gold, silver, or aluminum. In a preferred embodiment, the top bond ring 707 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide. The bond ring 707 may have any dimensions suitable for use within the accelerometer 305. In a preferred embodiment, as illustrated in FIG. 7a, the bond ring 707 has a width d1 that is smaller than the width of the top cap press frame recess 725. In a preferred embodiment, the bond ring 707 extends below the top cap overshock bumpers 720 by a distance d2. The top bond oxide ring 710 may be fabricated from any number of conventional commercially available materials suitable for making a bond oxide ring, such as, for example, silicon dioxide or dielectrics. In a preferred embodiment, the top bond oxide ring 710 is fabricated from silicon dioxide.

The top cap parasitic groove 715 preferably minimizes the coupling of electrostatic feedback of an external close-loop circuit to springs included in the top measurement mass half 410. The top cap parasitic groove 715 preferably is a groove within the bottom surface 408 of the top cap wafer body 406. The top cap parasitic groove 715 preferably circumscribes the top capacitor electrode 705 and is surrounded by the top bond oxide ring 710. The top cap parasitic groove 715 may include any dimensions suitable for creating an adequate parasitic groove. In a preferred embodiment, the top cap parasitic groove 715 measures greater than about 5 microns in depth and has a width wider than the width of the springs within the top measurement mass half 410.

The top cap overshock bumpers 720 preferably provide out-of-plane shock protection to the top measurement mass half 410. The top cap overshock bumpers 720 are preferably located on the bottom surface 408 of the top cap wafer body 406, and are exposed through the cutouts 706 in the top capacitor electrode 705. The top cap overshock bumpers 720 may be fabricated from any number of conventional commercially available materials suitable for creating overshock bumpers, such as, for example, silicon dioxide or dielectrics. In a preferred embodiment, the top cap overshock bumpers 720 are made of silicon dioxide. In a preferred embodiment, as illustrated in FIG. 7a, the top cap overshock bumpers 720 have a width w1. The top cap wafer 405 may include any number of top cap overshock bumpers 720. The design and layout of the top cap overshock bumpers 720 may be affected by any number of factors. In a preferred embodiment, the design and layout of the top cap overshock bumpers 720 balances the need for shock protection with the need for minimal stiction between the top cap overshock bumpers 720 and a mass electrode pattern 910 located on the top measurement mass half 410. Stiction occurs when the top cap overshock bumpers 720 stick to the mass electrode pattern 910 on the top measurement mass half 410 during the operation of the accelerometer 305. The stiction between the top cap overshock bumpers 720 and the mass electrode pattern located on the top measurement mass half 410 may be caused by any number of sources, such as, for example, imprinting of the top cap overshock bumpers 720 onto the mass electrode pattern 910 located on the top measurement mass half 410, Van Der Waals forces, electrostatic forces, surface residues resulting from the fabrication of the accelerometer 305, or package-induced stresses. In a preferred embodiment, as illustrated in FIG. 7d, the top cap wafer 405 includes four bumpers. In an alternative embodiment, as illustrated in FIG. 7e, the top cap wafer 405 includes five top cap overshock bumpers 720. In an alternative embodiment, as illustrated in FIG. 7f, the top cap wafer 405 includes eight geometrically arranged top cap overshock bumpers 720. In an alternative embodiment, as illustrated in FIG. 7g, the top cap wafer 405 includes nine geometrically arranged top cap overshock bumpers 720. In an alternative embodiment, as illustrated in FIG. 7h, the top cap wafer 405 includes nine top cap overshock bumpers 720 arranged in three linear, parallel rows with each row having three bumpers 720. In an alternative embodiment, as illustrated in FIG. 7i, the top cap wafer 405 includes thirteen geometrically arranged top cap overshock bumpers 720. In an alternative embodiment, as illustrated in FIG. 7j, the top cap wafer 405 includes forty nine top cap overshock bumpers 720. In an alternative embodiment, as illustrated in FIGS. 7k and 7l, the top cap wafer 405 includes a plurality of geometrically arranged top cap overshock bumpers 720 in the shape of circles and ridges.

The top cap press frame recess 725 is preferably located on the upper surface 407 of the top cap wafer body 406 between the top cap balanced metal pattern 730 and the top cap contact pad 735. The top cap press frame recess 725 preferably ensures that bond forces applied during a bonding process are localized to the top bond oxide ring 710 region. By localizing bond forces to the top bond oxide ring 710 region rather than to the region of the narrow gap between the top capacitor electrode 705 and the electrode located on an upper surface of the top measurement mass half 410, the narrow gap between the electrodes is maintained. The top cap press frame recess 725 may be formed using any number of processing steps suitable for forming a press frame recess such as, for example, silicon etching. In a preferred embodiment, the top cap press frame recess 725 is etched into the upper surface 407 of the top cap wafer body 406. The top cap press frame recess 725 may include any dimensions suitable for creating a press frame recess. In a preferred embodiment, the top cap press frame recess 725 measures greater than about 20 microns in depth, and has a width wider than the width d1 of the bond ring 707.

The top cap contact pad 735 is preferably located on the upper surface 407 of the top cap wafer body 406. The top cap contact pad 735 is preferably available for wire bonding. The top cap contact pad 735 may include any number of conventional commercially available materials suitable for creating a contact pad such as, for example, gold, aluminum, or silver. In a preferred embodiment, the top cap contact pad 735 is made of gold. In another preferred embodiment, the top cap contact pad 735 is made of a combination of gold and titanium. In a preferred embodiment, the combination of gold and titanium includes a layer of gold located on top of a layer of titanium. The layer of titanium preferably improves the adhesion of the gold to silicon and silicon dioxide.

The top cap balanced metal pattern 730 is used to minimize bowing of the top cap wafer body 406. Bowing of the top cap wafer body 406 is undesirable because it has an adverse effect on the performance of the accelerometer 305. Bowing of the top cap wafer body 406 typically results from thermal coefficient of expansion (TCE) differences between the material of the top cap wafer body 406 and the metal of the top capacitor electrode 705. In a preferred embodiment, the material of the top cap wafer body 406 is silicon. In a preferred embodiment, the top cap balanced metal pattern 730 is approximately identical in pattern and thickness to the top capacitor electrode 705 and is placed within the top cap press frame recess 725, substantially opposite the top capacitor electrode 705. In a preferred embodiment, the top cap balanced metal pattern 730 includes cutouts 731 to offset the cutouts 705 in the top capacitor electrode 705. This alignment preferably creates a balanced metal/silicon/metal sandwich that helps minimize the TCE mismatch effects on accelerometer 305 performance.

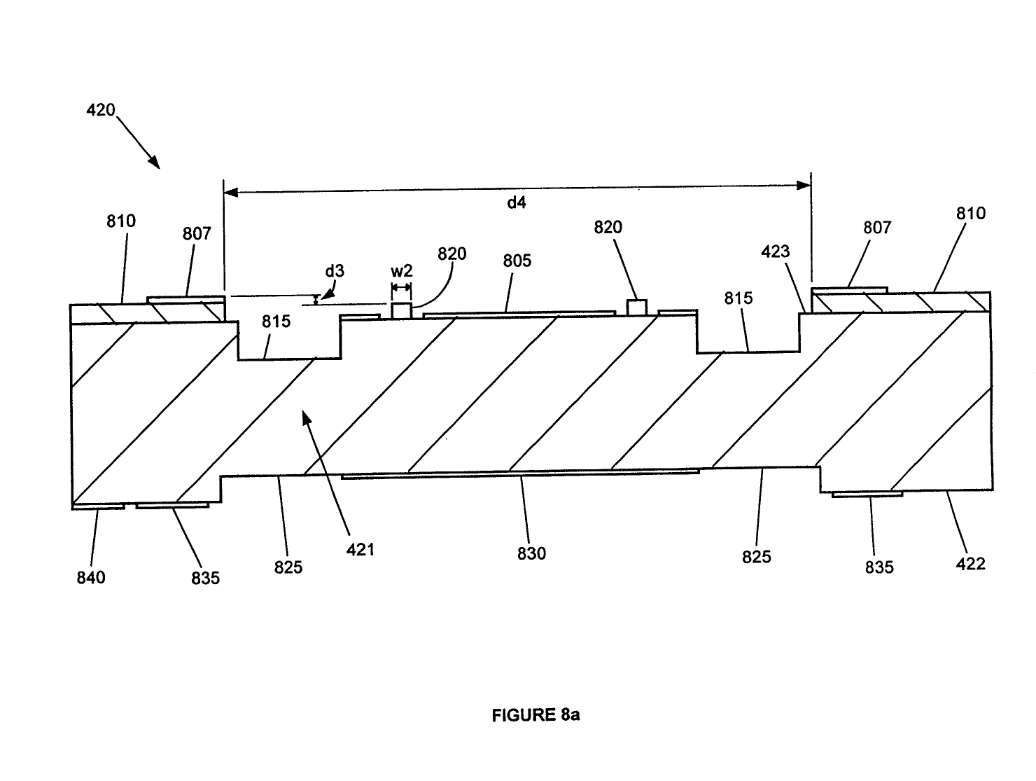

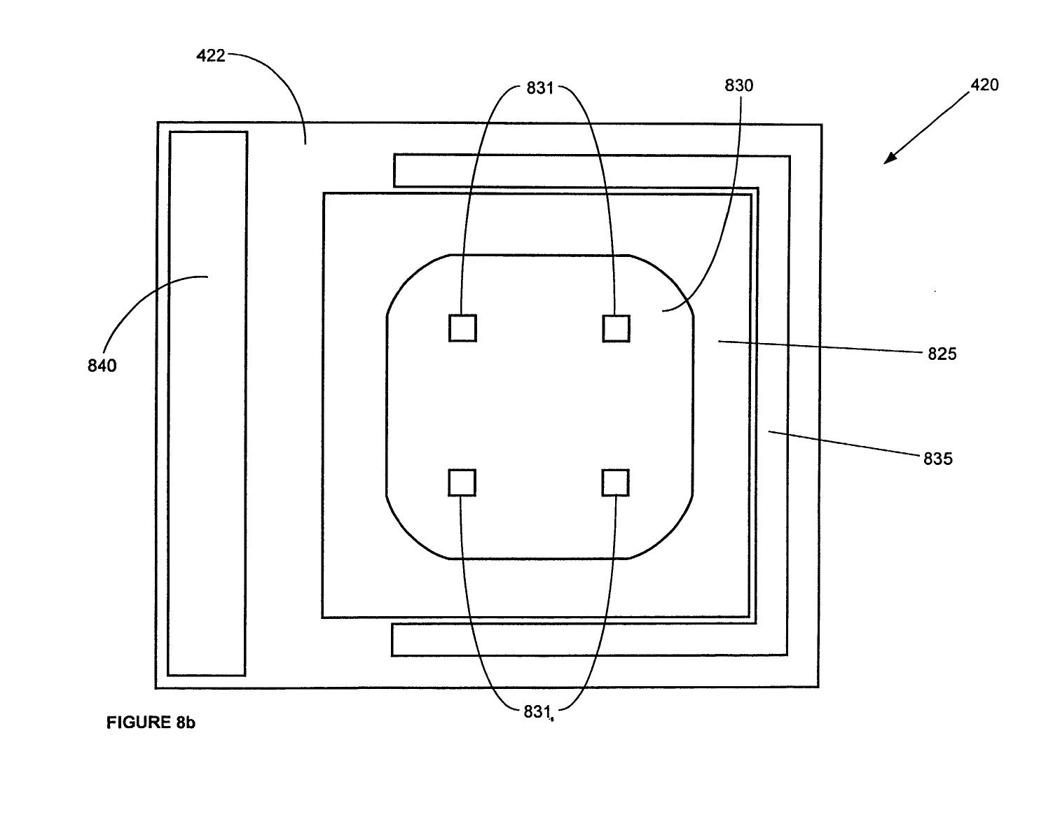

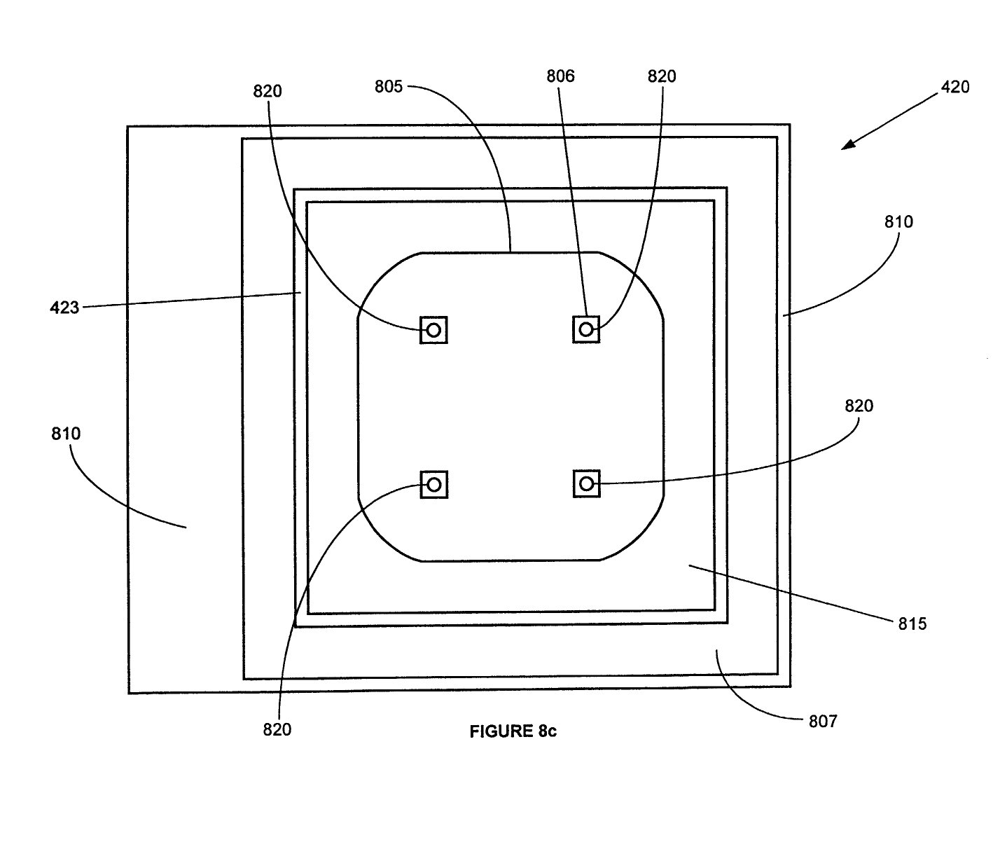

The bottom cap wafer 420 may include any number of conventional commercially available components suitable for forming a bottom cap wafer. In a preferred embodiment, as illustrated in FIGS. 8a, 8b, and 8c, the bottom cap wafer 420 includes a bottom cap wafer body 421, an upper surface 423, a bottom surface 422, a bottom capacitor electrode 805, a bottom bond ring 807, a bottom bond oxide ring 810, a bottom cap parasitic groove 815, bottom cap overshock bumpers 820, a bottom cap press frame recess 825, a bottom cap balanced metal pattern 830, a bottom cap contact pad 835, and an extended cap solder attach (ECSA) metal bond pad 840.

The bottom cap wafer body 421 may be fabricated from any number of conventional commercially available materials suitable for creating a cap wafer body such as, for example, glass, quartz, ceramic, or silicon. In a preferred embodiment, the bottom cap wafer body 421 is made of silicon.

The bottom capacitor electrode 805 is preferably used for the time-based multiplexing of electrical signals from an external circuit, the operation of which is substantially as described in PCT patent application serial number PCT/US00/40038, filed on Mar. 16, 2000, the disclosure of which is incorporated herein by reference. The bottom capacitor electrode 805 is preferably located on the upper surface 423 of the bottom cap wafer body 421, within an area circumscribed by the bottom cap parasitic groove 815. In a preferred embodiment, as illustrated in FIG. 8c, the bottom capacitor electrode 805 includes cutouts 806 into which the bottom cap overshock bumpers 820 are fabricated. The bottom capacitor electrode 805 may be fabricated using any number of conductive materials suitable for creating an electrode such as, for example, metals, suicides, or doped semiconductors. In a preferred embodiment, the bottom capacitor electrode 805 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide.

The bottom bond ring 807 and the bottom bond oxide ring 810 preferably bond the bottom cap wafer 420 to the bottom measurement mass half 415 and help establish a narrow gap between the bottom capacitor electrode 805 and an electrode located on a lower surface of the bottom measurement mass half 415. The bottom bond oxide ring 810 preferably provides electrical isolation between the bottom cap wafer 420 and the bottom measurement mass half 415. The bottom bond ring 807 and the bottom bond oxide ring 810 are preferably located on the upper surface 423 of the bottom cap wafer body 421. The bottom bond ring 807 may be fabricated from any number of materials suitable for making a bond ring such as, for example, aluminum, silver, or gold. In a preferred embodiment, the bottom bond ring 807 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide. In a preferred embodiment, the bond ring 807 has a width d4 that is smaller than the width of the bottom cap press frame recess 825. In a preferred embodiment, the bond ring 807 extends beyond the bottom cap overshock bumpers 820 by a distance d3. The bottom bond oxide ring 810 may include any number of conventional commercially available materials suitable for making a bond oxide ring such as, for example, dielectrics. In a preferred embodiment, the bottom bond oxide ring 810 is fabricated from silicon dioxide.

The bottom cap parasitic groove 815 preferably minimizes the coupling of electrostatic feedback of an external close-loop circuit to springs included in the bottom measurement mass half 415. The bottom cap parasitic groove 815 preferably is a groove within the upper surface 423 of the bottom cap wafer body 421. The bottom cap parasitic groove 815 preferably circumscribes the bottom capacitor electrode 805, and is surrounded by the bottom bond oxide ring 810. The bottom cap parasitic groove 815 may include any dimensions suitable for creating an adequate parasitic groove. In a preferred embodiment, the bottom cap parasitic groove 815 measures greater than about 5 microns in depth and has a width wider than the width of the springs within the bottom measurement mass half 415.

The bottom cap overshock bumpers 820 preferably provide out-of-plane shock protection to the bottom measurement mass half 415. The bottom cap overshock bumpers 820 are preferably located on the upper surface 423 of the bottom cap wafer body 421, and are exposed through the cutouts 806 in the bottom capacitor electrode 805. The bottom cap overshock bumpers 820 may be fabricated from any number of conventional commercially available materials suitable for creating overshock bumpers, such as, for example, dielectrics or silicon dioxide. In a preferred embodiment, the bottom cap overshock bumpers 820 are made of silicon dioxide. In a preferred embodiment, the bottom cap overshock bumpers 820 have a width w2. The bottom cap wafer 420 may include any number of bottom cap overshock bumpers 820. The design and layout of the bottom cap overshock bumpers 820 may be affected by any number of factors. In a preferred embodiment, the design and layout of the bottom cap overshock bumpers 820 balances the need for good shock protection with the need for minimal stiction between the bottom cap overshock bumpers 820 and a mass electrode pattern 915 located on the bottom measurement mass half 415. Stiction occurs when the bottom cap overshock bumpers 820 stick to the mass electrode pattern 915 on the bottom measurement mass half 415 during the operation of the accelerometer 305. The stiction between the bottom cap overshock bumpers 820 and the mass electrode pattern located on the bottom measurement mass half 415 may be caused by any number of sources, such as, for example, imprinting of the bottom cap overshock bumpers 820 onto the mass electrode pattern 915 located on the bottom measurement mass half 415, Van Der Waals forces, electrostatic forces, surface residues resulting from the manufacture of the accelerometer 305, or package-induced stresses. In a preferred embodiment, the number of bottom cap overshock bumpers 820 on the bottom cap wafer 420 equals the number of top cap overshock bumpers 720 on the top cap wafer 405, the variations of which are illustrated in FIGS. 7d, 7e, 7f, 7g, 7h, 7i, 7j, 7k, and 7l.

The bottom cap press frame recess 825 is preferably located on the bottom surface 422 of the bottom cap wafer body 421 between the bottom cap balanced metal pattern 830 and the outer edge of the bottom surface 422. The bottom cap press frame recess 825 ensures that bond forces applied during a bonding process are localized to the bottom bond oxide ring 810 region. By localizing bond forces to the bottom bond oxide ring 810 region rather than to the region of the narrow gap between the bottom capacitor electrode 805 and the electrode located on an bottom surface of the bottom measurement mass half 415, the narrow gap between the electrodes is maintained. The bottom cap press frame recess 825 may formed using any number of processing steps suitable for forming a press frame recess such as, for example, silicon etching. In a preferred embodiment, the bottom cap press frame recess 825 is etched into the bottom surface 422 of the bottom cap wafer body 421. The bottom cap press frame recess 825 may include any dimensions suitable for creating a press frame recess. In a preferred embodiment, the bottom cap press frame recess 825 measures greater than about 20 microns in height and has a width wider than the width d4 of the bond ring 807.

The bottom cap contact pad 835 is preferably located on the bottom surface 422 of the bottom cap wafer body 421. The bottom cap contact pad 835 is preferably available for wafer probing. The bottom cap contact pad 835 may include any number of conventional commercially available materials suitable for creating a contact pad such as, for example, gold, aluminum, or silver. In a preferred embodiment, the bottom cap contact pad 835 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide.

The bottom cap balanced metal pattern 830 is used to minimize bowing of the bottom cap wafer body 421. Bowing of the bottom cap wafer body 421 is undesirable because it has an adverse effect on the performance of the accelerometer 305. Bowing of the bottom cap wafer body 421 typically results from thermal coefficient of expansion (TCE) differences between the material that makes up the bottom cap wafer body 421 and the metal of the bottom capacitor electrode 805. In a preferred embodiment, the material that makes up the bottom cap wafer body 421 is silicon. In a preferred embodiment, the bottom cap balanced metal pattern 830 is approximately identical in pattern and thickness to the bottom capacitor electrode 805 and is placed within the bottom cap press frame recess 825, substantially opposite the bottom capacitor electrode 805. As illustrated in FIG. 8b, the bottom cap balanced metal pattern 830 preferably includes cutouts 831 designed to offset the cutouts 806 in the bottom capacitor electrode 805. This alignment preferably creates a balanced metal/silicon/metal sandwich that helps minimize the TCE mismatch effects on accelerometer 305 performance.

The ECSA metal bond pad 840 is preferably available for conductive die-attach to an external package into which the accelerometer 305 is placed. The operation of the ECSA metal bond pad 840 is preferably as described in PCT patent application serial number PCT/US00/06832, filed on Mar. 15, 2000, the disclosure of which is incorporated herein by reference.

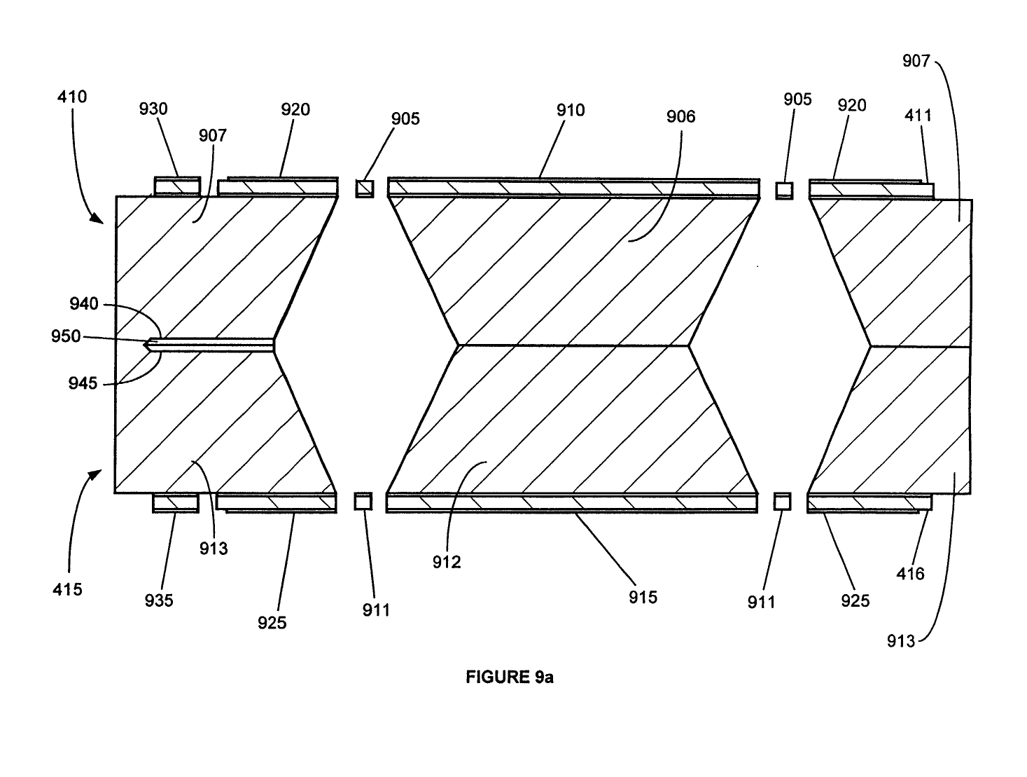

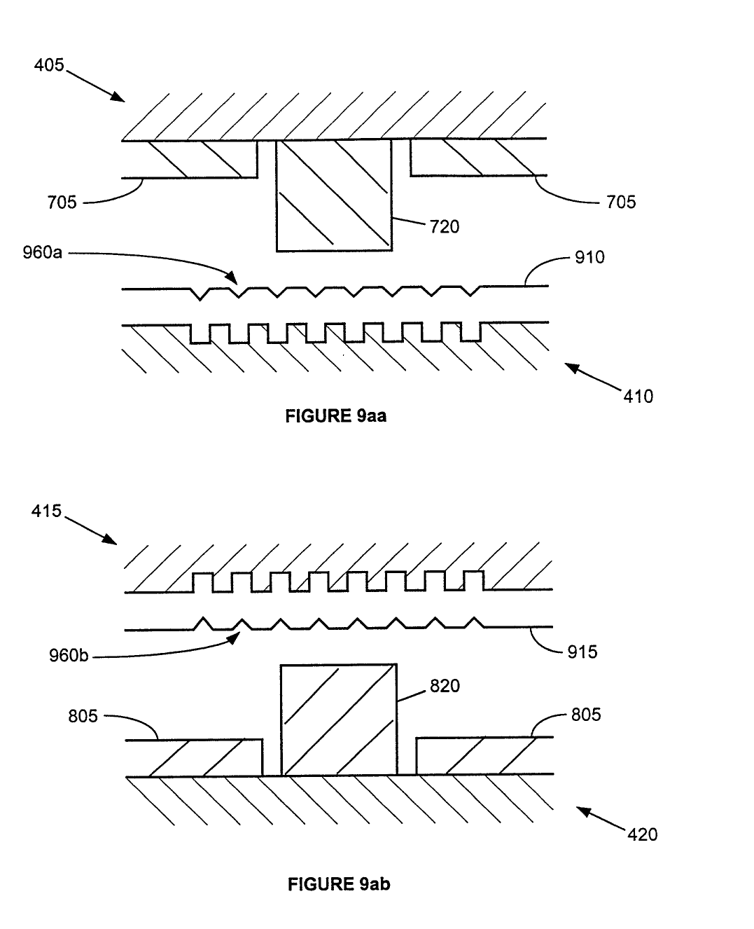

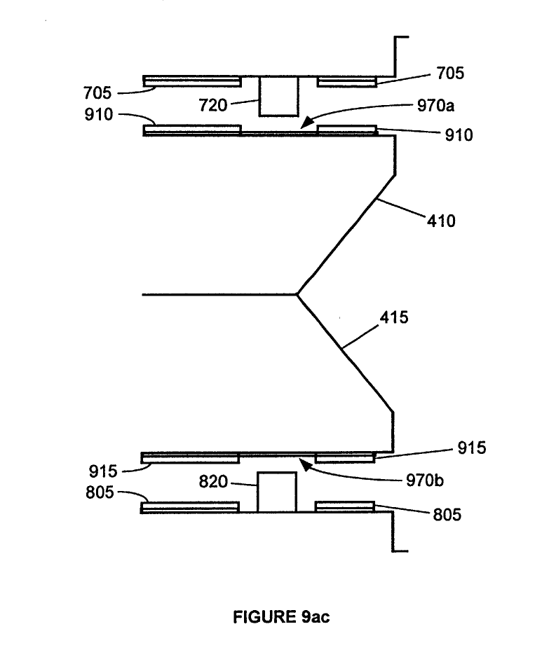

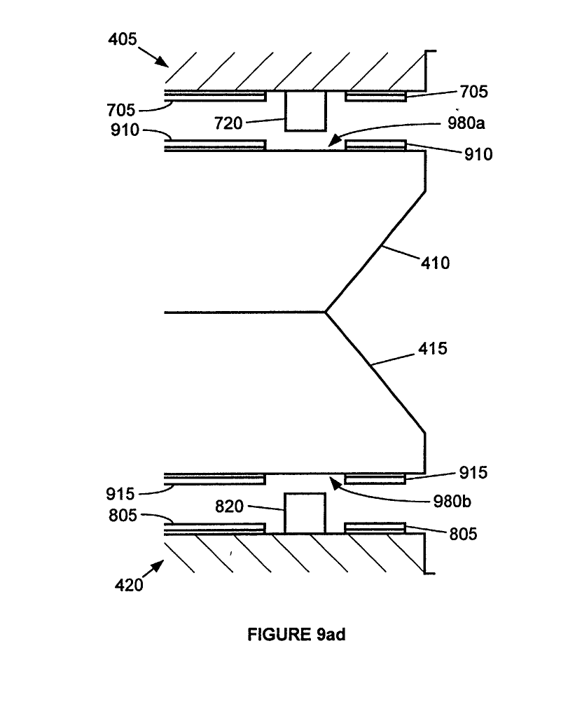

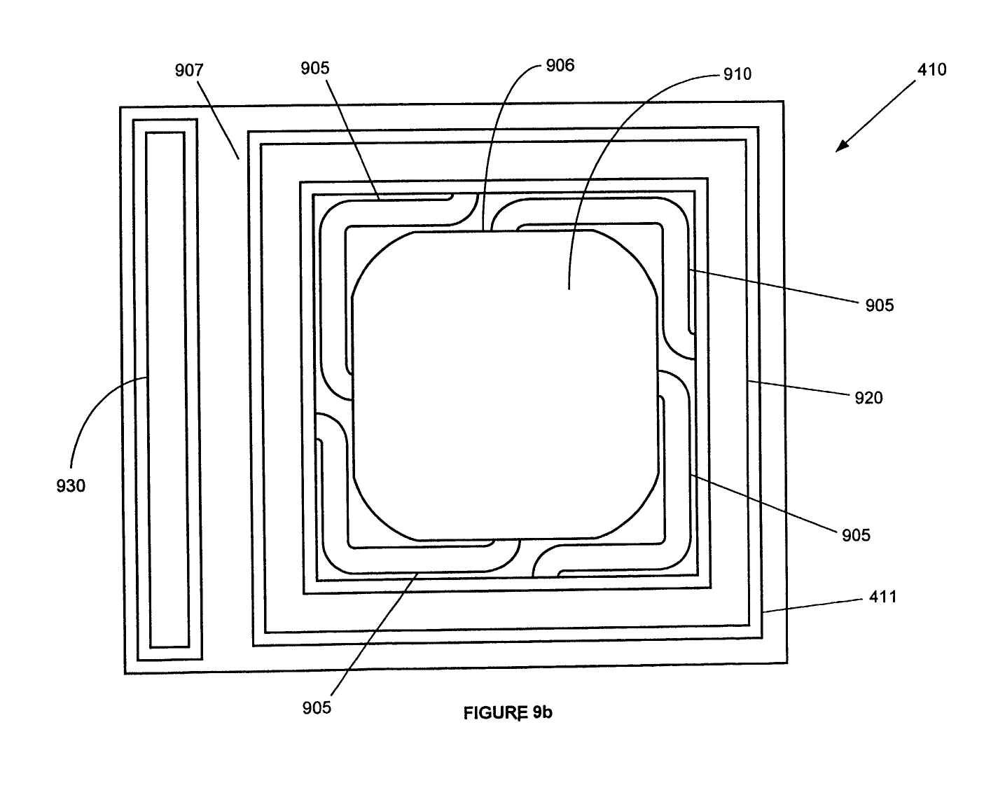

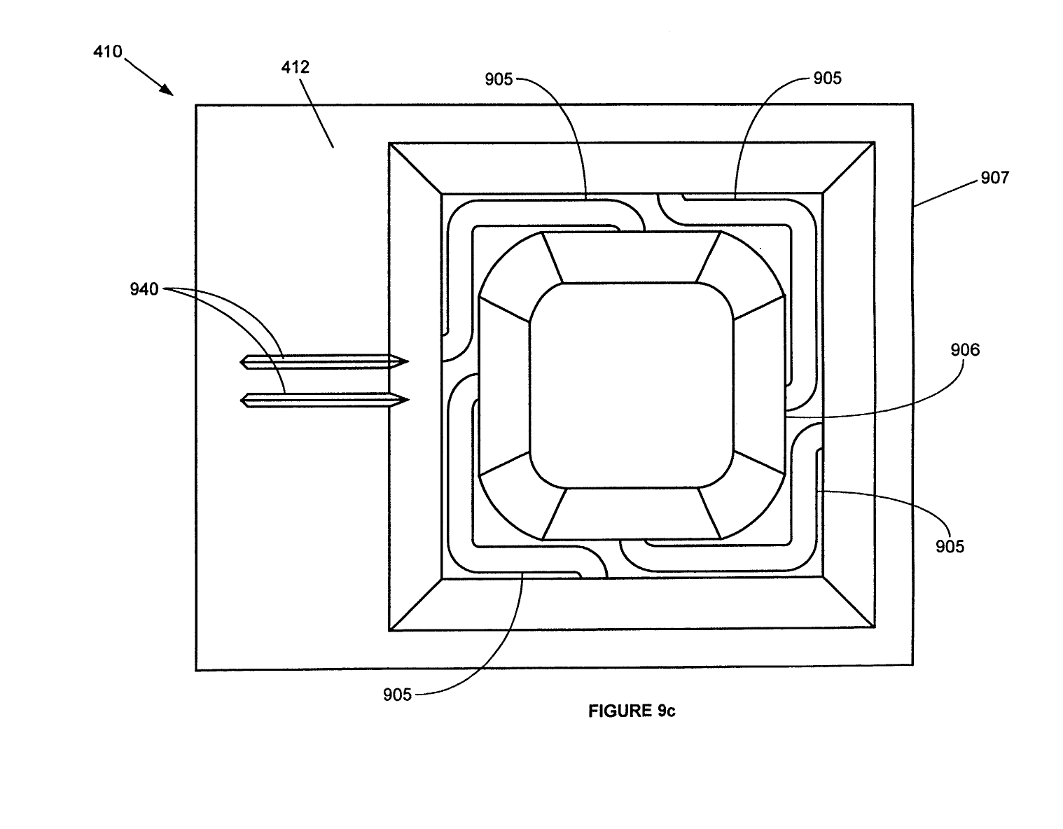

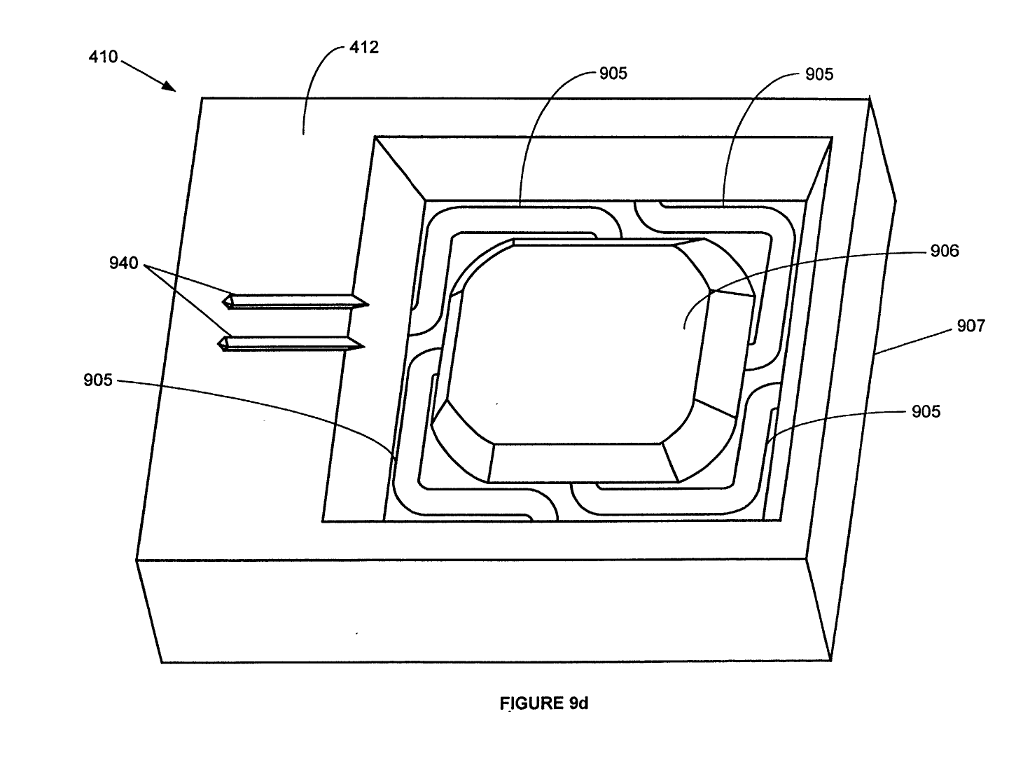

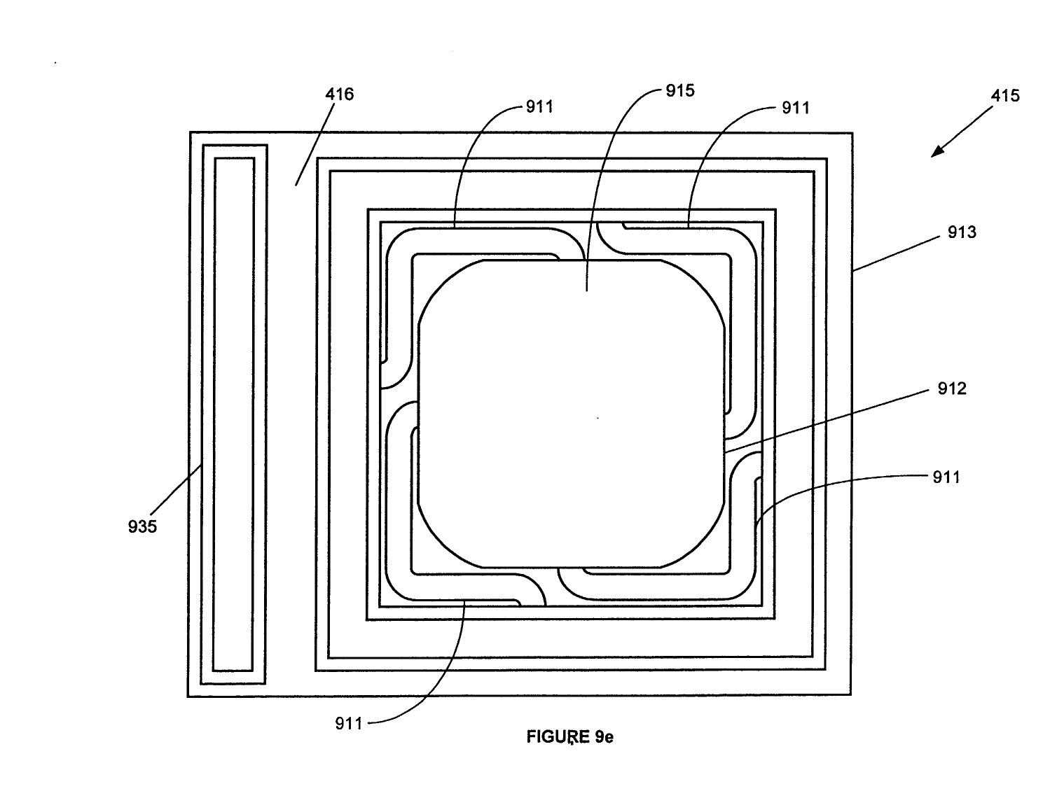

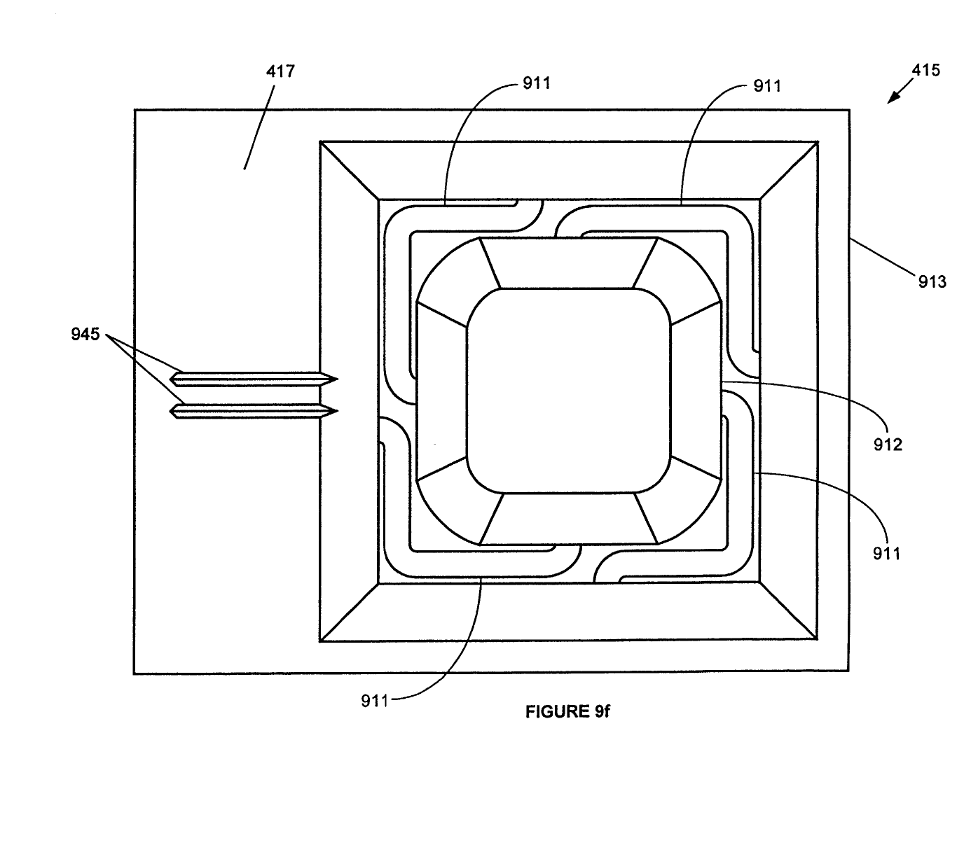

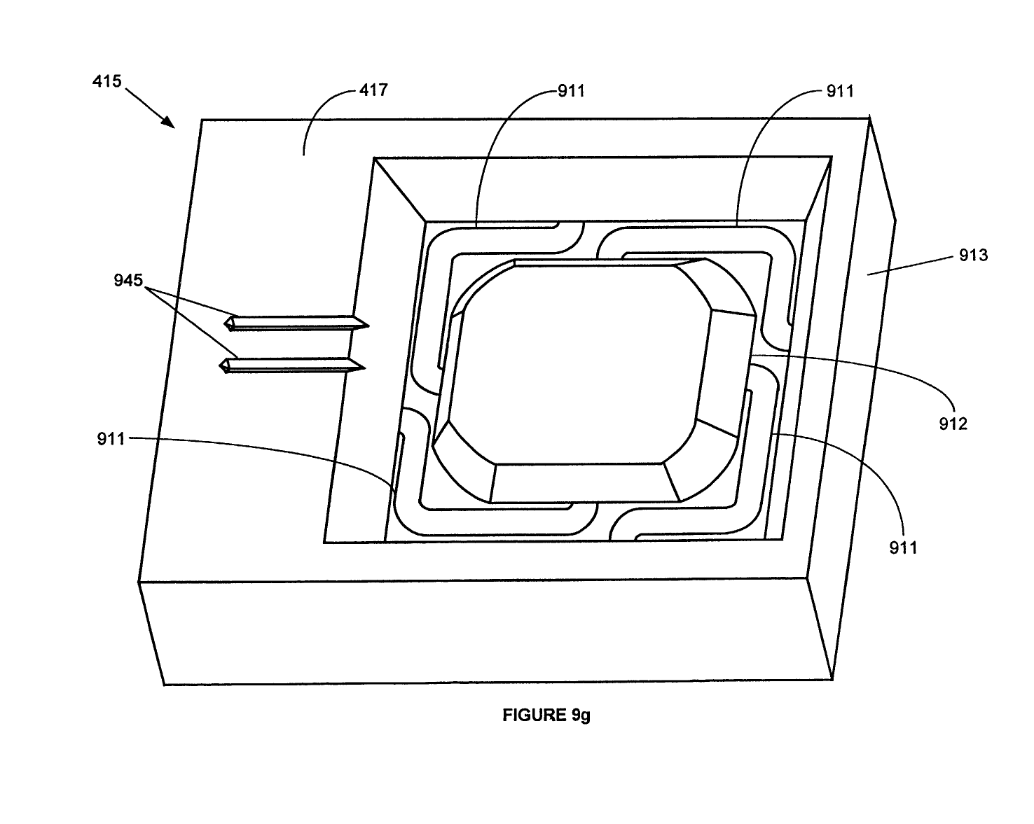

The top measurement mass half 410 may include any number of conventional commercially available materials suitable for creating a measurement mass half. In a preferred embodiment, as illustrated in FIGS. 9a, 9aa, 9ac, 9ad, 9b, 9c, and 9d, the top measurement mass half 410 includes an upper surface 411, a lower surface 412, one or more springs 905, a top measurement mass 906, a housing 907, the mass electrode pattern 910, a bond ring 920, and a top mass contact pad 930. In another preferred embodiment, the top measurement mass half 410 further includes a groove 940.

The springs 905 preferably couple the top measurement mass 906 to the housing 907 and provide a conductive path between the top measurement mass 906 and the housing 907. The springs 905 may be fabricated from any number of conventional commercially available materials suitable for creating springs such as, for example, quartz, metals, or silicon. In a preferred embodiment, the springs 905 are made of silicon, and are micromachined out of the top measurement mass half 410 wafer. The springs 911 are preferably designed to maintain cross-axis rejection while providing lateral shock protection for the top measurement mass 906. The springs 905 are preferably linear L-shaped springs, the design of which is described in U.S. Pat. Nos. 5,652,384 and 5,777,226, the disclosures of which are incorporated herein by reference.

The top measurement mass 906 is used to detect measurement data. The top measurement mass 906 may be used in any application in which its use is suitable. In a preferred embodiment, the top measurement mass 906 is used in seismic applications to detect acceleration. The top measurement mass 906 is preferably coupled to the housing 907 by the springs 905. The top measurement mass 906 may be fabricated from any number of conventional commercially available materials suitable for creating a measurement mass such as, for example, metals, quartz, or silicon. In a preferred embodiment, the top measurement mass 906 is made of silicon, and is micromachined out of the top measurement mass half 410 wafer.

The housing 907 surrounds the top measurement mass 906 and is coupled to the top measurement mass 906 by the springs 905. The housing 907 may be fabricated from any number of conventional commercially available materials suitable for creating a housing such as, for example, metals, quartz, or silicon. In a preferred embodiment, the housing 907 is fabricated from silicon, and is micromachined out of the top measurement mass half 410 wafer.

The mass electrode pattern 910 is used for the time-based multiplexing of electrical signals from an external circuit. In a preferred embodiment, the mass electrode pattern 910 includes a single electrode. In a preferred embodiment, the mass electrode pattern 910 is located on the upper surface 411 of the top measurement mass half 410, on top of the top measurement mass 906. The mass electrode pattern 910 may include any number of conventional commercially available materials suitable for creating an electrode pattern such as, for example, aluminum, silver, or gold. In a preferred embodiment, the mass electrode pattern 910 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide. In an alternative embodiment, the mass electrode pattern 910 may be fabricated from any number of conductive materials suitable for creating an electrode, such as, for example, metals, silicides, or doped semiconductors.

The mass electrode pattern 910 may be of any size or shape suitable for forming an electrode pattern such as, for example, circular, square, or rectangular. The mass electrode pattern 910 is preferably substantially identical in size and shape to the top capacitor electrode 705. In an alternative embodiment, the mass electrode pattern 910 is substantially equal in thickness to the bond ring 920. In a preferred embodiment, the thicknesses of the mass electrode pattern 910 and the bond ring 920 are smaller than the thickness of the top bond ring 707. The difference in thickness between the mass electrode pattern 910, the bond ring 920, and the top bond ring 707 preferably reduces stiction between the top cap overshock bumpers 720 and the mass electrode pattern 910 during the operation of the accelerometer 305 by reducing the imprinting of the top cap overshock bumpers 720 on the mass electrode pattern 910.

In another preferred embodiment, as illustrated in FIG. 9aa, the mass electrode pattern 910 includes one or more patterns 960a designed to minimize stiction between the top cap overshock bumpers 720 and the mass electrode pattern 910 during the operation of the accelerometer 305. The patterns 960a may include any shape suitable for reducing stiction within the accelerometer 305. The patterns 960a in the mass electrode pattern 910 preferably reduce stiction between the top cap overshock bumpers 720 and the mass electrode pattern 910 by minimizing the surface area of the region of intimate contact between the top cap overshock bumpers 720 and the mass electrode pattern 910.

In another preferred embodiment, as illustrated in FIG. 9ac, the mass electrode pattern 910 includes one or more reduced-thickness recesses 970a at areas in which the top cap overshock bumpers 720 come in contact with the mass electrode pattern 910. The reduced-thickness recesses 970a in the mass electrode pattern 910 are preferably designed to reduce stiction between the top cap overshock bumpers 720 and the mass electrode pattern 910. The reduced-thickness recesses 970a may be formed using any suitable method for forming reduced-thickness recesses in the mass electrode pattern 910. In a preferred embodiment, the reduced-thickness recesses 970a are formed by removing the gold layer from the mass electrode pattern 910 to expose the underlying titanium layer. The reduced-thickness recesses 970a may have any shape suitable for reducing stiction within the accelerometer 305. In a preferred embodiment, the reduced-thickness recesses 970a are wider than the width w1 of the top cap overshock bumpers 720, and are located on the mass electrode pattern 910 at areas in which the top cap overshock bumpers 720 come in contact with the mass electrode pattern 910. The reduced-thickness recesses 970a in the mass electrode pattern 910 preferably reduce stiction between the top cap overshock bumpers 720 and the mass electrode pattern 910 by reducing the amount of imprinting in the mass electrode pattern 910 that occurs when the top cap overshock bumpers 720 come in contact with the mass electrode pattern 910.

In another preferred embodiment, as illustrated in FIG. 9ad, the mass electrode pattern 910 includes one or more cavities 980a. The cavities 980a in the mass electrode pattern 910 are preferably designed to eliminate stiction between the top cap overshock bumpers 720 and the mass electrode pattern 910. The cavities 980a may be formed using any suitable method for forming cavities in the mass electrode pattern 910. In a preferred embodiment, the cavities 980a are formed by selectively removing the gold layer and the titanium layer from the mass electrode pattern 910 to expose the underlying top measurement mass half 410. The cavities 980a may have any shape suitable for reducing stiction within the accelerometer 305. In a preferred embodiment, the cavities 980a are wider than the width w1 of the top cap overshock bumpers 720, and are located on the mass electrode pattern 910 at areas in which the top cap overshock bumpers 720 come in contact with the mass electrode pattern 910. The cavities 980a in the mass electrode pattern 910 preferably reduce stiction between the top cap overshock bumpers 720 and the mass electrode pattern 910 by eliminating imprinting in the mass electrode pattern 910 that occurs when the top cap overshock bumpers 720 come in contact with the mass electrode pattern 910. The operation of the mass electrode pattern 910 is substantially as that described in PCT patent application serial number PCT/US00/40038, filed on Mar. 16, 2000, the disclosure of which is incorporated herein by reference.

The bond ring 920 facilitates bonding of the top measurement mass half 410 to the top cap wafer 405. The bond ring 920 may include any number of conventional commercially available materials suitable for creating a bond ring such as, for example, gold, aluminum, or silver. In a preferred embodiment, the bond ring 920 is fabricated from a combination of gold and titanium. In a preferred embodiment, the combination of gold and titanium includes a layer of gold located on top of a layer of titanium. The layer of titanium preferably improves the adhesion of the gold to silicon and silicon dioxide. The bond ring 920 is preferably located on the upper surface 411 of the top measurement mass half 410, adjacent to the inner edge of the housing 907.

The top mass contact pad 930 is preferably used to make electrical contact to the top measurement mass half 410. The top mass contact pad 930 may be located anywhere on the upper surface 411 of the housing 907. In a preferred embodiment, the top mass contact pad 930 is located on the outer edge of the upper surface 411 of the housing 907, away from the mass electrode pattern 910. The top mass contact pad 930 may be fabricated from any materials suitable for creating a contact pad such as, for example, silver, aluminum, or gold. In a preferred embodiment, the top mass contact pad 930 is made of a combination of gold and titanium. In a preferred embodiment, the combination of gold and titanium includes a layer of gold located on top of a layer of titanium. The layer of titanium preferably improves the adhesion of the gold to silicon and silicon dioxide. The top mass contact pad 930 may include any dimensions suitable for creating a contact pad. In a preferred embodiment, the top mass contact pad 930 is sufficiently large for enabling a conventional wire bond.

The groove 940 is preferably located on the lower surface 412 of the housing 907 and extends from the outer edge of the housing 907 to the inner edge of the housing 907. The groove 940 preferably forms a passage 950 when the top measurement mass half 410 is bonded to the bottom measurement mass half 415. The passage 950 is preferably used to remove air from a cavity within the accelerometer 305, creating a vacuum or a low-pressure environment within the accelerometer 305 when the accelerometer 305 is sealed within a vacuum package. The groove 940 may be shaped in any way suitable for creating a passage for venting air. In a preferred embodiment, the groove 940 is V-shaped. In a preferred embodiment, the groove 940 is designed to allow for the fluidic flow of air from within the accelerometer 305 during a vacuum pump-down. The top measurement mass half 410 may include any number of grooves 940. In a preferred embodiment, the top measurement mass half 410 includes two grooves 940. In an alternative embodiment, the top measurement mass half 410 includes one groove 940. In an alternative embodiment, the top measurement mass half 410 includes a plurality of grooves 940. In an alternative embodiment, the top measurement mass half 410 includes no groove 940. The shape of the groove 940 may be affected by any number of factors. In a preferred embodiment, the groove 940 is designed to achieve an optimal pumpdown time for air passing through the passage 950. The conductance of air through the passage 950 is preferably given by:

$$C = \frac{8}{3 \sqrt{π}} {( \frac{2 k T}{m} )}^{1 / 2} ( \frac{{A}^{2}}{B L} ) \qquad ( 1 )$$

where:

C=the conductance of the passage 950,

k=Boltzman's constant,

T=absolute temperature,

m=mass of gas atom,

A=cross-sectional area of the passage 950,

B=periphery of the cross-sectional area of the passage 950, and

L=the length of the passage 950.

The dimensions of the passage 950, such as the length L, the cross-sectional area A, and the periphery B, are preferably designed to optimize the conductance of air through the passage 950. In a preferred embodiment, the optimal conductance C through the passage 950 produces an optimal pumpdown time for removing air from within the accelerometer 305. The pumpdown time is the amount of time it takes to remove enough air from within the accelerometer 305 to achieve the desired pressure within the accelerometer 305. The pumpdown time is preferably given by:

$$t \approx ( \frac{V}{S} ) [ 1 + S / C ] ln ( \frac{Pi - Pu}{P - Pu} ) \qquad ( 2 )$$

where:

t=pumpdown time,

V=volume of the internal cavities within the accelerometer 305,

S=speed of a vacuum pump used to remove air from the accelerometer 305,

C=conductance of the passage 950 from equation (1),

Pi=initial pressure within the accelerometer 305 (typically 1 atm),

P=desired pressure within the accelerometer 305,

Pu=(1+S/C)*Po, and

Po=lowest pressure of the pump.

The bottom measurement mass half 415 may be fabricated from any number of conventional commercially available materials suitable for creating a measurement half. In a preferred embodiment, as illustrated in FIGS. 9a, 9ab, 9ac, 9ad, 9e, 9f, and 9g, the bottom measurement mass half 415 includes an upper surface 417, a lower surface 416, one or more springs 911, a bottom measurement mass 912, a housing 913, the mass electrode pattern 915, a bond ring 925, a bottom mass contact pad 935, and a groove 945.

The springs 911 preferably couple the bottom measurement mass 912 to the housing 913 and provide a conductive path between the bottom measurement mass 912 and the housing 913. The springs 911 may be fabricated from any number of conventional commercially available materials suitable for creating springs such as, for example, metals, quartz, polysilicon, or silicon. In a preferred embodiment, the springs 911 are made of silicon, and are micromachined out of the bottom measurement mass half 415 wafer. The springs 911 are preferably designed to maintain cross-axis rejection while providing lateral shock protection for the bottom measurement mass 912. The springs 911 are preferably linear L-shaped springs, the design of which is described in U.S. Pat. Nos. 5,652,384 and 5,777,226, the disclosures of which are incorporated herein by reference.

The bottom measurement mass 912 is used to detect measurement data. The bottom measurement mass 912 may be used in any application in which its use is suitable. In a preferred embodiment, the bottom measurement mass 912 is used in seismic applications to detect acceleration forces. The bottom measurement mass 912 is preferably coupled to the housing 913 by the springs 911. The bottom measurement mass 912 may be fabricated from any material suitable for creating a measurement mass such as, for example, silicon or quartz. In a preferred embodiment, the bottom measurement mass 912 is made of silicon, and is micromachined out of the bottom measurement mass half 415 wafer.

The housing 913 surrounds the bottom measurement mass 912 and is coupled to the bottom measurement mass 912 by the springs 911. The housing 913 may be fabricated from any material suitable for creating a housing such as, for example, quartz or silicon. In a preferred embodiment, the housing 913 is fabricated from silicon, and is micromachined out of the bottom measurement mass half 415 wafer.

The mass electrode pattern 915 is used for the time-based multiplexing of electrical signals from an external circuit. In a preferred embodiment, the mass electrode pattern 915 includes a single electrode. In a preferred embodiment, the mass electrode pattern 915 is located on the lower surface 416 of the bottom measurement mass half 415, on a surface of the bottom measurement mass 912. The mass electrode pattern 915 may include any number of conventional commercially available materials suitable for creating an electrode pattern such as, for example, silver, aluminum, or gold. In a preferred embodiment, the mass electrode pattern 915 is made of a combination of gold and titanium. In a preferred embodiment, the combination of gold and titanium includes a layer of gold located on top of a layer of titanium. The layer of titanium preferably improves the adhesion of the gold to silicon and silicon dioxide. In an alternative embodiment, the mass electrode pattern 915 may be fabricated from any number of conductive materials suitable for creating an electrode, such as, for example, metals, silicides, or doped semiconductors.

The mass electrode pattern 915 may be of any size or shape suitable for forming an electrode pattern such as, for example, circular, square, or rectangular. The mass electrode pattern 915 is preferably identical in size and shape to the bottom capacitor electrode 805. In a preferred embodiment, the mass electrode pattern 915 is substantially equal in thickness to the bond ring 925. In a preferred embodiment, the thicknesses of the mass electrode pattern 915 and the bond ring 925 are smaller than the thickness of the bottom bond ring 807. The differences in thickness between the mass electrode pattern 915, the bond ring 925, and the bottom bond ring 807 preferably reduces stiction between the bottom cap overshock bumpers 820 and the mass electrode pattern 915 during the operation of the accelerometer 305 by reducing the imprinting of the bottom cap overshock bumpers 820 on the mass electrode pattern 915.

In another preferred embodiment, as illustrated in FIG. 9ab, the mass electrode pattern 915 includes one or more patterns 960b designed to minimize stiction between the bottom cap overshock bumpers 820 and the mass electrode pattern 915 during the operation of the accelerometer 305. The patterns 960b in the mass electrode pattern 915 preferably reduce stiction between the bottom cap overshock bumpers 820 and the mass electrode pattern 915 by minimizing the surface area of the region of intimate contact between the bottom cap overshock bumpers 820 and the mass electrode pattern 915.

In another preferred embodiment, as illustrated in FIG. 9ac, the mass electrode pattern 915 includes one or more reduced-thickness recesses 970b at areas in which the bottom cap overshock bumpers 820 come in contact with the mass electrode pattern 915. The reduced-thickness recesses 970b in the mass electrode pattern 915 are preferably designed to reduce stiction between the bottom cap overshock bumpers 820 and the mass electrode pattern 915. The reduced-thickness recesses 970b may be formed using any suitable method for forming reduced-thickness recesses in the mass electrode pattern 915. In a preferred embodiment, the reduced-thickness recesses 970b are formed by removing the gold layer from the mass electrode pattern 915 to expose the underlying titanium layer. The reduced-thickness recesses 970b may have any shape suitable for reducing stiction within the accelerometer 305. In a preferred embodiment, the reduced-thickness recesses 970b are wider than the width w2 of the bottom cap overshock bumpers 820, and are located on the mass electrode pattern 915 at areas in which the bottom cap overshock bumpers 820 come in contact with the mass electrode pattern 915. The reduced-thickness recesses 970b preferably reduce stiction between the bottom cap overshock bumpers 820 and the mass electrode pattern 915 by reducing the amount of imprinting in the mass electrode pattern 915 that occurs when the bottom cap overshock bumpers 820 come in contact with the mass electrode pattern 915.

In another preferred embodiment, as illustrated in FIG. 9ad, the mass electrode pattern 915 includes one or more cavities 980b. The cavities 980b in the mass electrode pattern 915 are preferably designed to eliminate stiction between the bottom cap overshock bumpers 820 and the mass electrode pattern 915. The cavities 980b may be formed using any suitable method for forming cavities in the mass electrode pattern 915. In a preferred embodiment, the cavities 980b are formed by selectively removing the gold layer and the titanium layer from the mass electrode pattern 915 to expose the underlying bottom measurement mass half 415. The cavities 980b may have any shape suitable for reducing stiction within the accelerometer 305. In a preferred embodiment, the cavities 980b are wider than the width w2 of the bottom cap overshock bumpers 820, and are located on the mass electrode pattern 915 at areas in which the bottom cap overshock bumpers 820 come in contact with the mass electrode pattern 915. The cavities 980b preferably reduce stiction between the bottom cap overshock bumpers 820 and the mass electrode pattern 915 by eliminating imprinting in the mass electrode pattern 915 that occurs when the bottom cap overshock bumpers 820 come in contact with the mass electrode pattern 915. The operation of the mass electrode pattern 915 is substantially as that described in PCT patent application serial number PCT/US00/40038, filed on Mar. 16, 2000, the disclosure of which is incorporated herein by reference.

The bond ring 925 preferably facilitates bonding of the bottom measurement mass half 415 to the bottom cap wafer 420. The bond ring 925 may include any number of conventional commercially available materials suitable for creating a bond ring such as, for example, gold, aluminum, or silver. In a preferred embodiment, the bond ring 925 is made of a combination of gold and titanium. In a preferred embodiment, the combination of gold and titanium includes a layer of gold located on top of a layer of titanium. The layer of titanium preferably improves the adhesion of the gold to silicon and silicon dioxide. The bond ring 925 is preferably located on the lower surface 416 of the bottom measurement mass half 415, adjacent to the inner edge of the housing 913.

The bottom mass contact pad 935 is preferably used to create an electrical contact to the bottom measurement mass half 415. The bottom mass contact pad 935 may be located anywhere on the lower surface 416 of the housing 913. In a preferred embodiment, the bottom mass contact pad 935 is located on the outer edge of the lower surface 416 of the housing 913, away from the mass electrode pattern 915. The bottom mass contact pad 935 may include any number of conventional commercially available materials suitable for creating a contact pad such as, for example, aluminum, silver, or gold. In a preferred embodiment, the bottom mass contact pad 935 is made of a combination of gold and titanium. In a preferred embodiment, the combination of gold and titanium includes a layer of gold located on top of a layer of titanium. The layer of titanium preferably improves the adhesion of the gold to silicon and silicon dioxide. The bottom mass contact pad 935 may include any dimensions suitable for a contact pad. In a preferred embodiment, the bottom mass contact pad 935 is sufficiently large for enabling conventional wire bonding.

The groove 945 forms a passage 950 when the bottom measurement mass half 415 is bonded to the top measurement mass half 410. The passage 950 is preferably used to remove air from a cavity within the accelerometer 305, creating a vacuum within the accelerometer 305 when the accelerometer 305 is sealed within a vacuum package. The groove 945 may be shaped in any way suitable for creating a passage for venting air. In a preferred embodiment, the groove 945 is V-shaped. In a preferred embodiment, the groove 945 is designed to allow for the fluidic flow of air from within the accelerometer 305 during a vacuum pump down. The shape of the groove 945 is preferably substantially identical to the shape of the groove 940, as described above. The groove 945 is preferably located on the upper surface 417 of the housing 913 and extends from the outer edge of the housing 913 to the inner edge of the housing 913. The bottom measurement mass half 415 may include any number of grooves 945. In a preferred embodiment, the bottom measurement mass half 415 includes two grooves 945. In an alternative embodiment, the bottom measurement mass half 415 includes one groove 945. In an alternative embodiment, the bottom measurement mass half 415 includes a plurality of grooves 945. In an alternative embodiment, the bottom measurement mass half 415 includes no groove 945.

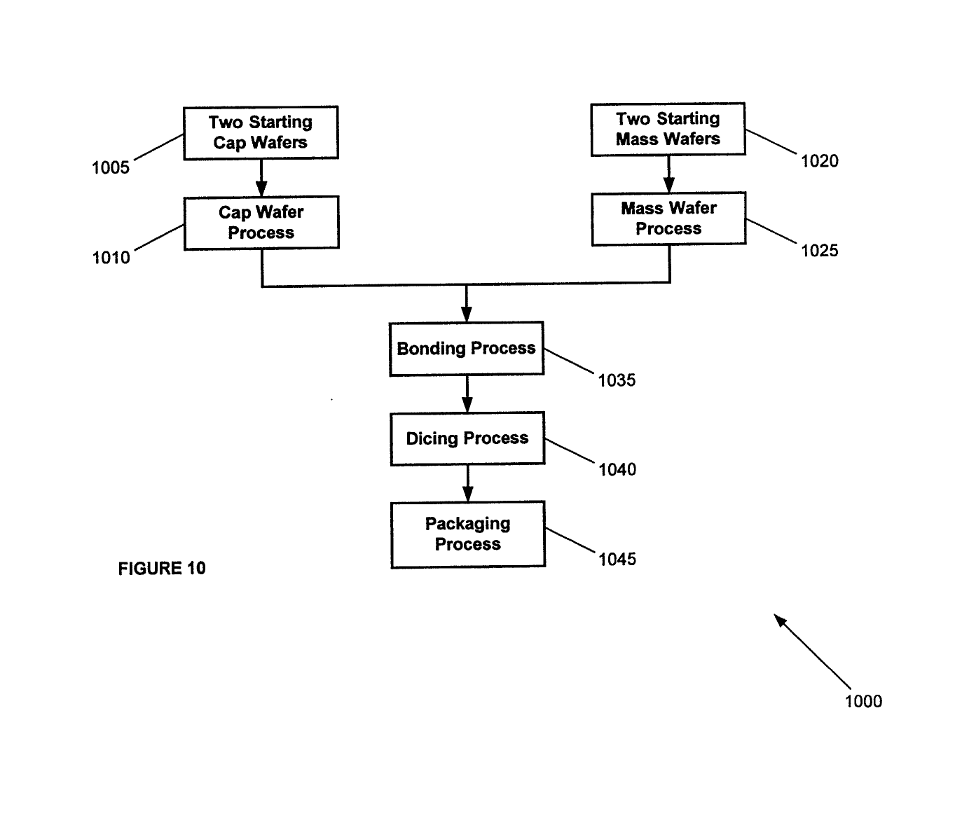

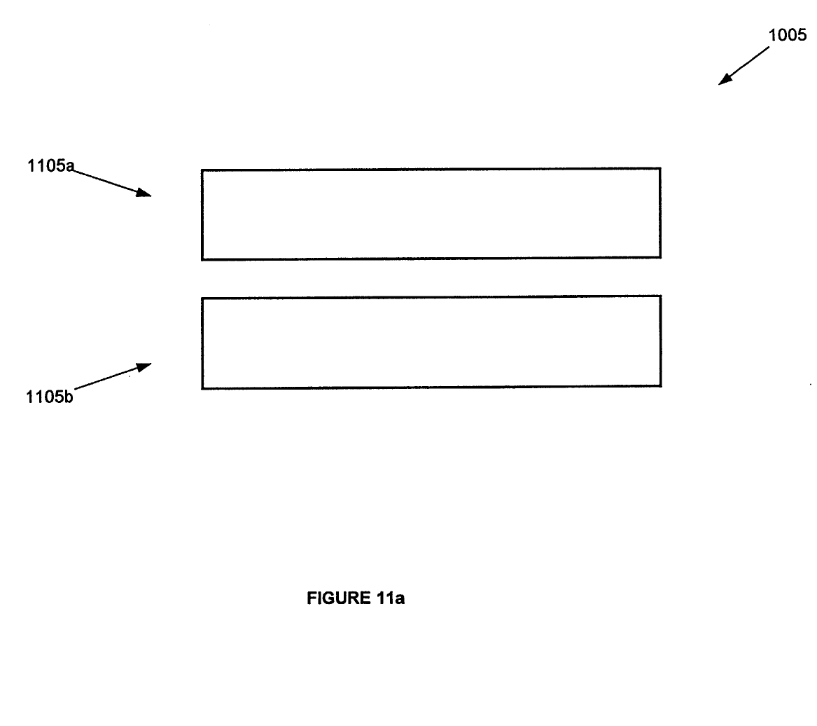

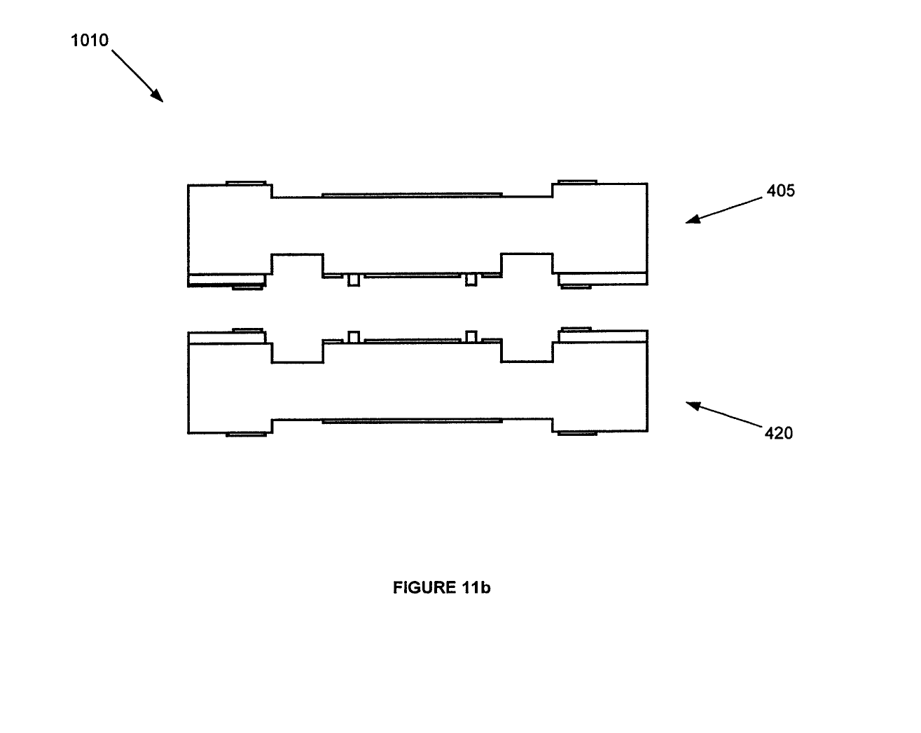

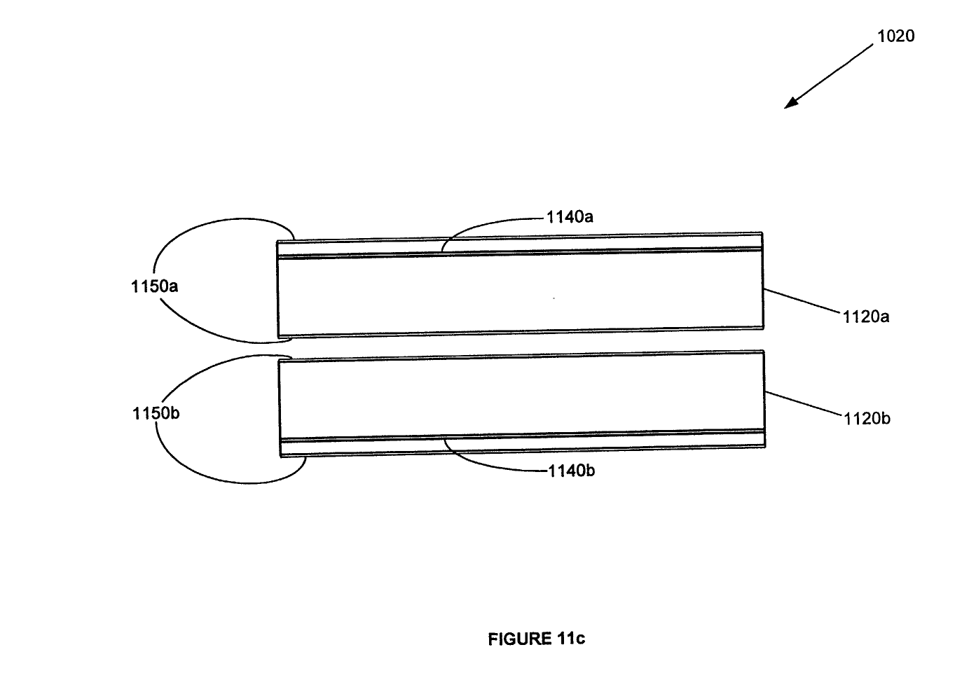

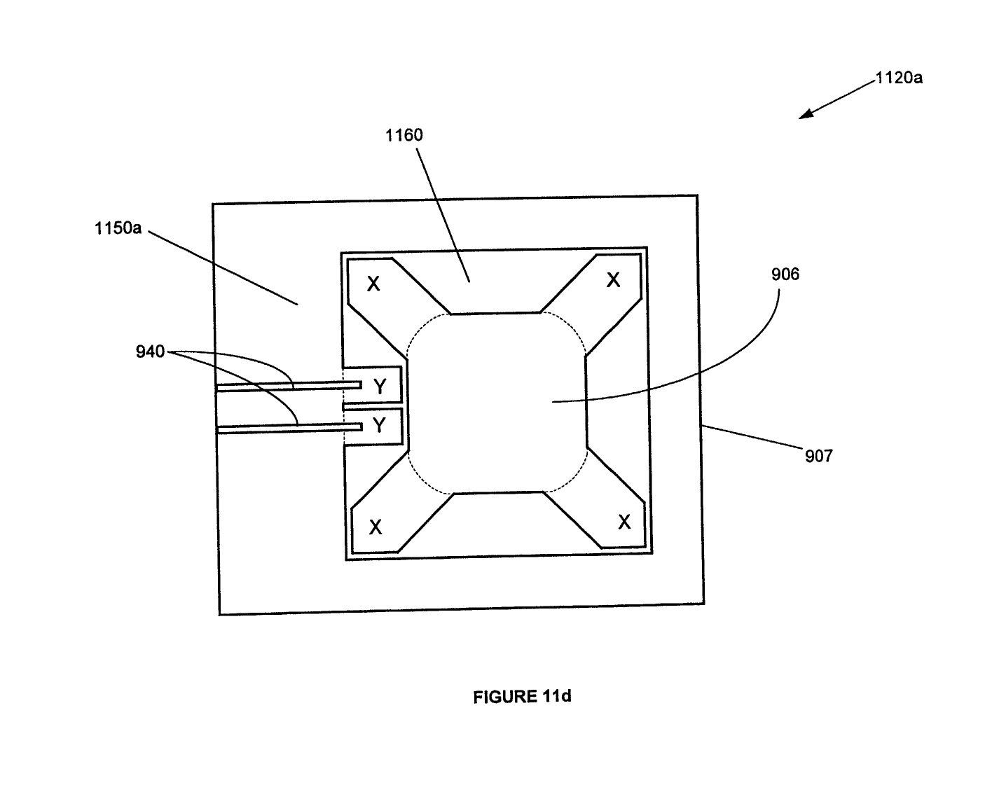

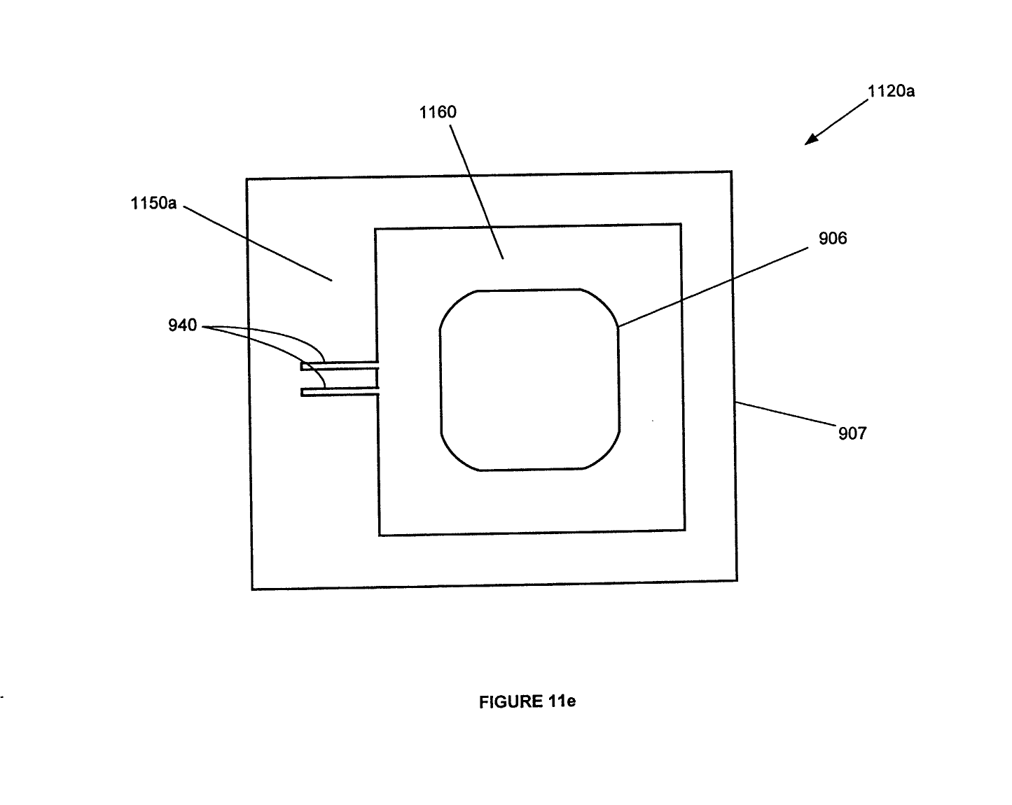

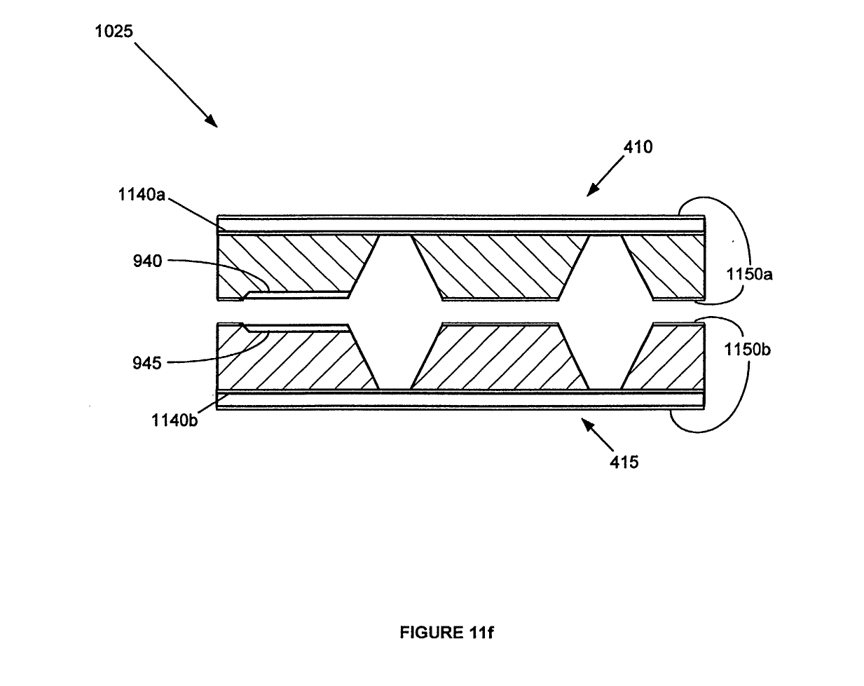

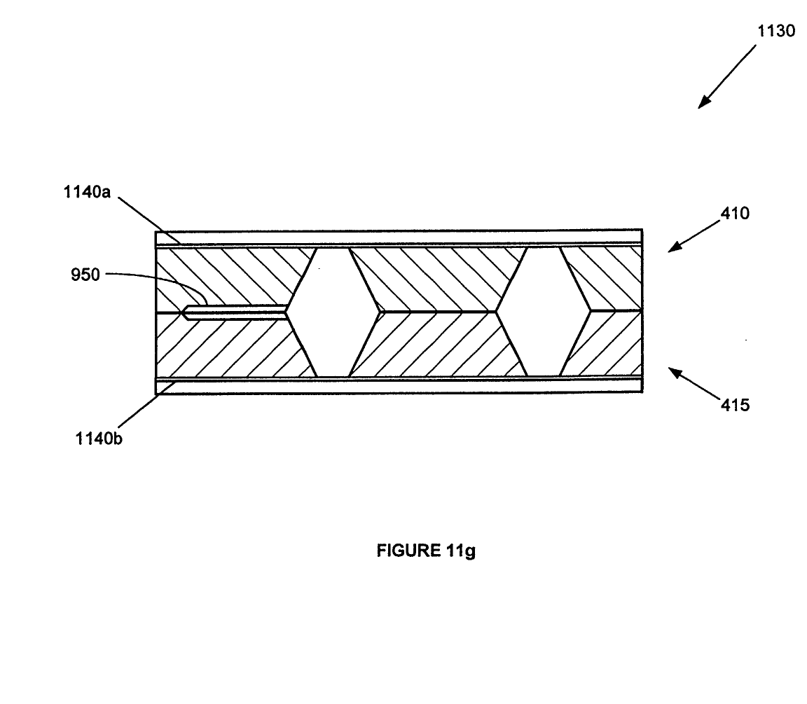

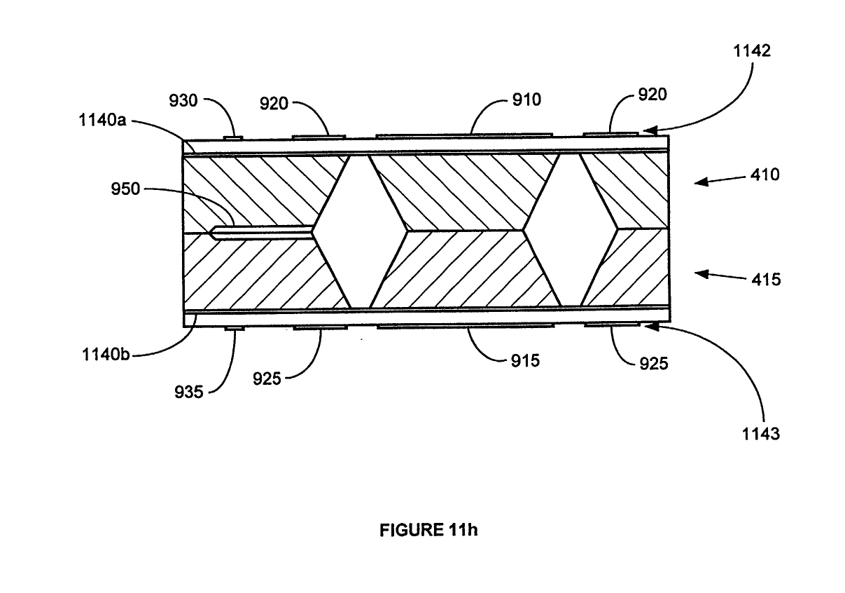

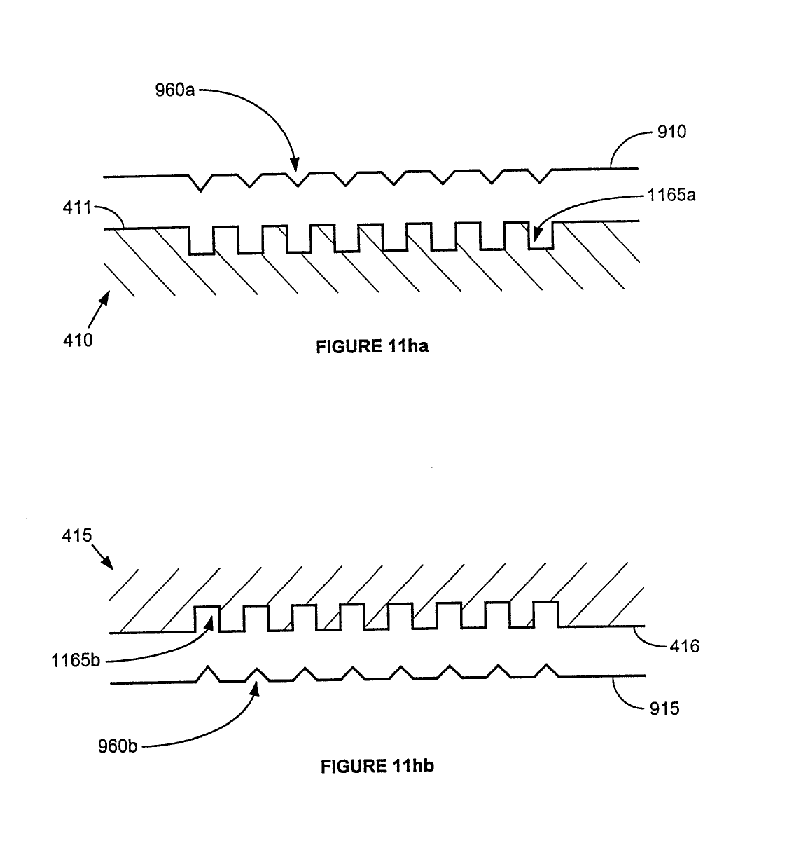

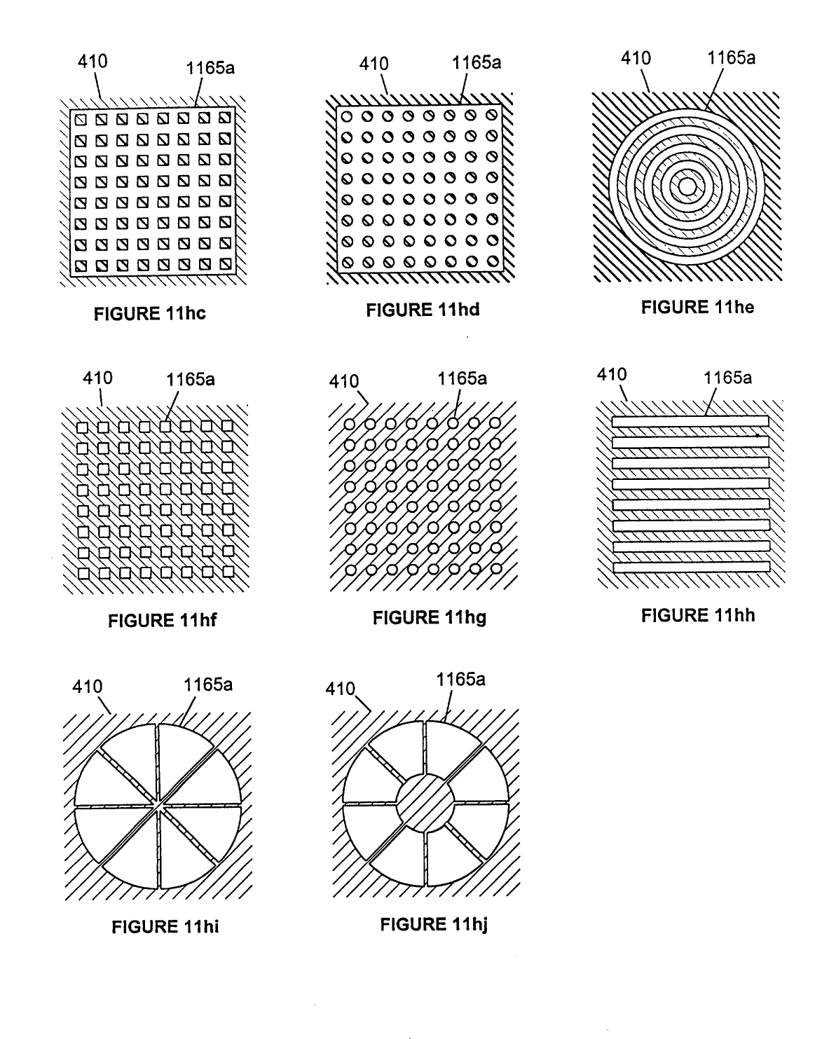

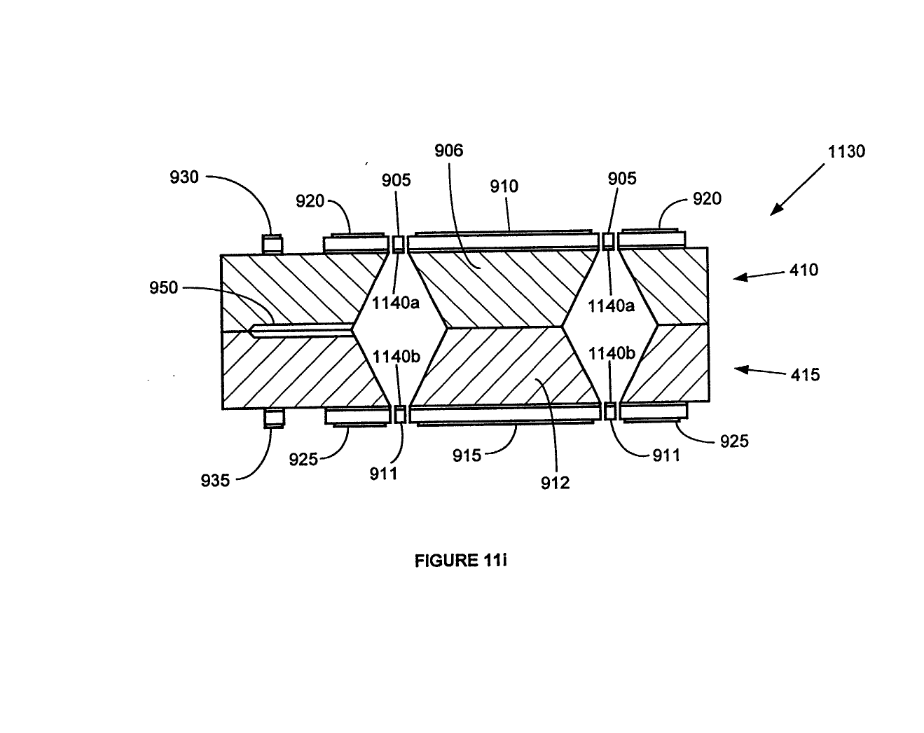

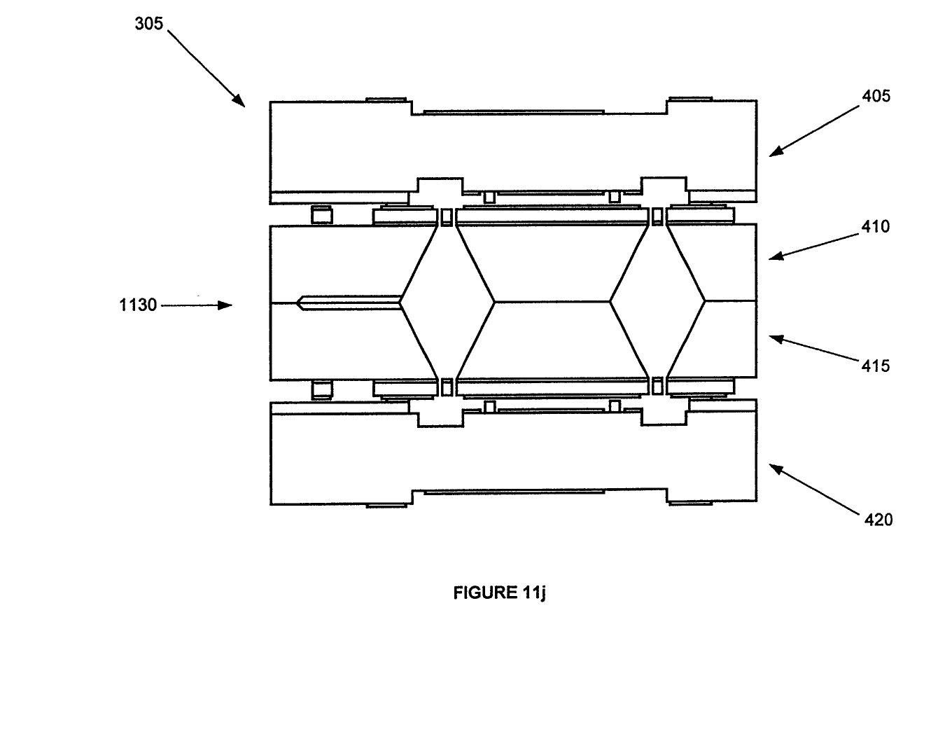

Referring to FIGS. 10, 11a, 11b, 11c, 11d, 11e, 11f, 11g, 11h, 11ha, 11hb, 11hc, 11hd, 11he, 11hf, 11hg, 11hh, 11hi, 11hj, 11i, 11j, 12a, 12b, 12c , and 13, a method 1000 of fabricating the accelerometer 305 will now be described. In a preferred embodiment, the method 1000 of fabricating the accelerometer 305 includes: acquiring two starting cap wafers in step 1005, shaping the two starting wafers using a cap wafer process in step 1010, acquiring two starting mass wafers in step 1020, shaping the two starting mass wafers using a mass wafer process in step 1025, bonding the wafers to form the accelerometer 305 using a bonding process in step 1035, making dicing cuts on the accelerometer 305 in step 1040, and packaging the accelerometer 305 in step 1045.

As illustrated in FIG. 11a, in step 1005 the two starting cap wafers 1105a and 1105b are fabricated. In a preferred embodiment, the two starting cap wafers 1105a and 1105b are identically sized and shaped. The starting cap wafers 1105a and 1105b may be fabricated from any number of conventional commercially available materials. In a preferred embodiment, the starting cap wafers 1105a and 1105b are made of silicon.

As illustrated in FIG. 11b, in step 1010 the two starting cap wafers 1105a and 1105b undergo a cap wafer process. In a preferred embodiment, the cap wafer process transforms the starting cap wafers 1105a and 1105b into the top cap wafer 405 and the bottom cap wafer 420, respectively. In an alternative embodiment, the cap wafer process includes a merged mask micro-machining process substantially as disclosed in one or more of the following: U.S. patent application Ser. No. 09/352,835, attorney docket number 14737.659.02, filed on Jul. 13, 1999, and U.S. patent application Ser. No. 09/352,025, attorney filed on Jul. 13, 1999, the disclosures of which are incorporated herein by reference.

As illustrated in FIG. 11c, in step 1020 the two starting mass wafers 1120a and 1120b are fabricated. In a preferred embodiment, the two starting mass wafers 1120a and 1120b are identically sized and shaped. The starting mass wafers 1120a and 1120b may be fabricated from any number of conventional commercially available materials. In a preferred embodiment, the starting mass wafers 1120a and 1120b are made of silicon. In a preferred embodiment, each of the starting mass wafers 1120a and 1120b includes an etch-stop layer 1140a and 1140b, respectively. In a preferred embodiment, each of the starting mass wafers 1120a and 1120b includes an etch-masking layer 1150a and 1150b, respectively.

As illustrated in FIGS. 11d, 11e, 11f, 11g, 11h, 11ha, 11hb, 11hc, 11hd, 11he, 11hf, 11hg, 11hh, 11hi, 11hj and 11i, in step 1025 the two starting mass wafers 1120a and 1120b undergo a mass wafer process that transforms the two starting mass wafers 1120a and 1120b into the top measurement mass half 410 and the bottom measurement mass half 415, respectively. In a preferred embodiment, the mass wafer process is substantially as that described in U.S. Pat. No. 5,484,073, the disclosure of which is incorporated herein by reference. In an alternative embodiment, the mass wafer process includes a merged mask micromachining process substantially as disclosed in U.S. patent application Ser. No. 09/352,835, filed on Jul. 13, 1999, and U.S. patent application Ser. No. 09/352,025, attorney docket number 14737.659.03, filed on Jul. 13, 1999, the disclosures of which are incorporated herein by reference.

As illustrated in FIG. 11d, the mass wafer process of step 1025 begins by photolithigraphically patterning the etch-masking layer 1150a to create an area of exposure 1160 on the etch-masking layer 1150a. In a preferred embodiment, the etch-masking layer 1150a is photolithigraphically patterned to create the area of exposure 1160 in the shape of the top measurement mass 906, the housing 907, and the grooves 940. In a preferred embodiment, the photolithigraphically patterned area of exposure 1160 includes corner compensation structures X and Y.

In a preferred embodiment, as illustrated in FIG. 11e, an etching process is performed to shape the starting mass wafer 1120a into the top measurement mass half 410. The etching process may include any number of conventional commercially available processes suitable for etching. In a preferred embodiment, the etching process begins by removing the etch-masking layer 1150a from the starting mass wafer 1120 within the area of exposure 1160. The etch-masking layer 1150a may be removed using any suitable process for removing an etch-masking layer, such as, for example, plasma etching. In a preferred embodiment, the etch-masking layer 1150a is removed from the starting mass wafer 1120a within the area of exposure 1160 by using an etchant. In a preferred embodiment, removal of the etch-masking layer 1150a exposes the material from which the starting mass wafer 1120a is fabricated. In a preferred embodiment, the material from which the starting mass wafer 1120a is fabricated is silicon. In a preferred embodiment, the corner compensation structures X prevent the etchant from attacking and corroding convex corners within the area of exposure 1160. The corner structures Y preferably allow the grooves 940 to be simultaneously formed during the etching process used to define the measurement mass 906 and the housing 907. In a preferred embodiment, the corner compensation structures Y reduce etchant-induced corner erosion at an intersection between the grooves 940 and the area of exposure 1160.

In a preferred embodiment, a wet etching chemical is then applied to the exposed silicon on the starting mass wafer 1120a. The wet etching chemical may be any number of conventional commercially available wet etching chemicals suitable for etching silicon. In a preferred embodiment, the wet etching chemical is potassium hydroxide (KOH). The KOH preferably controllably etches through the silicon and terminates at the etch-stop layer 1140a of the starting mass wafer 1120a. In a preferred embodiment, as illustrated in FIG. 11f, the KOH etches the starting mass wafer 1120a into the shape of the top measurement mass 406, the housing 407, and the groove 940. In a preferred embodiment, the etch-stop layer 1140a remains on the backside surface of the springs 905 after the wet chemical etching process has been completed. In an alternative embodiment, the etch-stop layer 1140a is removed from the springs 905 during the wet chemical etching process.

Following the wet etching process, the remaining etch-masking layer 1150a on the starting mass wafer 1120a is removed from the starting mass wafer 1120a using a standard wet etchant.

An identical etching process is preferably used on the second starting mass wafer 1120b to shape the second starting mass wafer 1120b into the bottom measurement mass half 415.

In a preferred embodiment, as illustrated in FIG. 11g, the top measurement mass half 410 and the bottom measurement mass half 415 are bonded together to form a mass wafer pair 1130. The wafer bonding process may be any number of bonding processes suitable for bonding the top measurement mass half 410 and the bottom measurement mass half 415. In a preferred embodiment, the wafer bonding process is a fusion bonding process. In a preferred embodiment, the groove 940 in the top measurement mass half 410 is aligned with the groove 945 in the bottom measurement mass half 415 during the wafer bonding process to form the passage 950.

In a preferred embodiment, a metal layer 1142 is deposited onto the upper surface of the mass wafer pair 1150, which corresponds to the upper surface 411 of the top measurement mass half 410. Additionally, a metal layer 1143 is deposited onto the lower surface of the mass wafer pair 1130, which corresponds to the lower surface 416 of the bottom measurement mass half 415. The metal layers 1142 and 1143 may include any number of conventional commercially available materials suitable for creating a metal layer such as, for example, aluminum, silver, or gold. In a preferred embodiment, the metal layers 1142 and 1143 are fabricated from a combination of gold and titanium. In a preferred embodiment, the combination of gold and titanium includes a layer of gold located on top of a layer of titanium. The layer of titanium preferably improves the adhesion of the gold to silicon and silicon dioxide. The metal layers 1142 and 1143 are preferably patterned using an etch-masking layer. The etch-masking layer may be any etch-masking layer suitable for patterning metal layers. In a preferred embodiment, the etch-masking layer is photoresist. The metal layers 1142 and 1143 may be shaped into any pattern suitable for use within the accelerometer 305. In a preferred embodiment, as illustrated in FIG. 11h, the metal layer 1142 on the upper surface of the mass wafer pair 1130 is shaped to form the mass electrode pattern 910, the bond ring 920, and the top mass contact pad 930. In a preferred embodiment, as illustrated in FIG. 11h, the metal layer 1143 on the lower surface of the mass wafer pair 1130 is shaped to form the mass electrode pattern 915, the bond ring 925, and the bottom mass contact pad 935.

In a preferred embodiment, as illustrated in FIG. 11ha, the mass electrode pattern 910 includes a pattern 960a designed to reduce stiction between the mass electrode pattern 910 and the top cap overshock bumpers 720 during the operation of the accelerometer 305. In a preferred embodiment, as illustrated in FIG. 11hb, the mass electrode pattern 915 includes a pattern 960b designed to reduce stiction between the mass electrode pattern 915 and the bottom cap overshock bumpers 820 during the operation of the accelerometer 305. The patterns 960a and 960b may be created on the mass electrode patterns 910 and 915 using any number of methods suitable for creating patterns on the mass electrode patterns 910 and 915. In a preferred embodiment, as illustrated in FIG. 11ha, the pattern 960a is created by etching a pattern into the upper surface 411 of the top measurement mass half 410 to create a patterned surface 1165a, and depositing the metal layer 1142 onto the patterned surface 1165a. The metal layer 1142 preferably molds into the mass electrode 910 including the pattern 960a. In a preferred embodiment, as illustrated in FIG. 11hb, the pattern 960b is created by etching a pattern into the lower surface 416 of the bottom measurement mass half 415 to create a patterned surface 1165b, and depositing the metal layer 1143 onto the patterned surface 1165b. The metal layer 1143 preferably molds into the mass electrode 915 including the pattern 960b. The patterned surface 1165a etched into the upper surface 411 of the top measurement mass half 410 and the patterned surface 1165b etched into the lower surface 416 of the bottom measurement mass half 415 may include any number of patterns suitable for reducing the stiction between the mass electrode patterns 910 and 915 and the overshock protection bumpers 720 and 820, respectively. In a preferred embodiment, as illustrated in FIGS. 11hc and 11hf, the patterned surfaces 1165a and 1165b include a plurality of geometrically arranged squares. In another preferred embodiment, as illustrated in FIGS. 11hd and 11hg, the patterned surfaces 1165a and 1165b include a plurality of geometrically arranged circles. In another preferred embodiment, as illustrated in FIG. 11he, the patterned surfaces 1165a and 1165b include a series of concentric circles. In another preferred embodiment, as illustrated in FIG. 11hh, the patterned surfaces 1165a and 1165b include a series of geometrically arranged rectangles. In another preferred embodiment, as illustrated in FIGS. 11hi and 11hj, the patterned surfaces 1165a and 1165b include a series of geometrically arranged pie-shaped segments.

In a preferred embodiment, as illustrated in FIG. 11i, the springs 905 are formed to couple the top measurement mass 906 to the housing 907, and the springs 911 are formed to couple the bottom measurement mass 912 to the housing 913. The springs 905 and 911 may be formed using any number of conventional commercially available methods suitable for creating spring members in the mass wafer pair 1130. In a preferred embodiment, the springs 905 and 911 are formed using a DRIE plasma etching technique. In a preferred embodiment, the etching technique is substantially as that described in U.S. Pat. No. 5,484,073, the disclosure of which is incorporated herein by reference. The springs 905 and 911 are preferably linear L-shaped springs, the design of which is described in U.S. Pat. Nos. 5,652,384 and 5,777,226, the disclosures of which are incorporated herein by reference. The springs 905 and 911 are preferably designed to maintain cross-axis rejection while providing lateral shock protection for the top measurement mass 906 and the bottom measurement mass 911, respectively. In a preferred embodiment, the etch-stop layers 1140a and 1140b remain on backside surfaces of the springs 905 and 911, respectively, after the plasma etching process has been completed. The etch-stop layers 1140a and 1140b on the springs 905 and 911 preferably improve the uniformity of the thickness of the springs 905 and 911. In addition, the etch-stop layers 1140a and 1140b on the springs 905 and 911 preferably improve the dimensional control of the springs 905 during the operation of the accelerometer 305. In another preferred embodiment, the etch-stop layers 1140a and 1140b are removed from the springs 905 and 911, respectively, during the plasma etching process.

As illustrated in FIG. 11j, in step 1035 the top cap wafer 405, the bottom cap wafer 420, and the mass wafer pair 1130 preferably undergo a bonding process to form the accelerometer 305. The bonding process of step 1035 may be any number of bonding processes such as, for example, fusion bonding, thermocompression, eutectic bonding, anodic bonding, or glass frit bonding. In a preferred embodiment, the bonding process of step 1035 is a thermocompression bonding process.

During the bonding process of step 1035, the top cap wafer 405 is bonded to the upper surface of the mass wafer pair 1130, which corresponds to the upper surface 411 of the top measurement mass half 410. In a preferred embodiment, the top bond ring 707 bonds with the bond ring 920, coupling the top cap wafer 405 and the top measurement mass half 410. The top bond ring 707 and the bond ring 920 are preferably bonded using the thermocompression bonding process.

The top bond oxide ring 710 preferably extends below the bottom surface 408 of the top cap wafer body 406. As a result, the bonding process preferably creates a narrow capacitor electrode gap between the top capacitor electrode 705 and the mass electrode pattern 910. During the bonding process, bond forces are preferably applied to the upper surface 407 of the top cap wafer 405, away from the top cap press frame recess 725. In a preferred embodiment, the top cap press frame recess 725 is positioned on the upper surface 407 of the top cap wafer 405 in a location that ensures that bond forces applied during the bonding process are localized to the bond ring regions and away from the narrow capacitor electrode gap region.

Also during the bonding process of step 1035, the bottom cap wafer 420 is bonded to the lower surface of the mass wafer pair 1130, which corresponds to the lower surface 416 of the bottom measurement mass half 415. In a preferred embodiment, the bottom bond ring 807 bonds with the bond ring 925, coupling the bottom cap wafer 420 and the bottom measurement mass half 415. The bottom bond ring 807 and the bond ring 925 are preferably bonded using the thermocompression bonding process.

The bottom bond oxide ring 810 preferably extends above the upper surface 423 of the bottom cap wafer body 421. As a result, the bonding process preferably creates a narrow capacitor electrode gap between the bottom capacitor electrode 805 and the mass electrode pattern 915. During the bonding process, bond forces are preferably applied to the bottom surface 422 of the bottom cap wafer 420, away from bottom cap press frame recess 825. In a preferred embodiment, the bottom cap press frame recess 825 is positioned on the bottom surface 422 of the bottom cap wafer 420 in a location that ensures that bond forces applied during the bonding process are localized to the bond ring regions and away from the narrow capacitor electrode gap region.

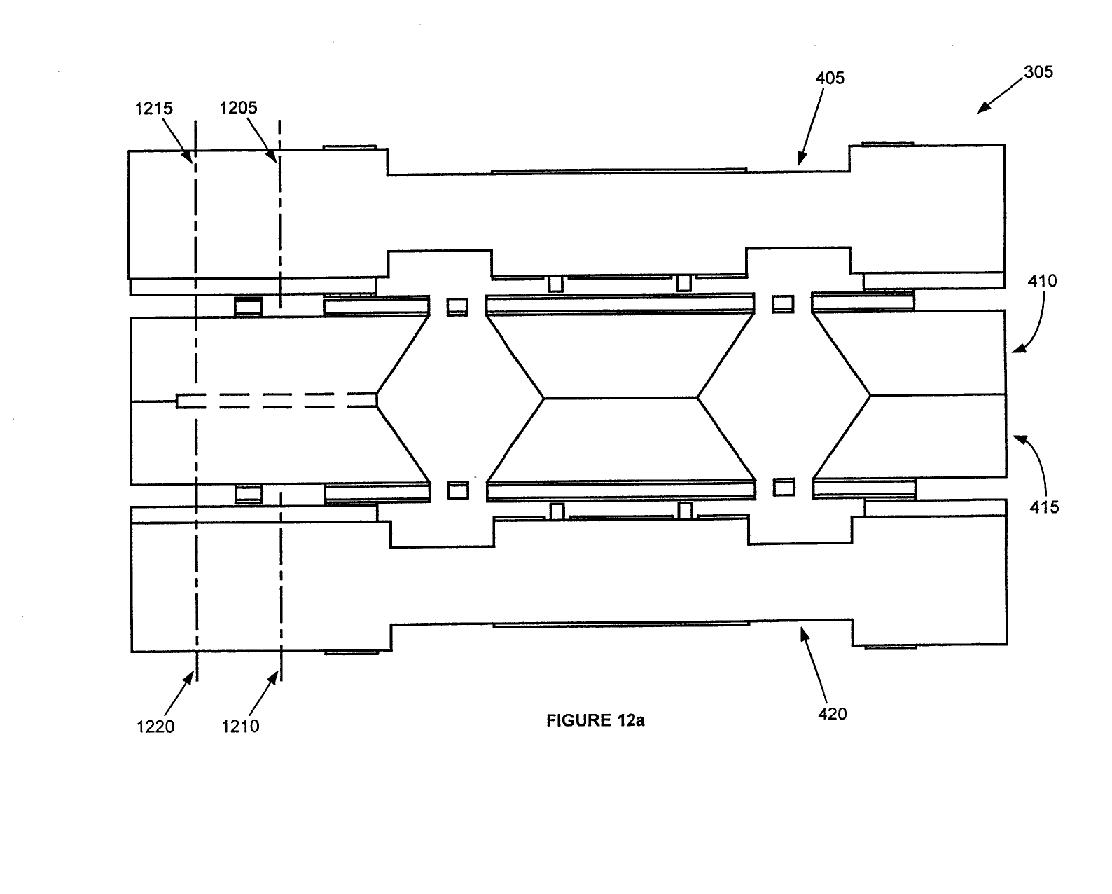

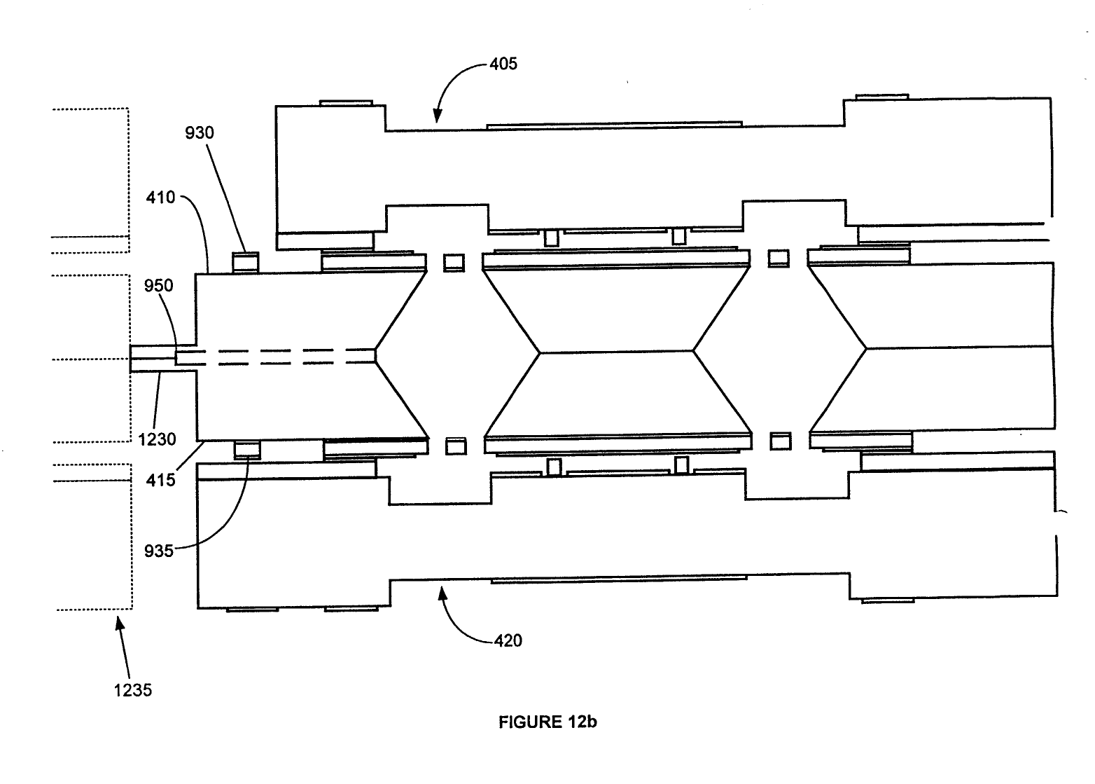

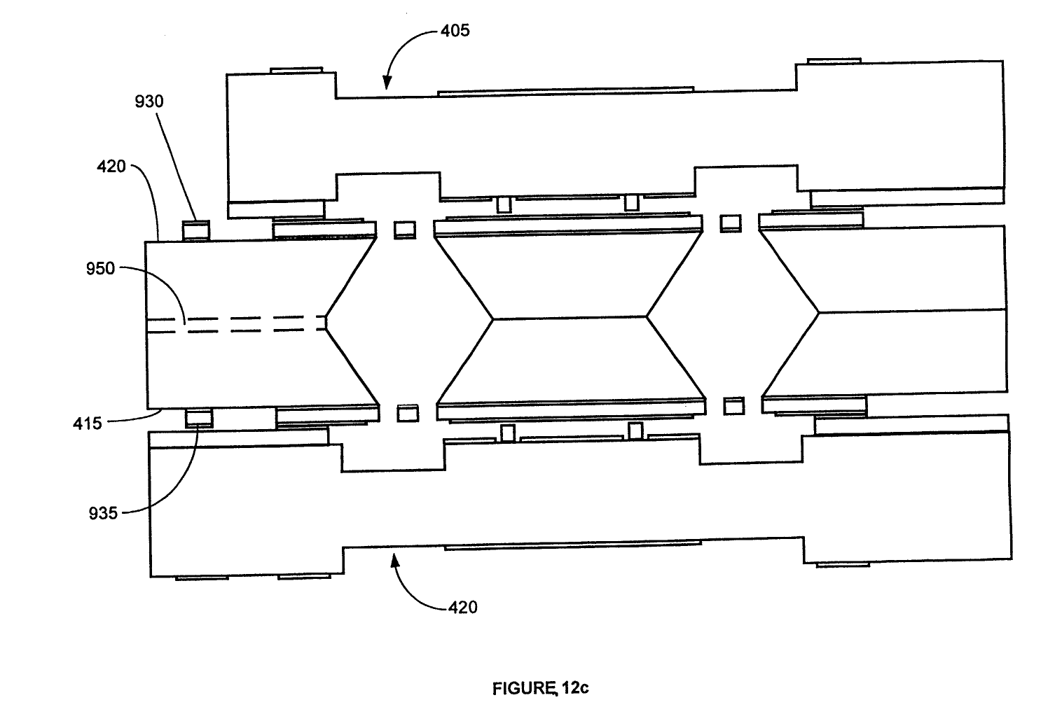

As illustrated in FIGS. 12a, 12b, and 12c, in step 1040 the accelerometer 305 undergoes a dicing process. Dicing cuts 1205, 1210, 1215, 1220 are preferably made at predetermined locations on the accelerometer 305. The dicing cuts 1205, 1210, 1215, 1220 serve a variety of purposes. In a preferred embodiment, the dicing cuts 1205, 1215, 1220 are made to separate the accelerometer 305 die from a wafer 1235, expose electrical leads from the electrodes 910 and 915, separate the electrical leads, and expose the passage 950. In another preferred embodiment, the dicing cut 1210 is made in addition to the dicing cuts 1205, 1215, 1220 to separate the accelerometer 305 die from the wafer 1235, expose electrical leads from the electrodes 910 and 915, separate the electrical leads, and expose the passage 950.

In a preferred embodiment, a cut 1205 is made on the top cap wafer 405. The cut 1205 preferably extends vertically through the top cap wafer body 406, resulting in the removal of a section of the top cap wafer body 406. In a preferred embodiment, the cut 1205 exposes the top mass contact pad 930. The cut 1205 may be performed using any number of conventional commercially available methods of performing a dicing cut such as, for example, using a diamond blade wafer saw. In a preferred embodiment, the cut 1205 is made by using a diamond blade wafer saw.

In a preferred embodiment, a cut 1215 is made extending vertically through the top cap wafer body 406 and into the housing 907 of the top measurement mass half 410. The cut 1215 is preferably stopped within the housing 907 before the cut 1215 reaches the passage 950. The cut 1215 may be stopped any distance before reaching the passage 950. In a preferred embodiment, the cut 1215 is stopped more than about 2 mils from the passage 950. The cut 1215 may be performed using any number of conventional commercially available methods of performing a dicing cut such as, for example, using a diamond blade wafer saw. In a preferred embodiment, the cut 1215 is made by using a diamond blade wafer saw.

In a preferred embodiment, a cut 1220 is made extending vertically through the bottom cap wafer body 421 and into the housing 913 of the bottom measurement mass half 415. The cut 1220 is preferably stopped within the housing 913 before the cut 1220 reaches the passage 950. The cut 1220 may be stopped any distance before reaching the passage 950. In a preferred embodiment, the cut 1220 is stopped more than about 2 mils from the passage 950. The cut 1220 may be performed using any number of conventional commercially available methods of performing a dicing cut such as, for example, using a diamond blade wafer saw. In a preferred embodiment, the cut 1215 is made by using a diamond blade wafer saw.

In an alternative preferred embodiment, a cut 1210 is made on the bottom cap wafer body 421. The cut 1210 preferably extends vertically through the bottom cap wafer body 421, resulting in the removal of a section of the bottom cap wafer body 421. In a preferred embodiment, the cut 1210 exposes the bottom mass contact pad 935. The cut 1210 may be performed using any number of conventional commercially available methods of performing a dicing cut such as, for example, using a diamond blade wafer saw. In a preferred embodiment, the cut 1210 is made by using a diamond blade wafer saw.

The cuts 1205, 1210, 1215, 1220 may be performed individually, or the cuts 1205, 1210, 1215, 1220 may be made in any combination to achieve the accelerometer 305 shape most suitable for a particular application. In a preferred embodiment, as illustrated in FIG. 12b, cuts 1205, 1215, and 1220 are performed on the accelerometer 305. In an alternative embodiment, cut 1210 is performed on the accelerometer 305 in addition to the cuts 1205, 1215, and 1220. Cut 1205 preferably exposes the top mass contact pad 930. Cut 1210 preferably exposes the bottom mass contact pad 935. Cuts 1215, 1220 preferably create a scribe lane 1230 surrounding the passage 950. The scribe lane 1230 is preferably attached to another die 1235.

During the dicing process, the scribe lane 1230 may remain attached to the accelerometer 305 and die 1235 to keep the accelerometer 305 hermetically sealed, or the scribe lane 1230 may be snapped to expose the passage 950 and separate the accelerometer 305 from the die 1235. In a preferred embodiment, as illustrated in FIG. 12c, the scribe lane 1230 is removed to expose the passage 950 and separate the accelerometer 305 from the die 1235. The exposed passage 950 is preferably used as a channel for removing air from within the accelerometer 305 to create a vacuum within the accelerometer 305 during packaging.

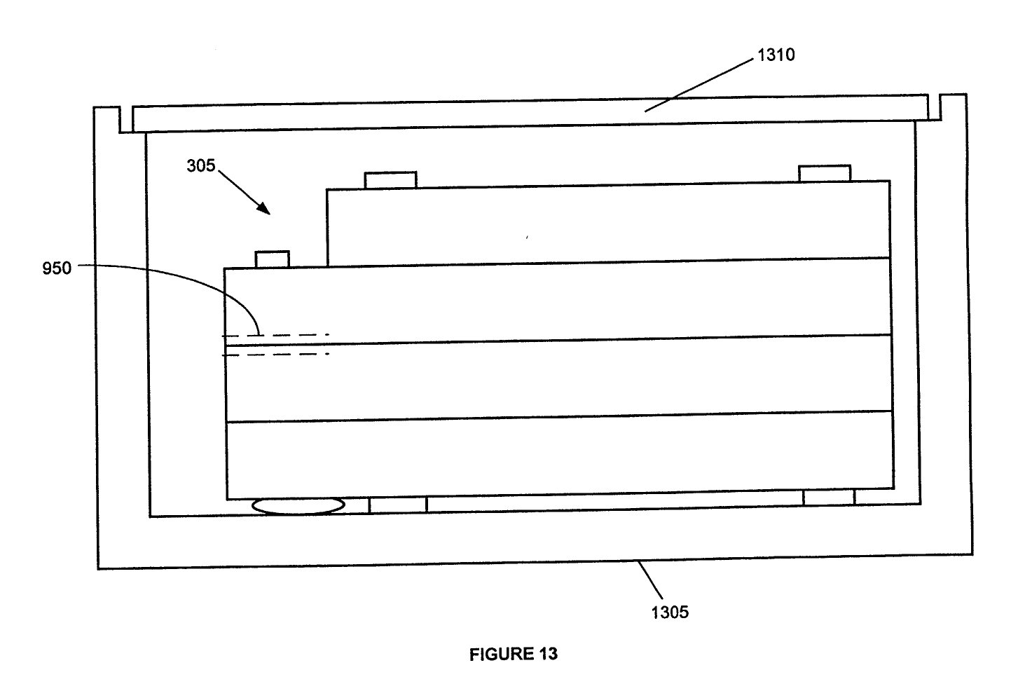

As illustrated in FIG. 13, in step 1045 the accelerometer 305 is packaged within a package 1305. The package 1305 may include any number of packages suitable for storing the accelerometer 305. In a preferred embodiment, the package 1305 is a housing. In another preferred embodiment, the package 1305 is a substrate.

The housing 1305 may be any number of housings suitable for storing the accelerometer 305. In a preferred embodiment, the housing 1305 includes a body 1310 and a lid 1315. The housing 1305 is preferably a conventional multi-layered ceramic package.

The accelerometer 305 is preferably placed within the body 1310 of the housing 1305. The accelerometer 305 may be placed within the housing 1305 using any number of methods suitable for securing the accelerometer 305 within the housing 1305. In a preferred embodiment, the accelerometer 305 is placed within the housing 1305 using a solder-die attachment process substantially as disclosed in PCT patent application Serial No. PCT/US00/06832, filed on Mar. 15, 2000, the disclosure of which is incorporated herein by reference.

The lid 1315 is then preferably fastened to the body 1310 to seal the accelerometer 305 within the housing 1305. In a preferred embodiment, a vacuum process is used to remove air from the housing prior to fastening the lid 1315 to the body 1310, creating a vacuum or a low-pressure environment within the housing 1305. When the passage 950 is exposed, air is removed from within the accelerometer 305 during the vacuum process, creating a vacuum within the accelerometer 305 in the housing 1305.

In another preferred embodiment, the bonding process of step 1035 is performed in a vacuum environment, creating a vacuum within the cavity in the accelerometer 305 during the bonding process. In this embodiment, the passage 950 is preferably removed from the design of the accelerometer 305. The vacuum-sealed accelerometer 305 is then preferably placed in the housing 1305, and the housing is sealed by fastening the lid 1315 to the body 1310.

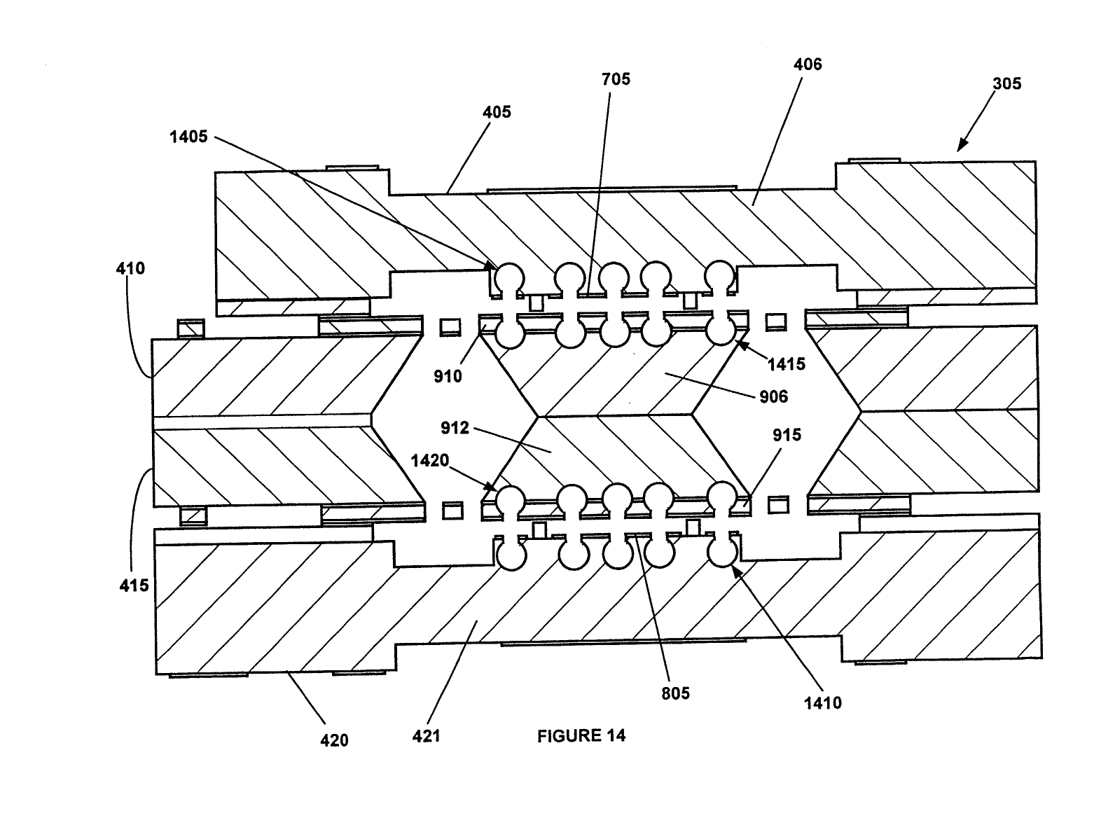

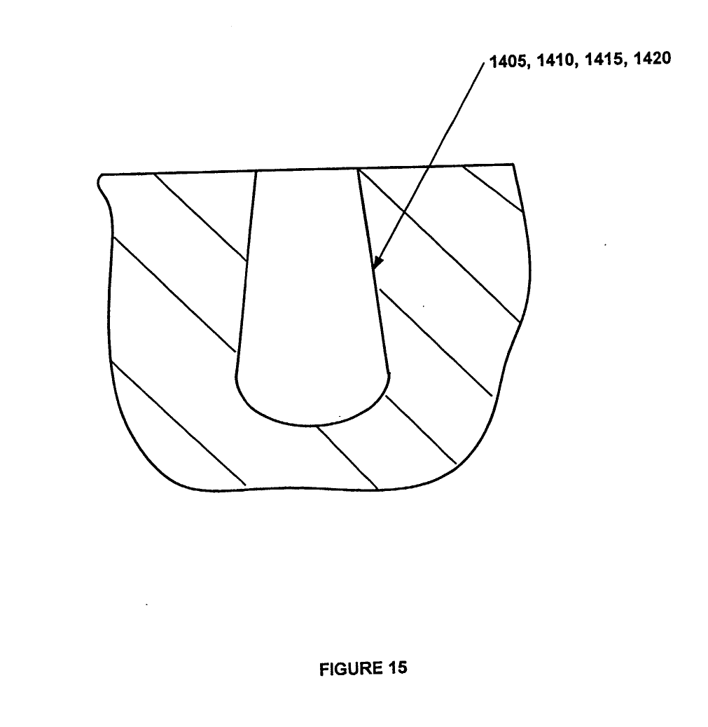

Referring to FIGS. 14 and 15, in an alternate embodiment, the top capacitor electrode 705 includes one or more re-entrant grooves 1405, and/or the bottom capacitor electrode 805 includes one or more re-entrant grooves 1410, and/or the mass electrode pattern 910 includes one or more re-entrant grooves 1415, and/or the mass electrode pattern 915 includes one or more re-entrant grooves 1420. As used herein, the term re-entrant is defined as any opening or groove in an element that is larger toward the element center than at the element surface. In a preferred embodiment, the top capacitor electrode 705 includes one or more re-entrant grooves 1405 and the bottom capacitor electrode 805 includes one or more re-entrant grooves 1410, while the mass electrode patterns 910 and 915 do not include any re-entrant grooves. The grooves 1405, 1410, 1415 and 1420 may extend into the top cap wafer 405, the bottom cap wafer 421, the top measurement mass 906 and the bottom measurement mass 912. The re-entrant grooves 1405, 1410, 1415, and 1420 reduce the resistance to fluid flow between the top pair of parallel-plate electrodes 705 and 910 and the bottom pair of parallel plate electrodes 805 and 915 to the internal cavity at the periphery of the electrodes. In this manner, fluid damping is reduced thereby reducing thermo-mechanical noise. Furthermore, the re-entrant grooves 1405, 1410, 1415, and 1420 permit the sealing pressure of the accelerometer 305 to be increased thereby lowering manufacturing costs and increasing production yields.

As illustrated in FIGS. 14 and 15, the re-entrant grooves 1405, 1410, 1415, and 1420 have a narrower cross-section at the electrode surfaces and a wider cross section below the electrode surfaces. The narrower cross-section at the electrode surface tends to preserve electrode surface area while the wider cross-section below the electrode surface reduces resistance to fluid flow. In several alternative embodiments, one or more of the grooves 1405, 1410, 1415, and 1420 do not have a re-entrant cross-section.

The location and sizing of the grooves 1405, 1410, 1415 and 1420 are preferably designed to minimize the fluid damping of the parallel plate electrodes 705 and 910 and 805 and 915 within the design constraints of the plate surface areas, the electrode gaps, and the total working capacitance. In order to minimize fluid damping with a fixed total electrode surface area, the location and sizing of the grooves 1405, 1410, 1415, and 1420 can be varied. In particular, some fluid damping is due to fluid flow between the electrode elements while other fluid damping is due to fluid flow within the grooves. If damping due to fluid flow between the electrode elements dominates the total fluid damping, then more grooves with narrower surface openings should be provided. On the other hand, if damping due to fluid flow within the grooves dominates, then grooves with larger cross-sectional areas should be provided. If the electrode cross-sectional area or the groove re-entrant profile is limited by processing limitations and if total fluid damping is dominated by fluid flow through the grooves, then fewer grooves with wider surface openings should be provided.

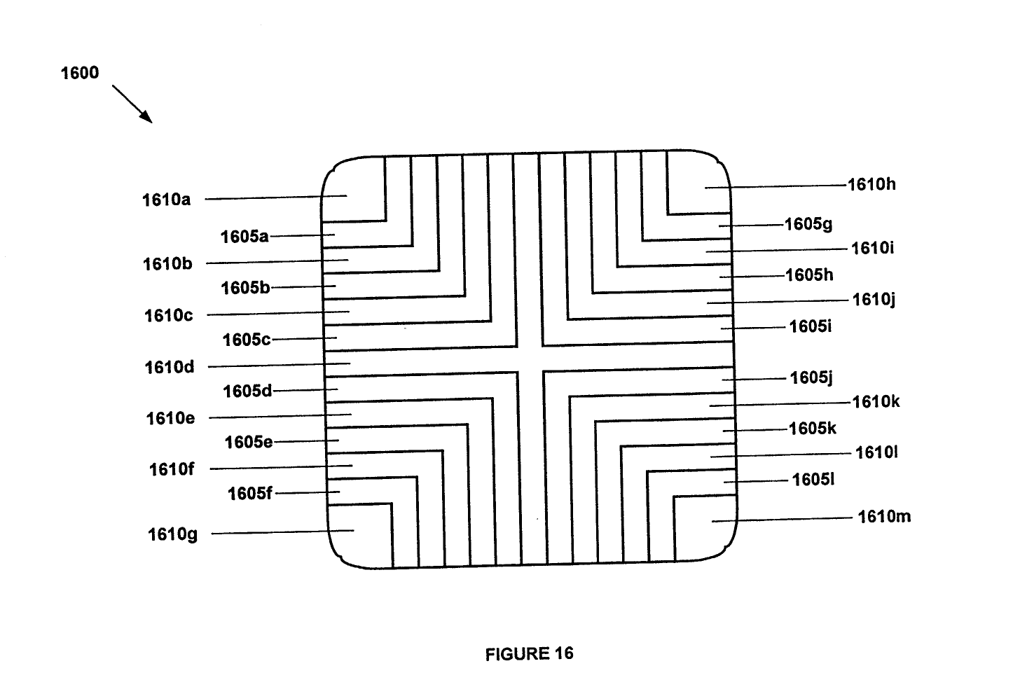

Referring now to FIGS. 16-20, several alternative embodiments of electrodes 1600, 1700, 1800, 1900, and 2000 having re-entrant openings or grooves for use in one or more of the parallel plate electrodes 705, 805, 910, and 915 of the accelerometer 305 will be described.

Referring to FIG. 16, the electrode 1600 includes a plurality of re-entrant herringbone grooves 1605a-1605l and electrode surface elements 1610a-1610m. The placement of the grooves 1605 minimizes the channel length of the grooves 1605 from any point to the periphery of the electrode 1600. In an exemplary embodiment, the width of the grooves 1605 at the surface is about 45 microns. In another exemplary embodiment, the grooves 1605 have width at the surface of about 20 microns, a width below the surface of about 65 microns, and a depth of about 120 microns. In an alternative embodiment, one or more of the grooves 1605 do not have a re-entrant cross section.

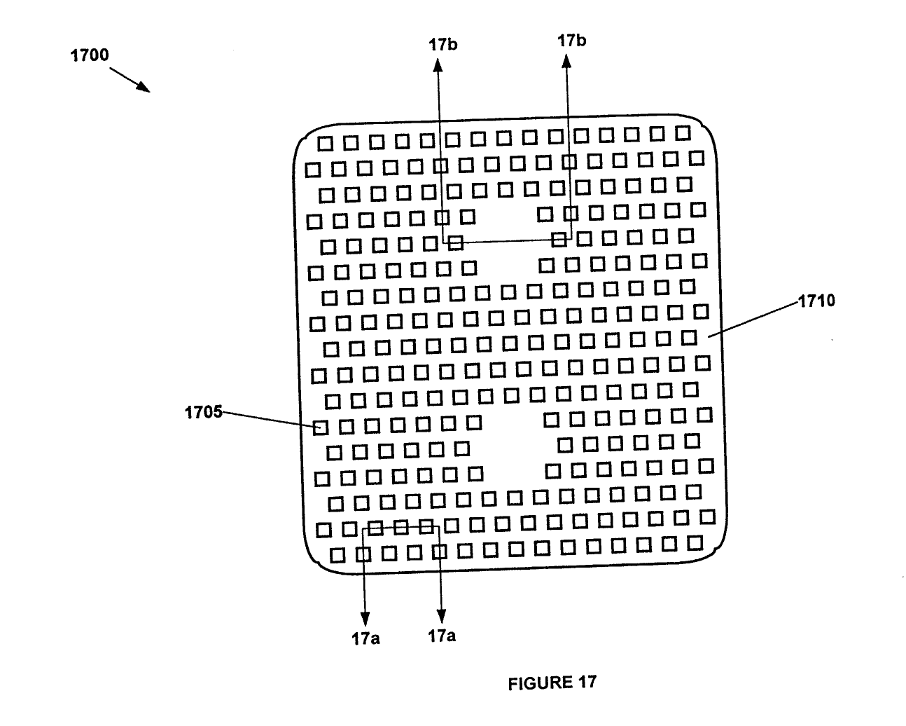

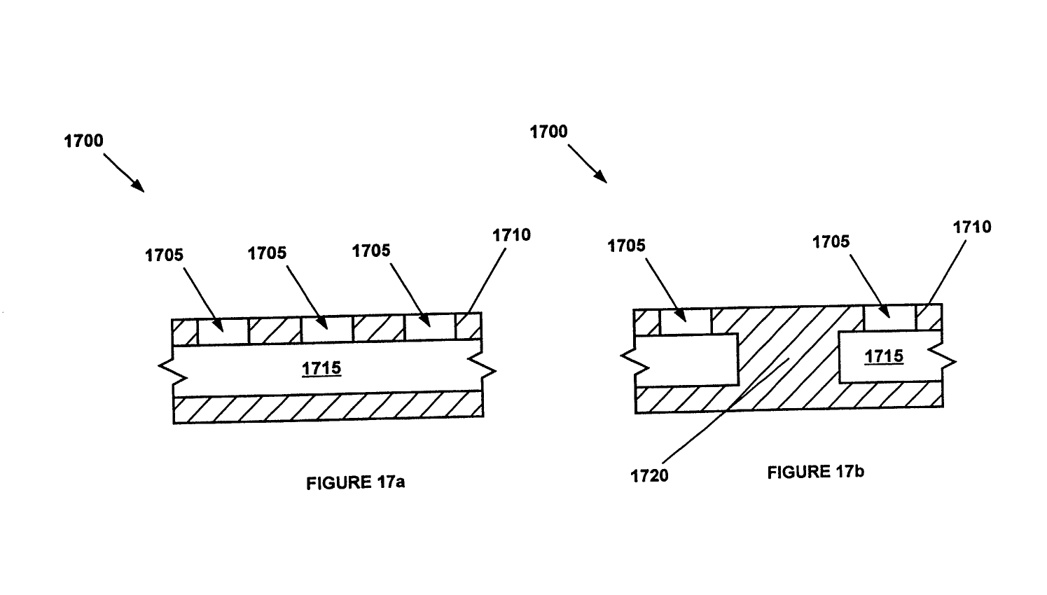

Referring to FIG. 17, the electrode 1700 includes a plurality of re-entrant holes 1705 formed in an electrode surface element 1710. In a preferred embodiment, as illustrated in FIG. 17a, below the surface of the electrode surface element 1710, the re-entrant holes 1705 merge to form a fluid flow channel 1715 below the surface. In a preferred embodiment, as illustrated in FIG. 17b, the pattern of the holes 1705 is provides one or more pillars 1720 for supporting the electrode surface element 1710. In an exemplary embodiment, the holes 1705 have a side dimension at the surface of about 10 microns. In an alternative embodiment, one or more of the holes 1705 do not have a re-entrant cross-section.

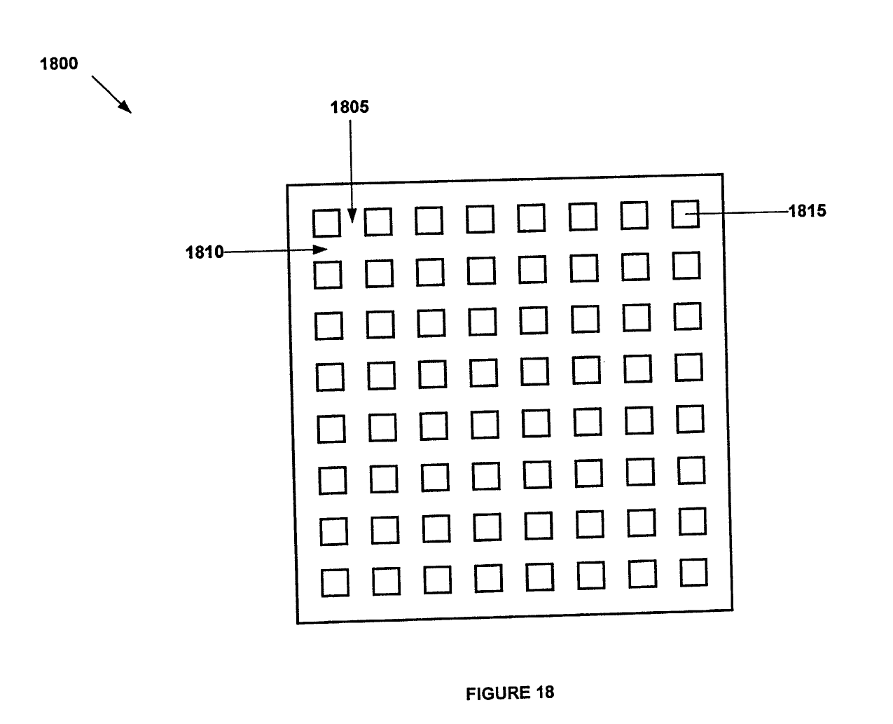

Referring to FIG. 18, the electrode 1800 includes a checkerboard pattern of vertical grooves 1805 and horizontal grooves 1810, and a plurality of electrode surface elements 1815. In an alternative embodiment, one or more of the grooves 1805 and 1810 do not have a re-entrant cross section.

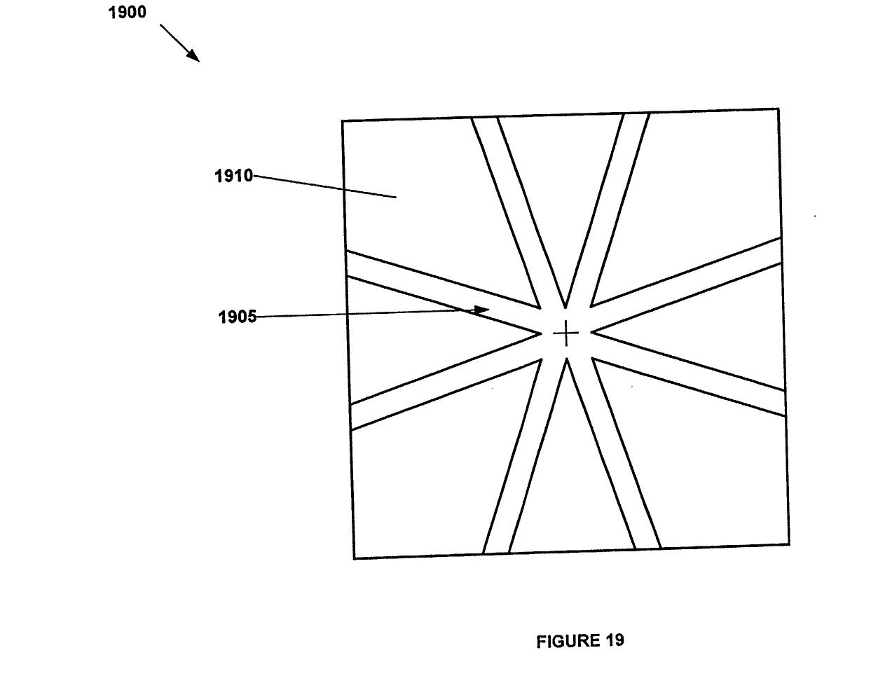

Referring to FIG. 19, the electrode 1900 includes a radial pattern of grooves 1905 and a plurality of electrode surface elements 1910. In an alternative embodiment, one or more of the grooves 1905 do not have a re-entrant cross section.

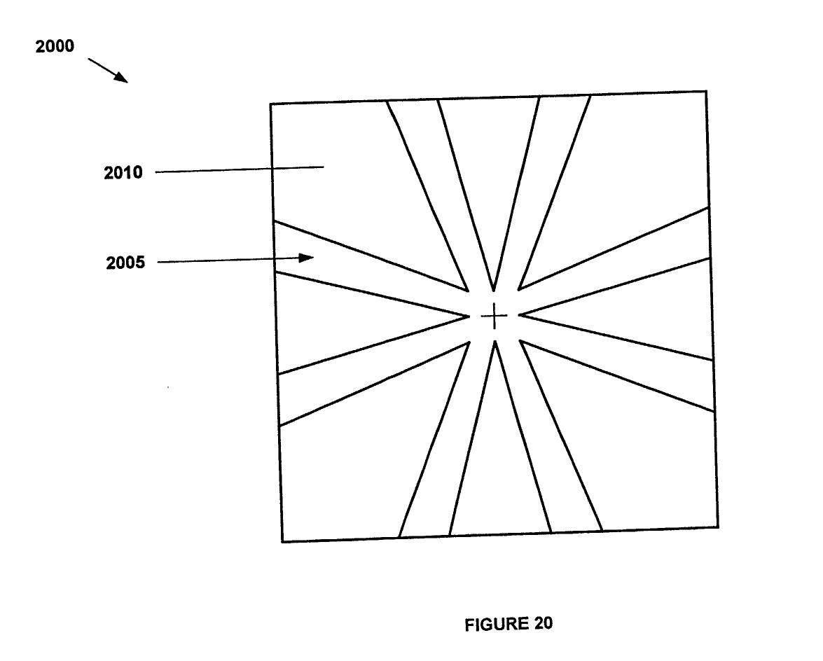

Referring to FIG. 20, the electrode 2000 includes a radial pattern of grooves 2005 and a plurality of electrode surface elements 2010. In a preferred embodiment, the width of the grooves 2005 increases in the direction of the periphery of the electrode 2000. In this manner, the resistance to fluid flow is reduced in the direction of the periphery of the electrode 2000. In several alternative embodiments, the width of the grooves 1605, 1805, 1810, and 1905, and the holes 1705 provided in the electrodes 1600, 1700, 1800, and 1900 increase in the direction of the periphery of the electrodes. In an alternative embodiment, one or more of the grooves 2005 do not have a re-entrant cross section.

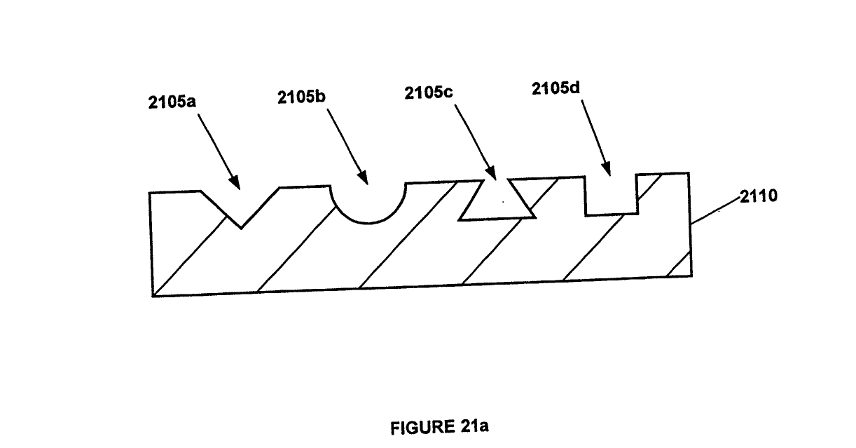

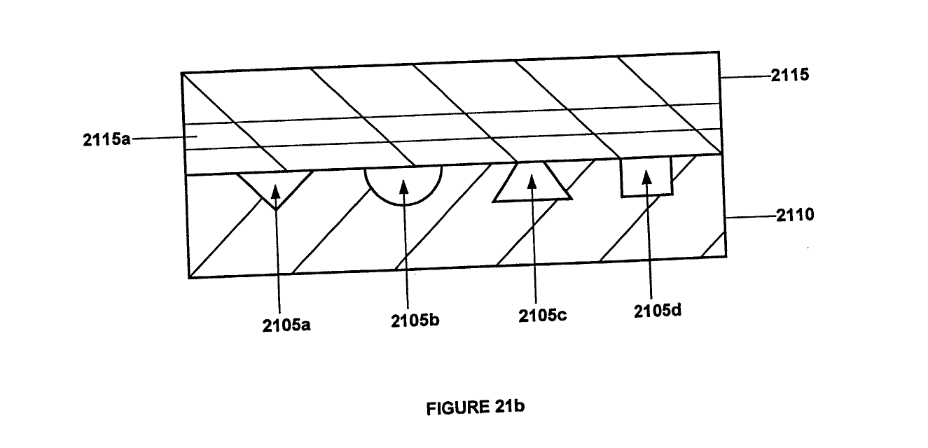

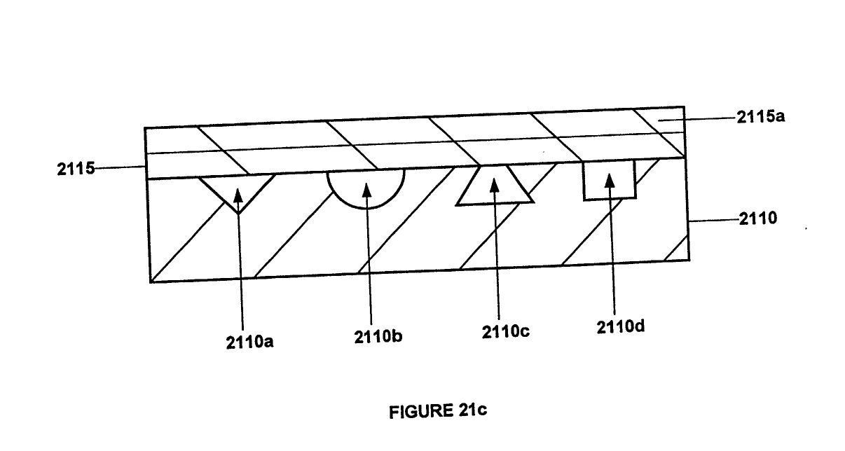

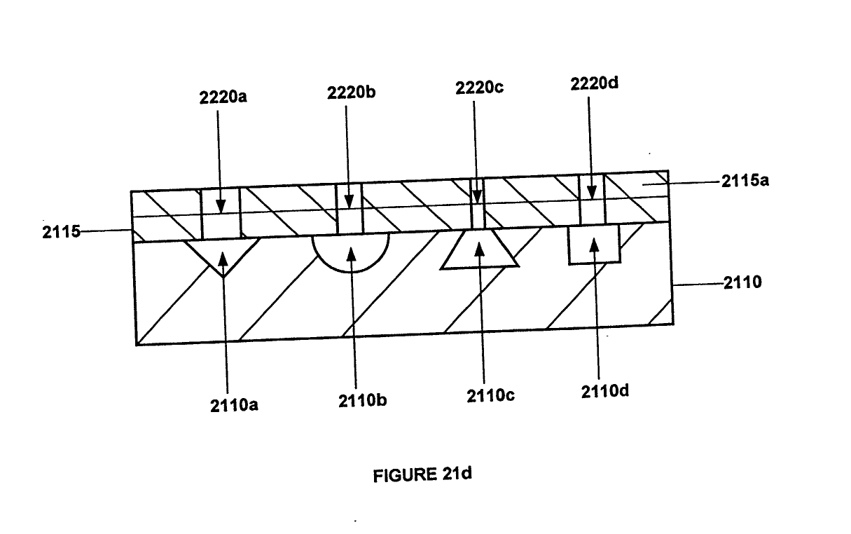

Referring to FIGS. 21a-21d, an embodiment of a method for forming re-entrant grooves will now be described. Initially, channels 2105a-2105d are formed in a silicon substrate 2110 using conventional processes such as, for example, wet and/or plasma etching processes. Another silicon substrate 2115 having a conventional etch-stop layer 2115a is then bonded onto the top surface of the silicon substrate 2110 in a conventional manner. The etch-stop layer 2115a may, for example, be a layer of silicon dioxide or a doped layer within the silicon substrate 2115. The portion of the silicon substrate 2115 above the etch-stop layer 2115a is then etched away in a conventional manner. Openings 2220a-2220d are then etched through the silicon substrate 2115 to expose the corresponding channel 2110a-2110d using conventional methods such as, for example, plasma etching. In this manner, re-entrant channels are formed that include the channels 2110a-2110d and the corresponding openings 2220a-2220d. In an alternative embodiment, the etch stop layer 2115a is removed in a conventional manner.

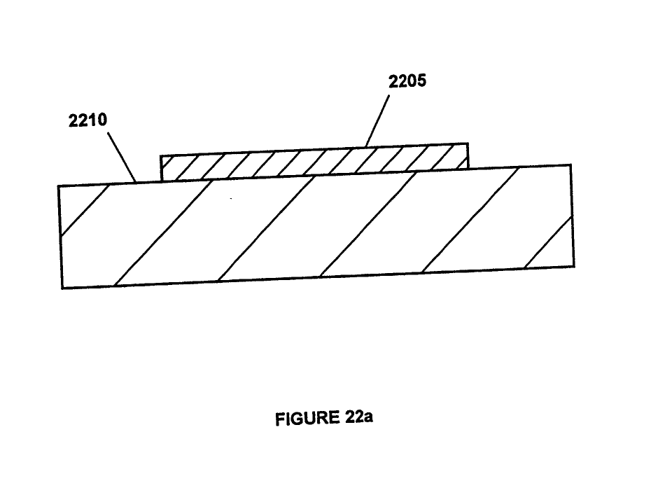

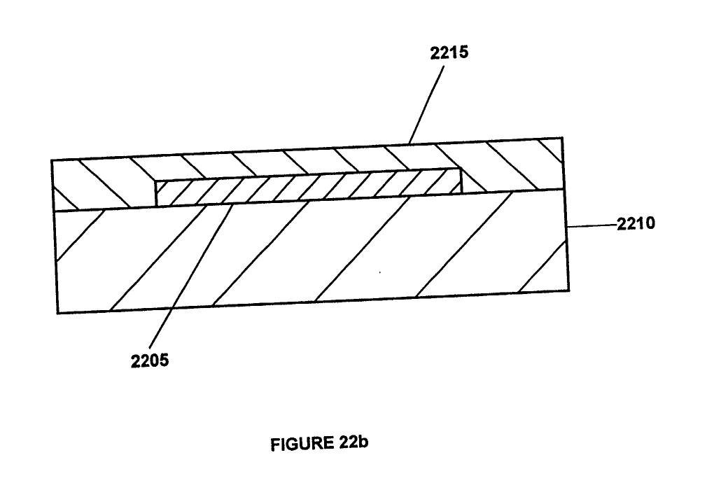

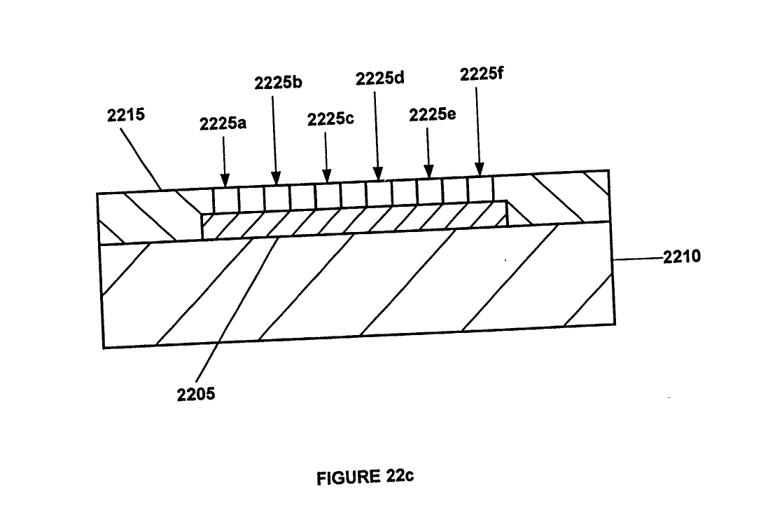

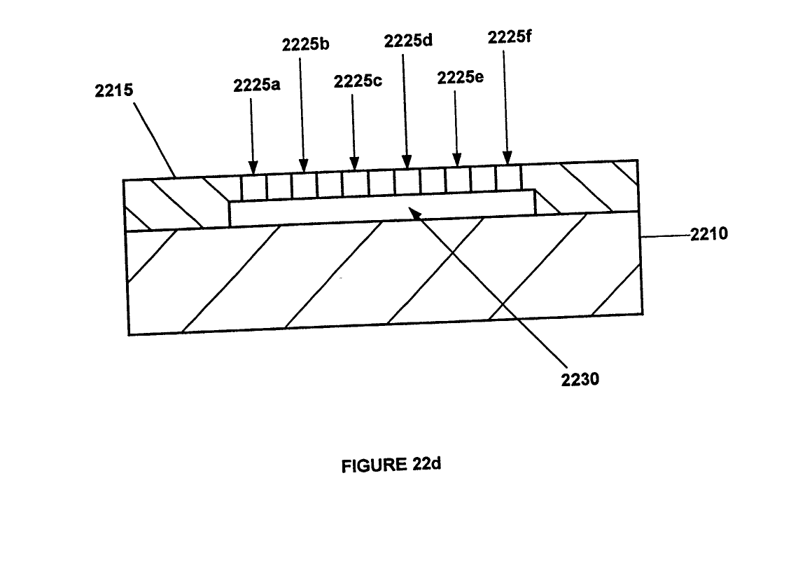

Referring to FIGS. 22a-22c, an embodiment of a method of forming re-entrant holes will now be described. Initially, a layer 2205 of silicon dioxide is deposited or grown on a silicon substrate 2210 in a conventional manner. The layer 2205 of silicon dioxide is then patterned in a conventional manner. A layer 2215 of silicon is then deposited onto the layer 2205 of silicon dioxide and the exposed portions of the silicon substrate 2210 in a conventional manner. Openings 2225 are then etched in the layer 2215 of silicon exposing the layer 2205 of silicon dioxide using conventional etching processes such as, for example, DRIE. The layer 2205 of silicon dioxide is then removed using a conventional wet etching process. As a result a plurality of re-entrant openings are formed in the layer 2215 of silicon that are coupled to an interior flow passage 2230 positioned below the surface of the layer 2215 of silicon. The resulting structure is similar to that illustrated in FIGS. 17, 17a and 17b.

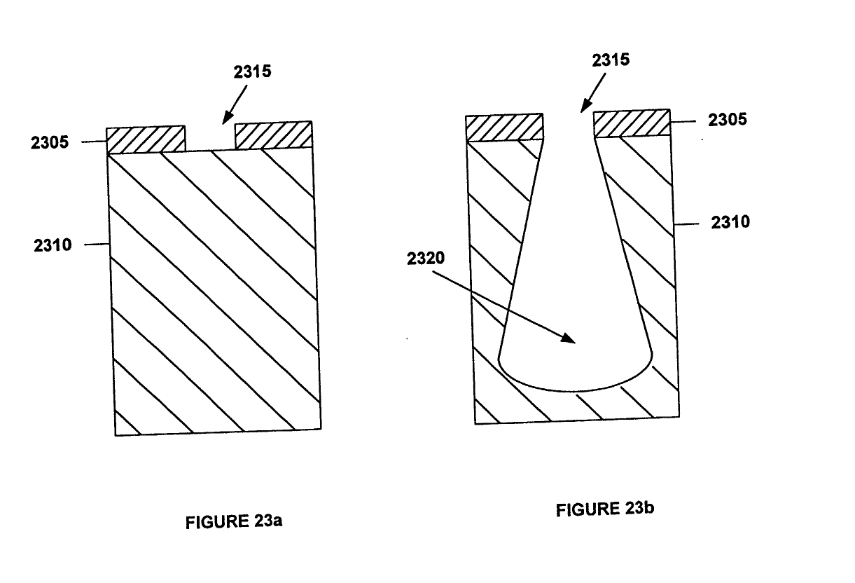

Referring to FIGS. 23a and 23b, an alternate embodiment of a method for forming re-entrant openings or grooves will be described. Initially, a layer 2305 of a masking material is deposited on a silicon substrate 2310 in a conventional manner. The masking material may be, for example, an organic polymer such as a photoresist, or an inorganic material such as, for example, silicon dioxide or metals. The layer 2305 of masking material is then patterned in a conventional manner to form a channel or opening 2315 to expose the silicon substrate 2310. The exposed portion of the silicon substrate 2310 is then etched using a plasma etching process to form a re-entrant opening or channel 2320 in the silicon substrate having an upper width that is less than a lower width. In an exemplary embodiment, the plasma etching process uses an etching gas such as SF6 alternating with a passivating gas C4F8. In this manner, a re-entrant groove or opening is formed. The method illustrated in FIGS. 23a and 23b can also be used to form grooves that do not have a re-entrant cross-section.

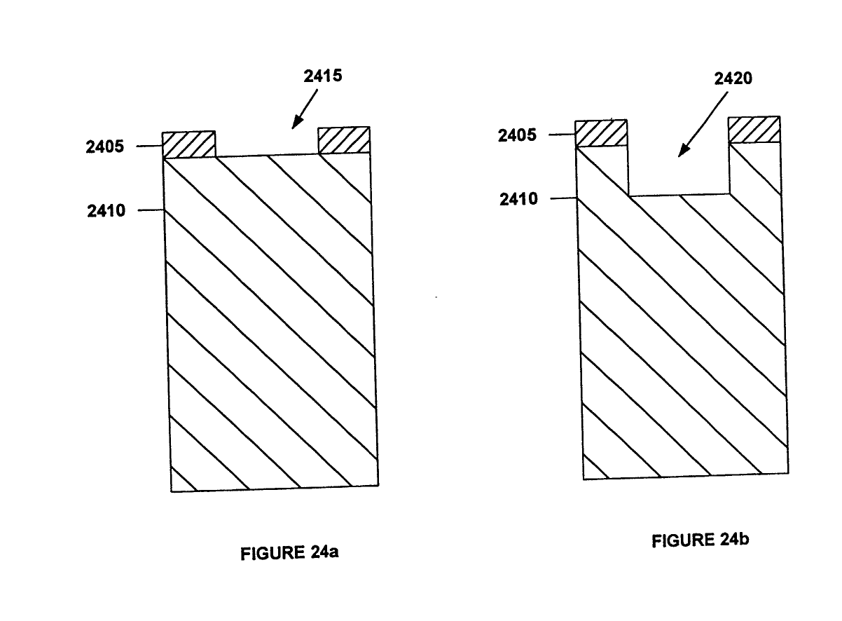

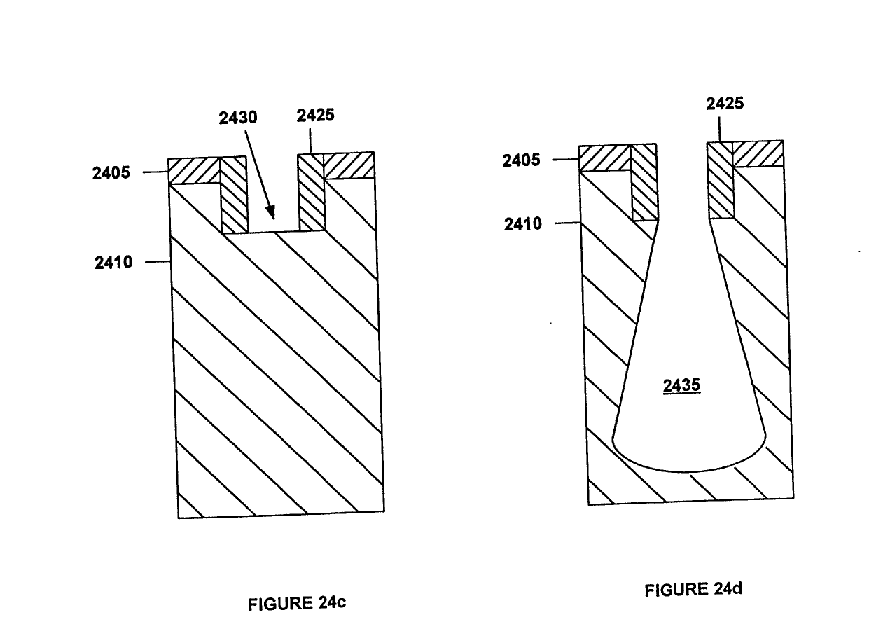

Referring to FIGS. 24a, 24b, 24c, and 24d, an alternative embodiment of a method for forming re-entrant openings or grooves in a silicon substrate will be described. Initially a layer 2405 of a masking material is deposited on a silicon substrate 2410. The layer 2405 of masking material may be, for example, an organic polymer such as a photoresist, or an inorganic material such as silicon dioxide or a metal. The layer 2405 of masking material is then patterned in a conventional manner to form an opening or channel 2415 to expose the silicon substrate 2410. The exposed portions of the silicon substrate are then etched using conventional methods to form a recess 2420 in the silicon substrate 2410. A layer 2425 of a masking material is then deposited on the exposed portions of the silicon substrate 2410. The layer 2425 of masking material may be, for example, an organic polymer such as a photoresist, or an inorganic material such as silicon dioxide or a metal. A channel 2430 is then formed in the layer 2425 of masking material to expose the silicon substrate 2410. The exposed portions of the silicon substrate 2410 are then etched using conventional methods to form a re-entrant opening or channel 2435 in the silicon substrate having an upper width that is less than a lower width. In this manner, a re-entrant opening or channel is formed. The additional layer 2425 of masking material reduces the undercut of the layer 2405 of masking material during the etching of the silicon substrate 2410 to form the re-entrant opening or channel 2435.

More generally, the grooves of the present disclosure may be used to reduce fluid damping in all micro-machined structures. In an exemplary embodiment, re-entrant grooves are provided in all of the exterior surfaces of the accelerometer 305 in order to optimally minimize fluid damping.

In an alternative embodiment, the mass electrode patterns 910 and 915 are fabricated from any number of conductive materials suitable for creating an electrode, such as, for example, metals, silicides, or doped semiconductors.

The present embodiments of the invention provide a number of significant advantages. For example, the use of re-entrant openings in the electrodes of the accelerometer reduces fluid damping during operation of the accelerometer. In this manner, thermo-mechanical noise is reduced. Furthermore, the use of re-entrant openings maximizes the available electrode surface area thereby maximizing the working capacitance of the electrodes.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. An accelerometer, comprising:
a measurement mass for detecting acceleration, including a housing having a cavity, a spring mass assembly positioned within the cavity, and one or more mass electrodes coupled to the spring mass assembly;
a top cap wafer coupled to the measurement mass, including a top capacitor electrode; and
a bottom cap wafer coupled to the measurement mass, including a bottom capacitor electrode;
wherein the surfaces of one or more of the mass electrodes, the top capacitor electrode, or the bottom capacitor electrode include one or more re-entrant openings.

2. The accelerometer of claim 1, wherein the re-entrant openings include one or more re-entrant grooves.

3. The accelerometer of claim 2, wherein the re-entrant grooves are herringbone shaped.

4. The accelerometer of claim 2, wherein the re-entrant grooves are criss-crossed.

5. The accelerometer of claim 2, wherein the re-entrant grooves extend from a central location in a radial direction.

6. The accelerometer of claim 2, wherein the width of the re-entrant grooves increases in the direction of the periphery of the electrodes.

7. The accelerometer of claim 1, wherein the openings include one or more re-entrant holes.

8. The accelerometer of claim 7, wherein the re-entrant holes are connected beneath the surfaces of the electrodes.

9. The accelerometer of claim 7, wherein the size of the re-entrant holes increase in the direction of the periphery of the electrodes.

10. A method of operating an accelerometer including a measurement mass for detecting acceleration, including a housing having a cavity, a spring mass assembly positioned within the cavity, and one or more mass electrodes coupled to the spring mass assembly, a top cap wafer coupled to the measurement mass, including a top capacitor electrode, and a bottom cap wafer coupled to the measurement mass, including a bottom capacitor electrode, comprising:
reducing fluid damping between the electrodes by providing one or more re-entrant openings in the surfaces of one or more of the electrodes.

11. The method of claim 10, wherein the re-entrant openings include one or more re-entrant grooves.

12. The method of claim 11, wherein the re-entrant grooves are herringbone shaped.

13. The method of claim 11, wherein the re-entrant grooves are criss-crossed.

14. The method of claim 11, wherein the re-entrant grooves extend from a central location in a radial direction.

15. The method of claim 11, wherein the width of the re-entrant grooves increases in the direction of the periphery of the electrodes.

16. The method of claim 10, wherein the openings include one or more re-entrant holes.

17. The method of claim 16, wherein the re-entrant holes are connected beneath the surfaces of the electrodes.

18. The method of claim 16, wherein the size of the re-entrant holes increase in the direction of the periphery of the electrodes.

19. A method of forming a re-entrant opening, comprising:
providing a substrate;
patterning a portion of the substrate to form a cavity having an upper cross sectional area;
bonding a wafer having an internal etch-stop layer onto the surface of the substrate;
etching the wafer down to the etch-stop layer; and
patterning the wafer to form an opening that exposes the cavity;
wherein the cross sectional area of the opening is less than the upper cross sectional area of the cavity.

20. The method of claim 19, further including:
removing the etch-stop layer.

21. A method of forming a re-entrant opening, comprising:
providing a silicon substrate;
depositing a layer of silicon dioxide onto the silicon substrate;
patterning the layer of silicon dioxide;
depositing a layer of silicon onto the layer of silicon dioxide and the exposed portions of the silicon substrate;
patterning the layer of silicon to form an opening that exposes the layer of silicon dioxide; and
removing the layer of silicon dioxide.

22. The method of claim 21, wherein patterning the layer of silicon includes:
patterning the layer of silicon to form a plurality of openings that expose the layer of silicon dioxide.

23. A method of forming a re-entrant opening, comprising:
providing a substrate;
depositing a layer of a masking material onto the substrate;
patterning the masking material to form an opening;
etching the exposed portions of the substrate to form a re-entrant opening.

24. The method of claim 23, wherein the re-entrant opening comprises a re-entrant groove.

25. A method of forming a re-entrant opening, comprising:
providing a substrate;
depositing a first layer of a masking material onto the substrate;
patterning the layer of masking material to form an opening;
etching the exposed portions of the silicon substrate to form a channel;
depositing a second layer of a masking material onto the exposed portions of the substrate;
patterning the second layer of masking material to form an opening; and
etching the exposed portions of the silicon substrate to form a re-entrant opening.

26. The method of claim 25, wherein the re-entrant opening comprises a re-entrant groove.

27. An accelerometer, comprising:
a measurement mass for detecting acceleration, including a housing having a cavity, a spring mass assembly positioned within the cavity, and one or more mass electrodes coupled to the spring mass assembly;
a top cap wafer coupled to the measurement mass, including a top
capacitor electrode; and
a bottom cap wafer coupled to the measurement mass, including a
bottom capacitor electrode;
wherein the surfaces of one or more of the mass electrodes, the top capacitor electrode, or the bottom capacitor electrode include one or more grooves.

28. The accelerometer of claim 27, wherein the grooves are herringbone shaped.

29. The accelerometer of claim 27, wherein the grooves are criss-crossed.

30. The accelerometer of claim 27, wherein the grooves extend from a central location in a radial direction.

31. The accelerometer of claim 27, wherein the width of the grooves increases in the direction of the periphery of the electrodes.

32. A method of operating an accelerometer including a measurement mass for detecting acceleration, including a housing having a cavity, a spring mass assembly positioned within the cavity, and one or more mass electrodes coupled to the spring mass assembly, a top cap wafer coupled to the measurement mass, including a top capacitor electrode, and a bottom cap wafer coupled to the measurement mass, including a bottom capacitor electrode, comprising:
reducing fluid damping between the electrodes by providing one or more grooves in the surfaces of one or more of the electrodes.

33. The method of claim 32, wherein the grooves are herringbone shaped.

34. The method of claim 32, wherein the grooves are criss-crossed.

35. The method of claim 32, wherein the re-entrant grooves extend from a central location in a radial direction.

36. The method of claim 32, wherein the width of the grooves increases in the direction of the periphery of the electrodes.
